(19) United States
(12) Patent Application Publication
(10) Pub. No.: US 2015/0256499 A1
(43) Pub. Date: Sep. 10, 2015

(54) RANKING, COLLECTION, ORGANIZATION, AND MANAGEMENT OF NON-SUBSCRIPTION ELECTRONIC MESSAGES

(71) Applicants: Ankesh Kumar, Palo Alto, CA (US); Aleksey Sergeyevich Nazarov, San Mateo, CA (US)

(72) Inventors: Ankesh Kumar, Palo Alto, CA (US); Aleksey Sergeyevich Nazarov, San Mateo, CA (US)

(73) Assignee: Socialmail LLC, Palo Alto, CA (US)

(21) Appl. No.: 14/485,013

(22) Filed: Sep. 12, 2014

Related U.S. Application Data
(63) Continuation-in-part of application No. 13/191,412, filed on Jul. 26, 2011, now abandoned.
Application No. 13/191,412 is a continuation-in-part of application No. 13/712,870, filed on Dec. 12, 2012.
Application No. 13/712,870 is a continuation-in-part of application No. 13/191,412, filed on Jul. 26, 2011, now abandoned.
Application No. 13/191,412 is a continuation-in-part of application No. 14/049,204, filed on Oct. 8, 2013.
Application No. 14/049,204 is a continuation-in-part of application No. 13/712,870, filed on Dec. 12, 2012.
Application No. 13/712,870 is a continuation-in-part of application No. 13/191,412, filed on Jul. 26, 2011, now abandoned.
Application No. 14/049,204 is a continuation-in-part of application No. 13/191,412, filed on Jul. 26, 2011, now abandoned.

(51) Int. Cl. H04L 12/58; G06F 17/30

(52) U.S. Cl. CPC H04L 51/28; G06F 17/3089; H04L 51/12

(57) ABSTRACT

A user who is considering unsubscribing from content from a publisher of the content may be presented with an alternative, which if selected by the user, allows the user to access the content on a non-subscription-based domain (e.g., a web site, a web page, or using an APP executing on a client device). A unsubscribe request by the user may unsubscribe the user from the subscribed-to-domain of the publisher and may transition the user to the non-subscription-based domain or provide the user with a selectable link (e.g., hyperlink) to the non-subscription-based domain. A backend system (e.g., an administrator) may receive unsubscribed to content from publishers (e.g., from a frontend system) and may rank the content for presentation on a brand page or other format on the non-subscription-based domain. Collection, organization, publisher status and content status may be directed by the backend system.

### CROSS-REFERENCE TO RELATED APPLICATIONS

This application is a continuation-in-part of U.S. Non-Provisional patent application Ser. No. 13/191,412 (Atty. Docket No. SOC-001), filed Jul. 26, 2011; This application is also a continuation-in-part of U.S. Non-Provisional patent application Ser. No. 13/712,870 (Atty. Docket No. SOC-001CIP1), filed Dec. 12, 2012, which is a continuation-in-part of U.S. Non-Provisional patent application. Ser. No. 13/191,412 (Atty. Docket No. SOC-001), filed Jul. 26, 2011; This application is also a continuation-in-part of U.S. Non-Provisional patent application Ser. No. 14/049,204 (Atty. Docket No. SOC-001CIP2), filed Oct. 8, 2013, which is a continuation-in-part of U.S. Non-Provisional patent application Ser. No. 13/712,870 (Atty. Docket No. SOC-001CIP1), filed Dec. 12, 2012, which is a continuation-in-part of U.S. Non-Provisional patent application Ser. No. 13/191,412 (Atty. Docket No. SOC-001), filed Jul. 26, 2011 and U.S. Non-Provisional patent application Ser. No. 14/049,204 (Atty. Docket No. SOC-001CIP2) filed Oct. 8, 2013 is also a continuation-in-part of U.S. Non-Provisional patent application Ser. No. 13/191,412 (Atty. Docket No. SOC-001), filed Jul. 26, 2011; All of the above-referenced properties are herein incorporated by reference in their entirety for all purposes.

### FIELD

The present application relates generally to computer software, computer program architecture, data and database management, professional media, social media, web based applications, and mobile applications. More specifically, techniques for electronic mail processing and publication for a visual display oriented email system are described.

### BACKGROUND

Electronic messaging is an important function for garnering data for personal consumption and for sharing data with other individuals, organizations, or entities. Conventional electronic messaging solutions such as electronic mail (hereafter “email”) applications, servers, and platforms allow users to receive email, compose email, forward email, send email, carbon copy (cc) email, blind cc email and reply to email. Moreover, reviewing content included in an email often requires several “click troughs” of a mouse or other user interface device to access the content. For example, one click through may be necessary to open an email in a user's inbox or other email folder, another click through may be necessary to access a web page/site in a hyperlink or image included in a body of the email message. It is estimated that one-third of users are lost for each click through required to access email content. From a user point of view, an inbox or other email folder may contain an overwhelming amount of visual information created by a large number of email messages from a large number of different email sources, such as advertisers, businesses, financial institutions, invoices for bills, newsletters, social networks, professional networks, special interests groups, friends, colleagues and family, just to name a few.

In some instances there may be redundant emails from the same source and/or there may be emails from sources the user is subscribed to but is no longer interested in receiving. In any case, visually parsing through the disparate assembly of email messages and the concomitant click troughs that may be required to access the content of each email may result in the user unsubscribing from an email source or ignoring email from an email source due to the number of required to access content. The unsubscribe requests from users may be regarded as a “churn rate” that is undesirable for a publisher or other source of the email.

On a weekly basis, if a publisher has a 0.3% churn rate, then that publisher may lose 5% of its subscribers on an annual basis with a concomitant loss of revenue to the publisher from advertising, etc. In many cases, the unsubscribing user may actually like the content being provided by the publisher, but is compelled to downsize the amount of emails that he/she is receiving due to an overwhelming amount of emails being received from many disparate sources and the burden of having to visually sort through and decide which emails to react to or to ignore or delete. For example, faced with a large number of emails in an inbox, a user may permanently delete emails they regard as less important. As another example, a user has subscribed to a source of emails (e.g., a newsletter, etc.) and those emails are received in the user's inbox. The user may actually want to receive the subscribed to emails, but doesn't want them in their regular inbox. Due to email overload, the user may elect to unsubscribe from the emails even though they initially subscribed to the emails and may actually still want to receive them.

Conventional presentation of email messages using a subject line format may not convey enough useful information to allow a user to decide whether or not to open the email to divine its content. For example, an email may include text and images; however, the user may not see the image portion until at least one or more click troughs, and the image portion of the content if known without having to click through may be more informative to the user in making a decision to dive further into the content of an email message or to ignore or delete the email message, as opposed to just the text presented in the subject line. In other cases, the visual parsing of a folder or inbox may be fatiguing to a user and result in the user overlooking an email of interest because it is not visually prominent and/or noticeable when presented among other emails in that folder or inbox.

Users (e.g., about 47%) may unsubscribe from email content that they may actually like because they are overwhelmed by the numerous amount of emails they receive (e.g., newsletters, marketing collateral, news, information, media, etc.) and that accumulate in their inboxes or other email folders over time. Moreover, some users may prefer a way to see email content from various publishers (e.g., multiple product brands) of content that they have an interest in but that does not require the user to have a subscription and/or create an account (e.g., access credentials such as username/email address and password) to access that content.

Retention marketing is a concept in which a marketer acts to retain as may users as possible. For example, if each publication of new content from a publisher elicits about 0.03 users to unsubscribe, then over time, that publisher may lose many users due to their unsubscribing from the publishers content. Publishers of content (e.g., newsletters, marketing collateral, news, information, media, etc.) may wish to retain users who would otherwise unsubscribe by providing content of interest to those users on an alternative forum that users may openly access whenever they wish.

Thus, what is needed is a solution that provides users with an alternative to unsubscribing from email content and that provides publishers with an alternative forum for presentation of content to those users.

### BRIEF DESCRIPTION OF THE DRAWINGS

Various embodiments or examples (“examples”) are disclosed in the following detailed description and the accompanying drawings:

FIG. 1 illustrates an exemplary system for electronic mail processing and publication for shared environments;

FIG. 2 an exemplary application architecture for electronic mail processing and publication for shared environments;

FIG. 3 illustrates an exemplary shared environment for publication of processed electronic mail messages;

FIG. 4A illustrates a further exemplary shared environment for publication of processed electronic mail messages;

FIG. 4B illustrates an alternative exemplary shared environment for publication of processed electronic mail messages;

FIG. 5 illustrates another exemplary shared environment for publication of processed electronic mail messages;

FIG. 6A illustrates an exemplary process for electronic mail processing and publication for shared environments;

FIG. 6B illustrates an alternative exemplary process for electronic mail processing and publication for shared environments;

FIG. 7 illustrates a further exemplary process for electronic mail processing and publication for shared environments;

FIG. 8 illustrates an exemplary process for transforming email addresses for electronic mail processing and publication for shared environments;

FIG. 9 illustrates an exemplary computer system suitable for electronic mail processing and publication for shared environments;

FIG. 10 illustrates an exemplary process for aggregating and cleaning electronic mail for publication on shared environments;

FIG. 11 illustrates an exemplary shared environment for publication of aggregated and cleaned electronic mail messages;

FIG. 12A depicts one example of a flow diagram for generating a grid view including one or more tiles;

FIG. 12B depicts one example of an electronic email message having different content types;

FIG. 12C depicts one example of a grid view including a plurality of tiles displayed on a display system;

FIG. 12D depicts one example of different configurations for tiles in a grid view and flying or hovering over a tile to initiate content rotation of content in the tile;

FIG. 12E depicts one example of a selected tile made visually more prominent than un-selected tiles in a grid view;

FIG. 12F depicts a grid view of plurality of tiles and their respective content types with one of the tiles being selected and having content rotation of its content;

FIG. 13A depicts one example of a flow diagram for generating a carousel view including one or more tiles;

FIG. 13B depicts one example of a carousel view including a plurality of tiles displayed on a display system;

FIG. 13C depicts one example of different configurations for tiles in a carousel view and flying or hovering over a selected tile to make the selected tile visually prominent and to position un-selected tiles around a perimeter of the selected tile;

FIG. 13D depicts a carousel view of plurality of tiles and their respective content types and a selected tile being visually prominent and having content rotation of its content;

FIG. 14A depicts one example of a flow diagram for reducing unsubscribe requests;

FIG. 14B depicts one example of a scenario for handling an unsubscribe request that may result in registration with an aggregating domain;

FIG. 15A depicts another example of a flow diagram for reducing unsubscribe requests;

FIG. 15B depicts another example of a scenario for handling an unsubscribe request that may result in registration with an aggregating domain;

FIG. 16 depicts one example of a non-subscription-based alternative to receiving electronic messages;

FIG. 17 depicts one example of how information may be presented on a brand page generated by a non-subscription based domain;

FIG. 18 depicts one example of a flow diagram of a non-subscription-based alternative to receiving electronic messages;

FIG. 19 depicts one example of a flow diagram of ranking of content presented on a brand page;

FIG. 20 depicts one example of a flow diagram of collection and organization of content by publishers who submit content to a non-subscription-based alternative to receiving electronic messages;

FIG. 21 depicts one example of a flow diagram of a publisher opt-in process;

FIG. 22 depicts one example of a system diagram of a non-subscription-based alternative to receiving electronic messages;

FIG. 23 depicts another example of a non-subscription-based alternative to receiving electronic messages; and

FIG. 24 depicts another example of a flow diagram of a non-subscription-based alternative to receiving electronic messages.

It is to be understood that, in the drawings, like reference numerals designate like structural elements. Also, it is understood that the drawings are not necessarily to scale.

### DETAILED DESCRIPTION

Various embodiments or examples may be implemented in numerous ways, including as a system, a process, an apparatus, a user interface, or a series of program instructions on a non-transitory computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

In some examples, the described techniques may be implemented as a computer program or application (“application”) or as a plug-in, module, or sub-component of another application. The described techniques may be implemented as software, hardware, firmware, circuitry, or a combination thereof. If implemented as software, the described techniques may be implemented using various types of programming, development, scripting, or formatting languages, frameworks, syntax, applications, protocols, objects, or techniques, including ASP, ASP.net, .Net framework, Ruby, Ruby on Rails, C, Objective C, C++, C#, Adobe® Integrated Runtime™ (Adobe® AIR™), ActionScript™, Flex™, Lingo™, Java™, Javascript™, Ajax, Perl, COBOL, Fortran, ADA, XML, MXML, HTML, DHTML, XHTML, HTTP, XMPP, PHP, and others. Design, publishing, and other types of applications such as Dreamweaver®, Shockwave®, Flash®, Drupal and Fireworks® may also be used to implement the described techniques. Database management systems (i.e., “DBMS”), search facilities and platforms, web crawlers (i.e., computer programs that automatically or semi-automatically visit, index, archive or copy content from, various websites (hereafter referred to as “crawlers”)), and other features may be implemented using various types of proprietary or open source technologies, including MySQL, Oracle (from Oracle of Redwood Shores, Calif.), Solr and Nutch from The Apache Software Foundation of Forest Hill, Md., among others and without limitation. The described techniques may be varied and are not limited to the examples or descriptions provided.

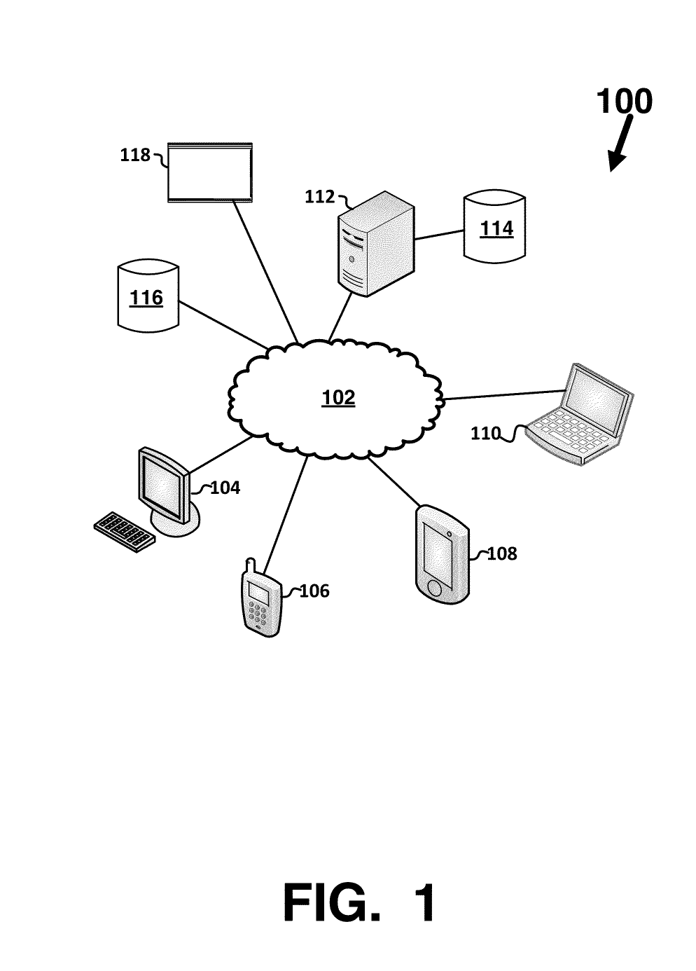

FIG. 1 illustrates an exemplary system for electronic mail processing and publication for shared environments. Here, system 100 includes network 102, clients 104-110, server 112, databases 114-116, and website 118. “Elements” may refer to one or more of network 102, clients 104-110, server 112, databases 114-116, and website 118 shown in association with system 100. As shown, the type, quantity, configuration, topology, and other characteristics are provided for purposes of illustration only and may be varied beyond the examples shown and provided. In some examples, network 102 may be any type of data network including, without limitation, a local area network (LAN), wide area network (WAN), municipal area network (MAN), wireless local area network (WLAN), computing cloud, or any other type of aggregation of computing, networking, storage, or processing resources. As shown, clients 104-110 may be implemented as a desktop computer (e.g., client 104), mobile communication (i.e., voice and data) device (e.g., client 106), mobile computing device (e.g., client 108), or notebook or laptop (i.e., portable) computing device (client 110). Each of clients 104-110 may be in data communication with server 112 using network 102. In some examples, server 112 may be a web, application, email, or other type of server, without limitation.

Databases 114-116, in some examples, may be directly or indirectly in data communication with server 112, which may be implemented as described above to perform one or more applications, deliver services or resources to clients 104-110, execute or compile applications, or otherwise provide any type of processing capability or facility, without limitation. Data associated with the techniques described herein may be stored in one or both of databases 114-116. In other examples, data may also be stored in embedded memory, of any type, with server 112 or any of clients 104-110. Still further, data may be stored and retrieved by server 112 or any of clients 104-110 from any of databases 114-116 without limitation as to any given database schema or structure. For example, an email may be transmitted to a “shared destination,” which may be an email server (e.g., server 112), email account, or other resource that is configured to accept email messages sent using messaging protocols such as Simple Mail Transfer Protocol (hereafter “SMTP”) and received using other protocols such as Internet Message Access Protocol (hereafter “IMAP”) or Post Office Protocol (hereafter “POP”), among others. In some examples, email receipt may be indicated automatically or semi-automatically to server 112. In other examples, received emails sent to an email account or client may be retrieved periodically based on a set or irregular schedule. For example, an application hosted and running on server 112 may be configured to retrieve emails for further processing, as described below, on a set schedule (e.g., every 1, 5, 30, 60 minutes, or the like). Using various types of email receipt protocols (e.g., IMAP, POP, or others), emails may be retrieved from an email account or shared destination. Once retrieved by server 112, emails may be stored in database 114 and/or 116 and processed further to generated processed messages for posting to a shared environment (e.g., website 118). As used herein, an email account to which emails are sent for posting in a shared environment may be referred to as a “shared destination.”

A shared destination may be, in some examples, an email account hosted on server 112 that is configured to receive emails sent from various sources and intended for posting to a given website (e.g., website 118). Data associated with emails sent to a shared destination may be stored in database 114 or, in other examples, remotely stored in database 116.

As shown here, website 118 may be described as a “shared environment” or facility to which data, information, or other content may be posted or published. As used herein, “posting” or “publication” may be used interchangeably and are intended to refer to the format, transmission, upload, design, layout, and other parameters of content manipulated relative to a given environment (e.g., website 118, among others). In some examples, website 118 may be a website at which emails, attachments, data, information, or other types of content may be viewed, retrieved, posted, or deleted, without limitation. In other examples, system 100 and the above-described elements may be varied in function, structure, configuration, topology, quantity, type, or other aspects and are not limited to the examples shown.

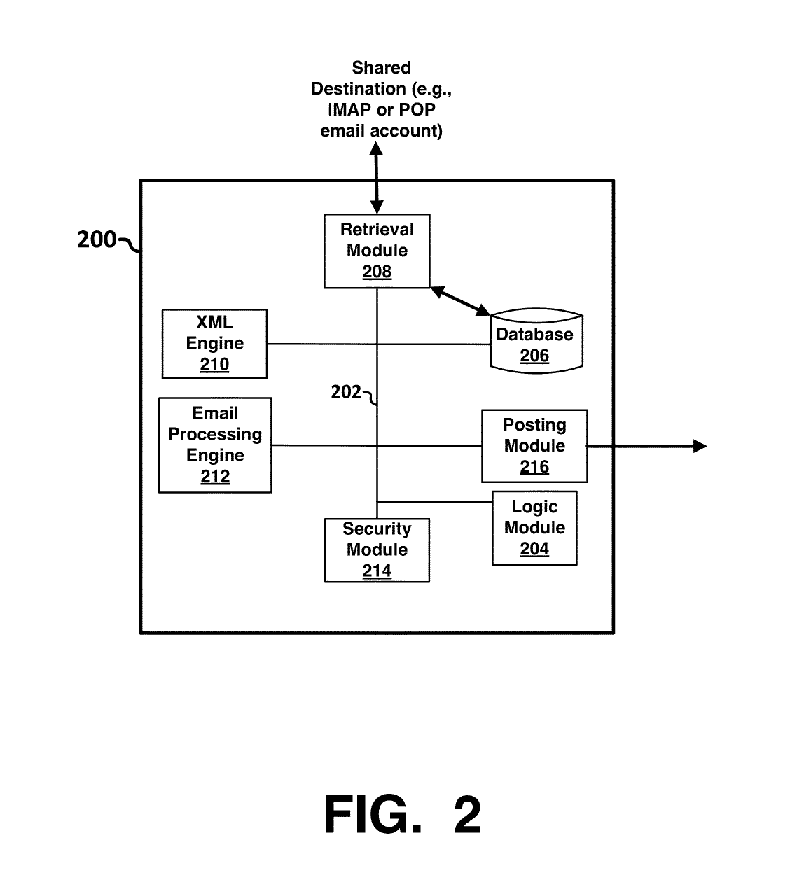

FIG. 2 an exemplary application architecture for electronic mail processing and publication for shared environments. Here, application 200 includes bus 202, logic module 204, database 206, retrieval module 208, XML engine 210, email processing engine 212, security module 214, and posting module 216. In some examples, bus 202 may be implemented as any type of data communication bus for transferring data between any of logic module 204, database 206, retrieval module 208, XML engine 210, email processing engine 212, security module 214, and posting module 216, without limitation to any given type, configuration, capacity, rating, or other characteristic. As shown, application 200 and the elements described herein (i.e., logic module 204, database 206, retrieval module 208, XML engine 210, email processing engine 212, security module 214, and posting module 216) may be implemented as hardware, software, firmware, circuitry, or a combination thereof and are not limited to any specific application structure or formatting, scripting, or programming language.

In some examples, logic module 204 may be configured to provide command and/or control signals, instructions, and functions to direct one or more of database 206, retrieval module 208, XML engine 210, email processing engine 212, security module 214, and posting module 216. Logic module 204, for example, may direct retrieval module 208 to identify, locate, and retrieve emails sent to a shared destination (e.g., IMAP or POP email account). Logic module 204 may also be configured to process retrieved emails to generate processed messages (i.e., retrieved emails that have been processed by email processing engine 212) for posting or publication in a shared environment (e.g., website 118 (FIG. 1)) prior to being directed to posting module 216 for posting to the shared environment (e.g., website 118). Further, logic module 204 may be configured to evaluate retrieved emails to determine whether a security threat (e.g., malicious software (hereafter “malware”), spyware (i.e., malware intended to passively gather data and information from a host operating system, computer, or application), cross site scripting, and others. Security module 214 may be implemented using various types of security software, firmware, or hardware, such as intrusion detection and prevention systems, anti-virus, or others, without limitation, that are intended to detect whether an email to be processed by email processing engine 212 is a security threat that, once posted to a shared environment (e.g., website 118) may be accessible and pose a security risk to other clients.

As shown, data may be stored in database 206 using any type of database, database schema, or storage mechanism, without limitation, including storage area networks (hereafter “SAN”), network attached storage (hereafter “NAS”), cloud storage, or the like. Further, retrieved emails may be stored using various types of markup and formatting languages such as XML and others. XML engine 210 is an example of a type of facility or resource that may be used to evaluate, format, and generate XML-formatted data to be stored, for example, in database 206 or, as another example, to be processed for posting to a shared environment (e.g., website 118) by email processing engine 212 and posting module 216. In other examples, application 200 may be implemented in any type of application environment, distributed or otherwise, using one or more application servers, computers, or computing platforms from which to host. Apart from the examples shown and described, application 200 and the above-described elements may be varied in function, structure, format, language, configuration, or other aspects and are not limited to any specific implementation.

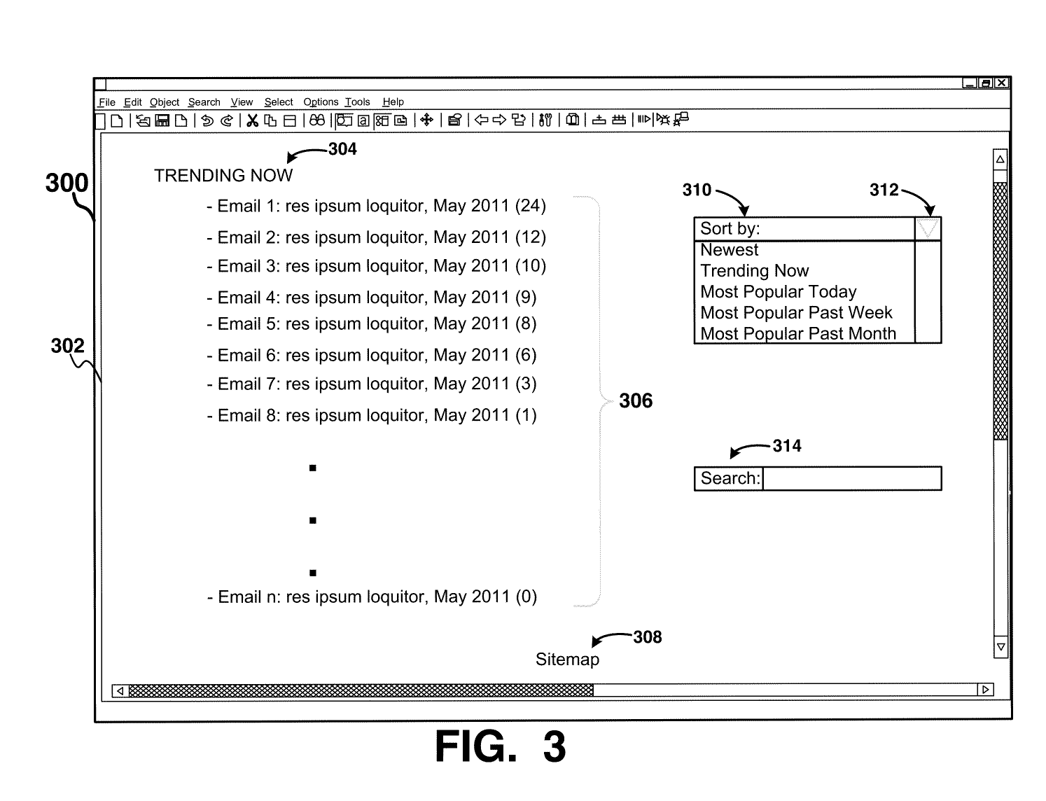

FIG. 3 illustrates an exemplary shared environment for publication of processed electronic mail messages. Here, window 300 includes shared environment 302, title tag 304, process messages 306, sitemap link 308, sort window 310, pulldown menu 312, and search field 314. In some examples, window 300 may be representative of a graphical user interface display that is presented by website 118 (FIG. 1). As shown, shared environment 302 may be a graphical display environment in which processed messages may be displayed and reviewed. Based on title tag 304, emails may be listed and displayed based on, for example, popularity (e.g., the number of comments posted in response to a given email posting, most popular today, most popular in past week, most popular in past month, and the like), age (i.e., newest-to-oldest, oldest-to-newest, and the like), trends of immediate interest (i.e., emails that are of immediate interest to the overall user or viewer population), or other factors apart from those described. As used herein, title tag 304 may be a descriptive title or categorical reference associated with a given email and other emails that are contextually or thematically related. In some examples, title tag 305 may use a format such as “<subject line of email>|SocialMail” in order to aid in search engine optimization (hereafter “SEO”). By using the subject line of an email as part of a header tag (e.g., H1 tag), the content, data, or information contained may be used to enhance search engine optimization to allow other users to find and retrieve processed messages 306. By using modifying the header tags of retrieved emails, processed messages 306 can be improved for SEO, facilitating searches performed for various topics, themes, keywords, or emails.

In some examples, the quantity of processed messages may be set to a discrete number per page (e.g., 10 per page, 100, 1000, customizable, user-specified, system-specified, rules-based, and others). Further, when a user navigates to a given page using, for example, a web (i.e., the World Wide Web (hereafter “web”)) browsing application processed messages 306 may be sorted based on criteria specified in sort window 310 by using pulldown menu 312. In this example, criteria such as “Newest,” “Trending Now,” “Most Popular Today,” “Most Popular Past Week,” and “Most Popular Past Month” may be chosen in order to sort processed messages 306. When selected, a criterion may cause processed shared environment 302 to be rendered such that the order is determined based on the selected criteria. In other examples, posted emails may be ranked using various techniques and, as an example, identified using the “Trending Now” feature. For example, posted emails may be ranked based on determining the number of users to which the posted email has been forwarded (e.g., if a posted email has been forwarded previously multiple times to an aggregate pool of 20 recipients, a quantitative rank may be assigned using various techniques, including assigning a weighted or unweighted ranking value based on the number of recipients (e.g., in the example above, 20)). In other examples, rankings may be performed differently using various techniques or algorithms, without limitation. As an indicator of activity within a service providing window 300, an “activity stream” or other type of feed or data stream may be created in which one or more posted emails, replies, comments, votes, rankings, or other activities occurring may be posted generally for users to view (in some contexts such as within corporate enterprises, this and other features may be suppressed in order to confine the applicability of the described techniques to prescribed enterprise purposes). In some examples, users may opt-in and subscribe to an activity stream in order to ensure that those users who do not elect to receive updates as to activity are not receiving unwanted notifications. In other examples, processed messages 306 may be sorted or displayed differently and are not limited to those shown and described.

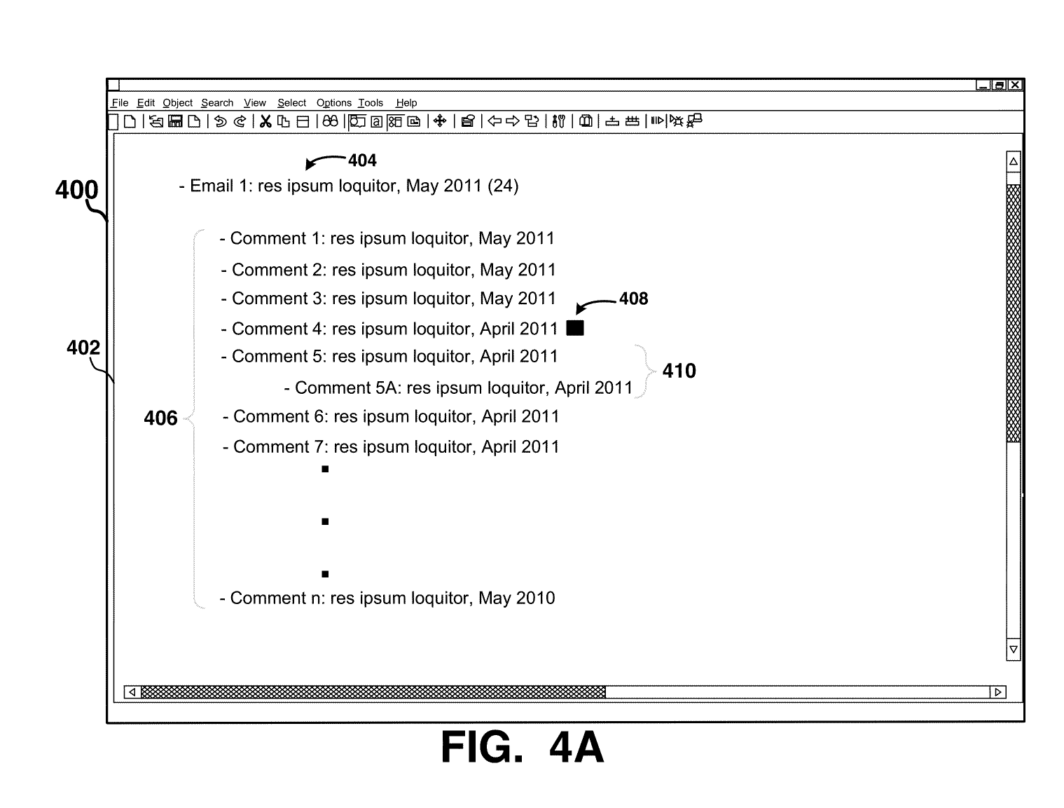

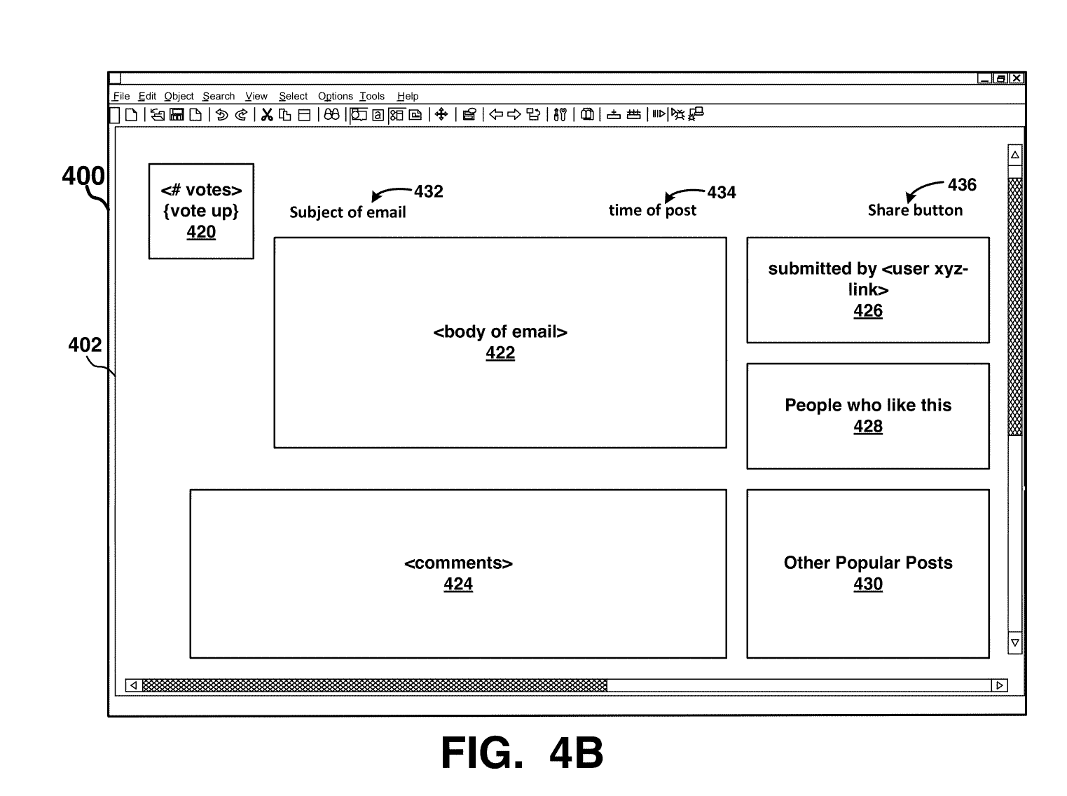

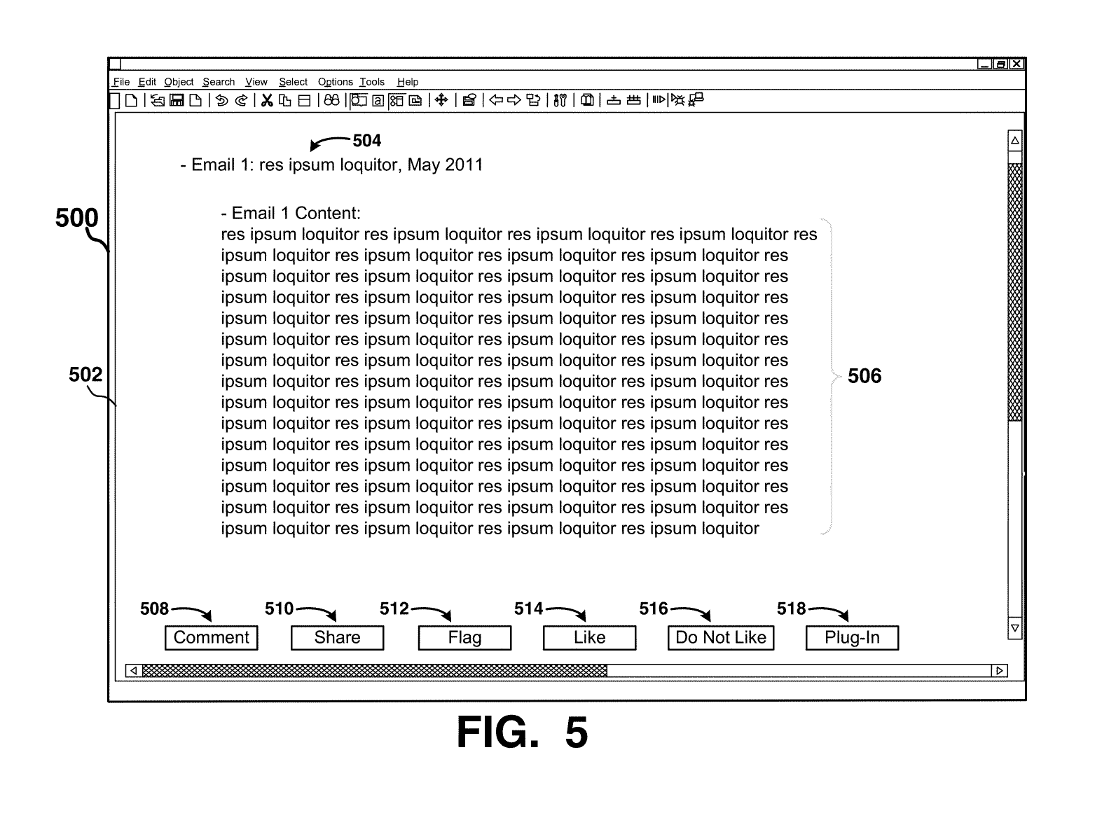

Here, processed messages 306 may also be searched using a facility that has an interface such as search field 314 to permit the entry of keywords or other items that may be used to select the appearance of processed messages 306. A search of processed messages 306 may be used to find email content (i.e., content, data, information, media, rich media, text, or the like) from a given pool of emails posted to shared environment 302. When posted, emails may be made “anonymous” (i.e., remove identifying information such as email addresses) in order to protect user privacy, as described in greater detail below in connection with FIG. 5. In some examples, each of processed messages 306 may be treated like an individual post that, when selected, is hyperlinked to another page where related emails of the same topic may be listed, as described below in connection with FIGS. 4A-4B.

Referring back to FIG. 3, shared environment 302 can be provided as a destination website (e.g., website 118) that enables the entry or submission of email content for various types of purposes (e.g., interest, humor, amusement, fun, business, enterprise/corporate, collaborative work sharing, and others, without limitation). Email content may be submitted using shared environment 302 to permit other users to enter comments or submit other emails related to a given topic or original email (i.e., threading), as indicated by title topic 304. Each email submitted may be processed by email processing engine 212 (FIG. 2) to be generated into a processed message and posted as part of a thread.

In other examples, users can view emails associated with topics of various types of interests. Within a corporate organization or enterprise (including for-profit, non-profit, governmental organizations), emails may be submitted for collective sharing and collaborative input by other members of the same organization. Likewise, security module 214 (FIG. 2) may be configured to provide additional security to permit authenticated use by members of a given organization as opposed to enabling shared environment 302 to be publicly accessible. Generally, shared environment 302 may be used as a forum for the sharing of email content that does not require the manual formatting of email content for posting. In other words, a user having an account recorded in one or both of databases 114-116 may forward or send emails to a service hosted by server 112, which may be processed by email processing engine 212 (as described in greater detail below in connection with FIG. 5) and posted to shared environment 302. Once made available to a community (e.g., public, closed, non-public, corporate, enterprise, and the like) of users, other emails may be posted directly to shared environment 302.

Additionally, sitemap link 308 may be used to hyperlink (i.e., linking (i.e., pointing a web browsing application to another address and retrieving and displaying content from that location) to another page of website 118) to another page of website 118 to retrieve and view information associated with posts (i.e., publications) of processed messages to shared environment 302. In some examples, by interacting with sitemap link 308, another web page is rendered that displays a list of processed messages classified by the month and year (i.e., posting date). Each entry of the list of processed messages (not shown) may be hyperlinked to another page that, when invoked, displays another page listing subject lines of individual posted processed messages and an excerpt of the related email. In some examples, the subject lines may also be hyperlinked to the complete post, which is displayed when the links are invoked. In other examples, the above-described examples may be varied in function, structure, format, language, configuration, or other aspects and are not limited to any specific implementation.

FIG. 4A illustrates a further exemplary shared environment for publication of processed electronic mail messages. Here, window 400 includes shared environment 402, title tag 404, processed messages 406, attachment icon 408, and threaded messages 410. As shown, if a hyperlink associated with one of processed messages 306 (FIG. 3) is invoked another web page may be rendered similarly to that presented in window 400. In some examples, a processed message and related processed messages may be presented in shared environment 402. A selected processed message may be indicated by title tag 404 and subsequent processed messages submitted in response or in relation to title tag 404 may be presented as a thread, as shown by processed messages 406. Further, one or more of processed messages 406 may have an attachment (i.e., an attached file, document, image, or other data or information), which may be indicated using, for example, attachment icon 408. In other examples, different types of icons, indicators, or indicia may be used to indicate visually or graphically whether an attachment is present. Further, attachment icon 408 may be hyperlinked to enable downloading, opening, viewing, or otherwise interacting with an attachment when a mouse pointer of other human computing interface (i.e., “HCI”) or input or input-output device is used to select (i.e., invoke) attachment icon 408. Still further, other emails may be submitted for generation of additional processed messages as extended threads, as shown by threaded messages 410.

As shown, each of processed messages 406 may be hyperlinked and, when invoked, may initiate the instantiation and rendering of another window that displays data, information, or other content associated with the selected processed message. As described in greater detail below in connection with FIG. 5, a selected processed message may be configured to direct a web browsing application (not shown) to an address that is associated with another web page that presents content such as the original email of the processed message selected. Some data, information, or content may also be modified in the new window (not shown) in order to provide data security, prevent unauthorized access, or perform other functions that would be beneficial to a collaborative data sharing environment such as shared environment 402. In still other examples, window and shared environment 402 may be implemented differently in layout, design, function, structure, features, or other aspects and are not limited to those shown and provided.

FIG. 4B illustrates an alternative exemplary shared environment for publication of processed electronic mail messages. Here, window 400 includes shared environment 402, sections 420-430, data 432-434, and button 436. In some examples, window 400 may be implemented as a graphical user interface such as that associated with a web browser or other web browsing application. As shown window 400 may be configured to present a page that displays several different functions or structures. For example, section 420 may be implemented to present the number of votes associated with a given email that is submitted and posted, as indicated by data 432 (e.g., “Subject of email,” which may be identified from a processed email), data 434 (e.g., “time of post,” which may also be posted from a processed email), section 422 (e.g., the body of the email, section 426 (e.g., identification of a posting user based on an “anonymized” email address or other user name (e.g., “user xyz,” which may be hyperlinked to another page that provides one or more details associated with a given user. Alternatively, when an email is posted, a user may “claim” ownership of a given email by creating a user account, such as that described herein, associated with the sending email address of the posted email.

Further, any email that is posted in window 400 may also include information associated with the number of votes received by other users (e.g., section 420), comments from one or more other users, which may also include replies to comments from the posting email sender (e.g., section 424), people indicating their “like” (or in some examples, dislike (not shown)) of the posted email (e.g., section 428), or related information or data (e.g., other posts that may be related contextually, thematically, by sender, by topic, and others, without limitation) associated with the given posted email (e.g., section 430). In some examples, users may vote for various purposes, including expressing their like, dislike, favor, disfavor, or other action or expression associated with a given posted email. Still further, if a given reader (i.e., user) likes the posted email, she may elect to share the post with another user by using an interactive feature or function such as button 436 that may open another window (not shown), field (not shown), interface (not shown), or the like that permits entry of another user's identifying information (e.g., email address, user name, or the like) in order to share the posted content. As an example, third party applications such as Facebook, Inc. of Menlo Park, Calif., may be coupled to an application implementing the described techniques (including, but not limited to window 400) enabling users (e.g., user xyz) to share the posted content with other users using the third party application (e.g., Facebook, Twitter (as developed by Twitter, Inc. of San Francisco, Calif.), blogs, and other online applications, social media, media, or the like, without limitation). In some examples, users may not have an account with other social media business, websites, or the like. However, the described techniques enable users to post content (e.g., emails) and share them with other users through, for example, an application programming interface (API) to these other websites using posting module 216 (FIG. 2). Referring back to FIG. 4B, users may also have accounts with third party websites and features may be included to enable these users to share content using the described techniques. In other words, the described techniques may be implemented as a service apart from various types of content or social media or entertainment websites, but enable users to share, send, forward, reply to, retrieve, or perform other functions associated with posted emails without requiring the creation of user accounts. As another example, the techniques described herein may be used by individual or organizations such as corporate enterprises.

For example, a corporate enterprise may use the described techniques in order to provide a closed or private (e.g., corporate or in-enterprise) forum or enterprise for its employees to share email content in a collaborative manner. In some examples, corporate employees may post emails using their corporate email addresses. In other examples, corporate employees may post emails using assigned or self-identified user names that mask an individual email address in order to prevent unwanted responsive email or comments to the posted content. In still other examples, by posting emails using the described techniques, various individuals or stakeholders within a corporate organization may be placed on a notice of a given user's posted email without requiring the user to individually and specifically identify various addressees. The described techniques aid in eliminating time and labor-intensive email creation efforts that corporate users often must undergo in order to notify supervisors, managers, executives, co-workers, project team members, and the like.

As shown, various types of purposes may motivate the described techniques for use within a corporate enterprise. In some examples, when a user is included as an addressee on a posted email, she may elect to stop or continue receiving notification of the posted emails, comments, votes, and other actions associated with these. In other examples, posted email subject lines may be used to initiate a discussion forum associated with the given subject. For example, if a subject line states “Sales Contract,” the subject line may render the posted email and associated content (e.g., FIG. 4B) available to a user when constructing an email, regardless of whether the user is the original author of the email. In other words, a user can use the described techniques to send an “inline” or in-thread reply or forward the email to another user who is separate and apart from the population having access to the posted email (in some examples, the user may be outside of the corporate enterprise or organization). In still other examples, window and shared environment 402 may be implemented differently in layout, design, function, structure, features, or other aspects and are not limited to those shown and provided.

FIG. 5 illustrates another exemplary shared environment for publication of processed electronic mail messages. Here, window 500 includes shared environment 502, title tag 504, processed message content 506, comment function 508, share function 510, flag function 512, like function 514, do not like function 516, and plug-in function 518. In some examples, the quantity, type, function, structure, or other aspects of window 500 and the elements shown may be varied and are not limited to those presented, which are provided for purposes of exemplary explanation. As shown, when one of processed messages 406 is selected, a web browsing application or other type of client interface may be opened in window 500, displaying processed message content 506 and indicating it is related to the selected processed message by title tag 504

Further, shared environment 502 may be designed and implemented to provide one or more functions that may be used in connection with processed message content 506. For example, a comment may be entered in association with processed message content 506 by interacting with comment function 508, which may be implemented as a button or link. When selected, comment function 508 may be configured to open a field, form, or altogether new web page in which a user may enter a subsequent comment using a variety of formats. Likewise, if selected, share function 510 may be used to share processed message content 506 with another user by, for example, emailing or using text-based messages via simple messaging service (i.e., “SMS”) or another format or protocol. Further, processed message content 506 may also be “flagged” or indicated as being inappropriate, undesirable, copied, or otherwise by invoking flag function 512. Other functions that may be invoked include like function 514 and do not like function 516.

In some examples, if a user “likes” or wishes to publicly indicate her favor for processed message content 506, she may place a tag or mark to indicate such by invoking like function 514. Likewise, she may also invoke do not like function 516 to indicate that processed message content 506 is undesirable to her. By invoking popularity-related functions such as these, ranking of published message content 506 may be performed. As yet another function, plug-in function 518 may be invoked to connect, couple, distribute, publish, send, re-send, or perform other functions associated with a third-party website or service. For example, social media websites that permit user posting of data may provide an application programming interface (“API”) that may be used to feed content in a given format for posting or publication. By invoking plug-in function 518, processed message content 506 may be posted to other shared environments such as Facebook (as developed by Facebook, Inc. of Palo Alto, Calif.), LinkedIn (as developed by LinkedIn, Inc. of Mountain View, Calif.), and many other social media-related services, sites, and destinations. In other examples, window 500 and the above-described elements may be implemented differently in layout, design, function, structure, features, or other aspects and are not limited to those shown and provided.

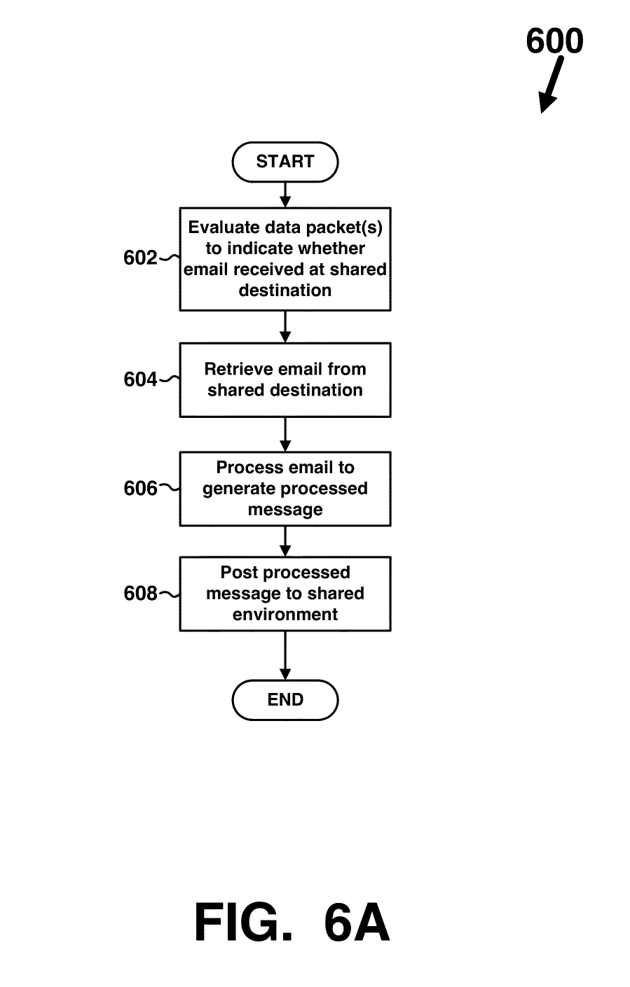

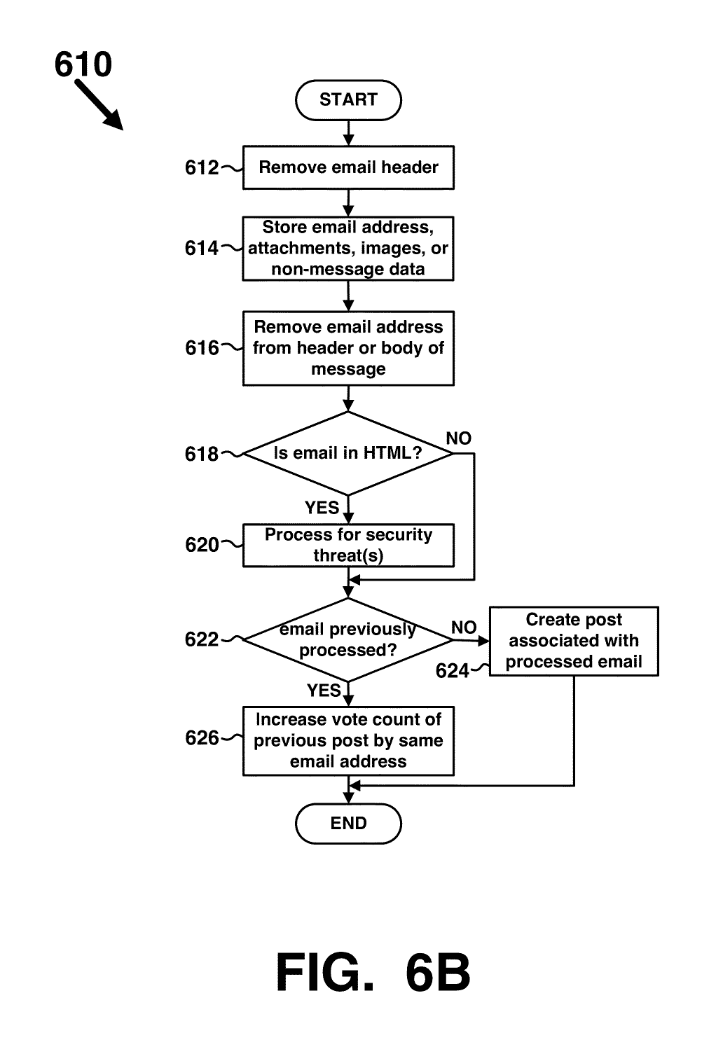

FIG. 6A illustrates an exemplary process for electronic mail processing and publication for shared environments. Here, process 600 starts by evaluating one or more data packets associated with an email that is received at a shared destination such as an email account or server (602). Upon detecting, based upon the evaluation of data packets to determine whether mail has been received (using either an IMAP or POP-based protocol), the received email is retrieved (604). Once retrieved, the email is processed to generate a processed message, such as that described above in connection with FIGS. 3-5 (606). Once processed, a processed message is posted to a shared environment such as website 118 (FIG. 1) (608).

As shown, data may be analyzed using various techniques. For example, data packets may be evaluated by analyzing a given domain associated with the sending email address. A corporate enterprise, as an example, may have a given domain (e.g., company.com) that is evaluated in order to provide message visibility to other users having the same domain. This may be implemented in order to provide a service to users and/or accounts within the given domain in order to prevent access to information or data. In other examples, the above-described process may be varied in the implementation, order, function, or structure of each or all steps and is not limited to those provided.

FIG. 6B illustrates an alternative exemplary process for electronic mail processing and publication for shared environments. Here, process 610 begins by processing an email submitted using the described techniques by removing email headers, which may include one or more email addresses (e.g., sender, destination, intermediate (i.e., email addresses found within a thread of emails such as a forward or chain of multiple replies, and the like) (612). For privacy, security, and other similar reasons, source-identifying information such as email addresses may be removed. In some examples, a received email may be processed for privacy reasons by parsing data associated with the posted email. The email address may be stored along with any non-message data, which may include attachments or embedded images of any kind or format (614). Non-message data, in some examples, may also be identified as any type of information or data that is not related to the message body. In other examples, non-message data may be any data that is not found within the payload of a message body. In still other examples, data to be stored in a database (e.g., database 206 (FIG. 2)) may be determined differently. The email address is then processed to identify any email addresses within the header or the body, which may be stored as fields or records associated with the sending email address in a database (616). A determination is made as to whether the email being processed is in HTML (i.e., Hyper Text Markup Language) or an HTML-based format (618). If the email being processed is in HTML or an HTML-based format (e.g., XHTML, DHTML, XML, and others, without limitation), then the email is processed for security threats (e.g., virus, malware, spyware, cross-site scripting, and others, without limitation) (620). If the email is not in HTML or an HTML-related format, then process 610 does not perform a security check.

In some examples, a check may be performed to determine whether the email being processed was previously processed (622). If the email was not previously processed, a new post with the email should be created (624). If the email was previously processed, in some examples, a vote count associated with the email may be incremented or increased. In other examples, the above-described process may be performed or implemented differently in steps, order, function, or other aspects, without limitation to those provided.

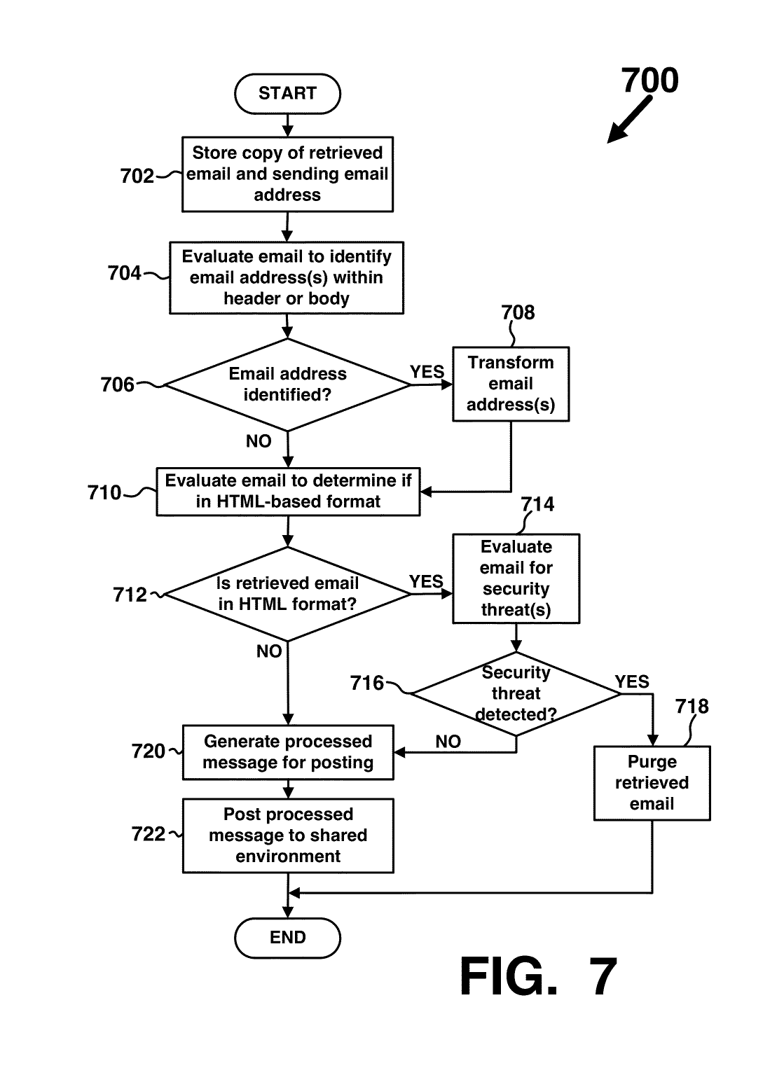

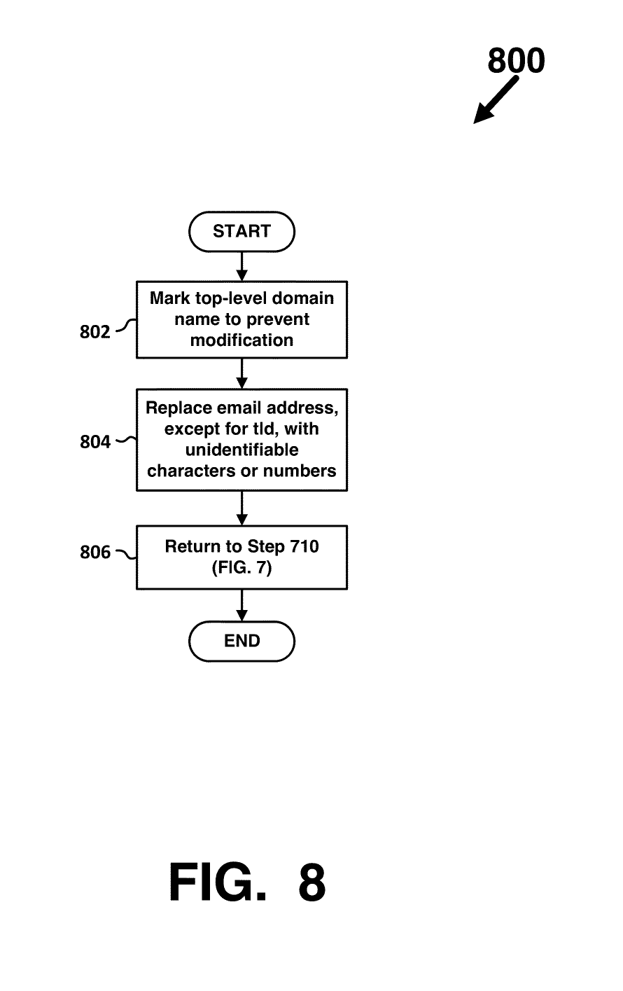

FIG. 7 illustrates a further exemplary process for electronic mail processing and publication for shared environments. As an exemplary illustration of generating processed messages, process 700 may be implemented. Here, process 700 starts by storing a copy of a retrieved email and recording the email address of the sending account or client (702). After storing in database 114 and/or 116 (FIG. 1) a copy of the retrieved email and email address of the sending account or client, the retrieved email is evaluated to identify whether there are email addresses within the header or body (i.e., payload) data of the email (704). A determination is made as to whether any email addresses are identified (706). If an email address is identified in either the header or body of the retrieved email, then the identified email addresses are transformed, which is described in greater detail below in connection with FIG. 8 (708).

Referring back to FIG. 7, if no email address is identified, then the retrieved email is further processed by evaluating the format of the email to determine whether it is in an HTML-based format (710). A determination is made as to whether the retrieved email is in an HTML-based format (712). If the email is in an HTML-based format, then it is further evaluated for security threats such as cross site scripting and others as described above (714). A determination is made as to whether a security threat is present (716). If a security threat is identified, then the retrieved email is purged and not stored in database 114 and/or 116 (718). In other examples, an alert message or other warning may be sent to the user of system 100 (FIG. 1) to indicate that a security threat was found. If no security threat is found, then a processed message is generated using the transformed email addresses (720). After generating a processed message, it may be posted to a shared environment (e.g., website 118 or shared environments 302 (FIG. 3), 402 (FIG. 4), or 502 (FIG. 5)) (722). In other examples, the above-described process may be varied in the implementation, order, function, or structure of each or all steps and is not limited to those provided.

FIG. 8 illustrates an exemplary process for transforming email addresses for electronic mail processing and publication for shared environments. Here, process 800 beings by marking or otherwise indicating a top-level domain (hereafter “TLD”) associated with the email in order to prevent modification (i.e., transformation) as described herein (802). After marking or indicating the TLD associated with the email, all other characters associated with the domain name are replaced with unidentifiable characters or numbers (804).

For example, an email address “joe@smith.com” may be transformed by marking the “.com” for non-modification and replacing “joe@smith” with unidentifiable characters such as “xxx@xxxxx.” Thus, the email address in the example above may be transformed from “joe@smith.com” to “xxx@xxxxx.com.” After transforming identified email addresses in the header or body (i.e., payload data) of a retrieved email message, the process then returns to step 710 (FIG. 7) to continue processing for generating a processed message (806). In other examples, the above-described process may be varied in the implementation, order, function, or structure of each or all steps and is not limited to those provided.

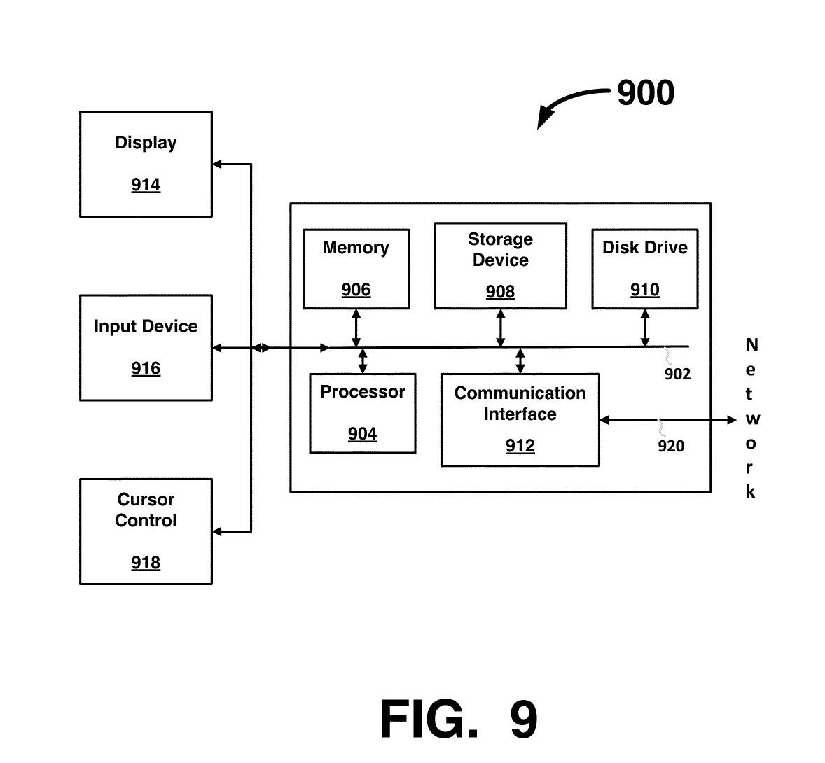

FIG. 9 illustrates an exemplary computer system suitable for electronic mail processing and publication for shared environments. In some examples, computer system 900 may be used to implement computer programs, applications, methods, processes, or other software to perform the above-described techniques. Computer system 900 includes a bus 902 or other communication mechanism for communicating information, which interconnects subsystems and devices, such as processor 904, system memory 906 (e.g., RAM), storage device 908 (e.g., ROM), disk drive 910 (e.g., magnetic or optical), communication interface 912 (e.g., modem or Ethernet card), display 914 (e.g., CRT or LCD), input device 916 (e.g., keyboard), and cursor control 918 (e.g., mouse or trackball).

According to some examples, computer system 900 performs specific operations by processor 904 executing one or more sequences of one or more instructions stored in system memory 906. Such instructions may be read into system memory 906 from another computer readable medium, such as static storage device 908 or disk drive 910. In some examples, hard-wired circuitry may be used in place of or in combination with software instructions for implementation.

The term “computer readable medium” refers to any tangible medium that participates in providing instructions to processor 904 for execution. Such a medium may take many forms, including but not limited to, non-volatile media and volatile media. Non-volatile media includes, for example, optical or magnetic disks, such as disk drive 910. Volatile media includes dynamic memory, such as system memory 906.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 902 for transmitting a computer data signal.

In some examples, execution of the sequences of instructions may be performed by a single computer system 900. According to some examples, two or more computer systems 900 coupled by communication link 920 (e.g., LAN, PSTN, or wireless network) may perform the sequence of instructions in coordination with one another. Computer system 900 may transmit and receive messages, data, and instructions, including program, i.e., application code, through communication link 920 and communication interface 912. Received program code may be executed by processor 904 as it is received, and/or stored in disk drive 910, or other non-volatile storage for later execution.

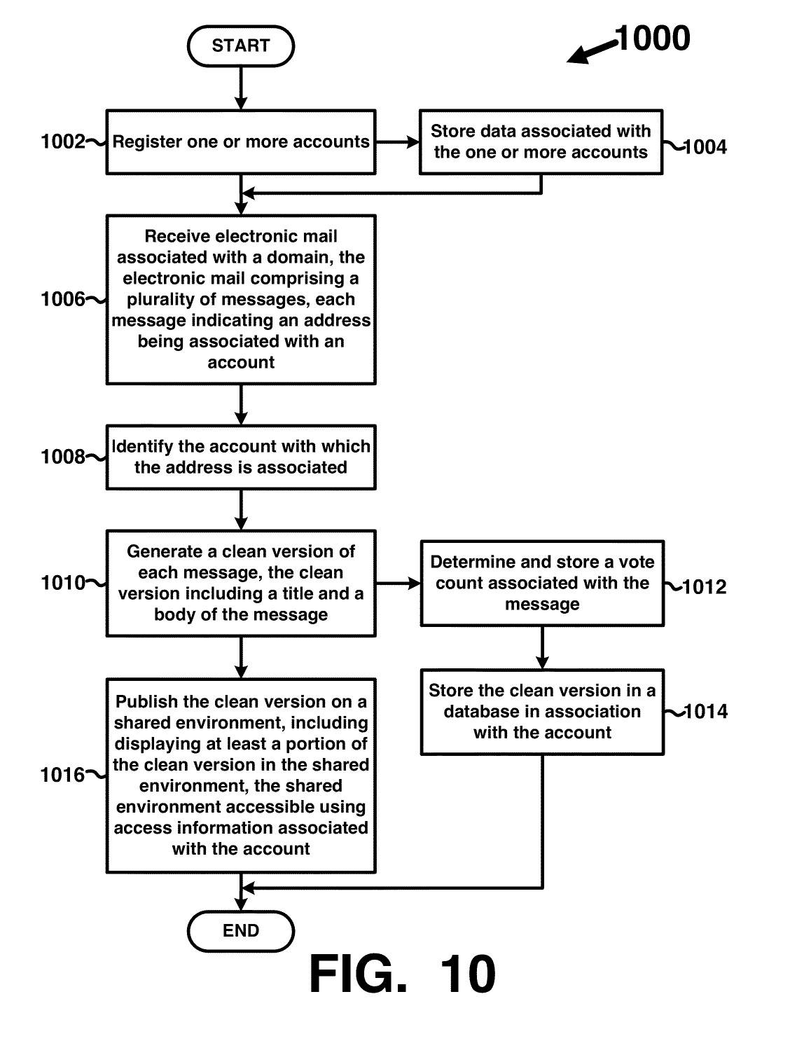

FIG. 10 illustrates an exemplary process for aggregating and cleaning electronic mail for publication on shared environments. Here, process 1000 begins with registering one or more accounts (1002). As used herein, an account may be an email account providing an address (i.e., email address) to which email messages (i.e., “messages” or “email”) may be sent. For example, the account may be a shared destination, as described herein. In some examples, an account may be associated with a system for electronic mail processing and publication, as described herein. In some examples, an account may be registered for an address to which certain types or categories of email may be sent. For example, a user may register for an account devoted to receiving social emails, email newsletters, marketing or promotional emails, other subscription or opt-in emails, or other types of emails. In some examples, an account may be associated with a user through access information provided by the user during registration of the account. The access information may include one or more of a username, password, pin number, identification image or graphic, passcode, customer number, security questions, and other manners of identification. In some examples, the access information may include a user's access information (e.g., email account information, username, password, or the like) for accessing a previously registered social network account (e.g., an account with Facebook, Twitter, Google+, or other social network service). Data associated with the one or more accounts (e.g., access information, email address, and other information associated with the accounts) may be stored (e.g., in a database, repository, hard disk, or other storage) (1004). In other examples, an account may be registered using new access information created particularly for an electronic mail processing and publication account (i.e., not shared with a social network account). In still other examples, an electronic mail and publication account may be created using an option provided in connection with a sign-up email or webpage for subscription or opt-in email (e.g., newsletters, marketing or promotional emails, or the like). For example, an email or webpage used for signing up for, or opting into, a newsletter or marketing email, may provide a user with an option to create and use an electronic mail and publication account to view and manage those opt-in emails. In some examples, such an option may be provided as a link to an account setup page configured to create an electronic mail and publication account. In yet other examples, an electronic mail processing and publication account may be created through a link from an email sent to a different email account. For example, a content provider (i.e., merchant, marketing firm, or the like), as described below, may provide an option in an unsubscribe (i.e., opt-out or email preferences) window, email or webpage to set up an account with an electronic mail processing and publication account for managing subscription emails (e.g., newsletters, marketing or promotional emails, or other opt-in emails). Using this option, a user may register, or set up, an account with an electronic mail processing and publication account for better management of subscription or opt-in emails, as described herein. Providing this option may decrease the number of users that unsubscribe from receiving content from a content provider. In still other examples, an account may be registered differently and are not limited to those shown and described.

Once the account is registered, electronic mail associated with a domain may be received, the electronic mail comprising a plurality of messages, each message indicating an address being associated with an account (1006). In some examples, the domain may be a single domain, or a set of domains, associated with a system for electronic mail processing and publication. In some examples, a domain may be associated with a plurality of accounts, each account having an address associated with the domain. For example, multiple addresses may have the same domain (i.e., “@socialmail.com”), and a plurality of email messages addressed to one or more addresses associated with a domain, or a set of related domains, may be received by a system for electronic mail processing and publication. In some examples, the electronic mail associated with a domain, or set of domains, may be received, or aggregated, into a “catch all” or general mailbox configured to receive mail sent to multiple email addresses (e.g., a set of email addresses provided by an electronic mail processing system or service, a set of email addresses associated with the same domain, or the like). As used herein, “catch all mailbox” refers to a general mailbox configured to receive and aggregate email from a group, set, or other multiple of, email addresses (e.g., a group of related email addresses, a group of email addresses that share a domain, email addresses associated with a group of related domains, email addresses for a company or other entity, or other groups of email addresses). For example, a catch all mailbox may be configured to receive email sent to all or substantially all email addresses having the same domain, and a Javascript program may be employed to process the contents of the catch all mailbox (i.e., to parse the emails as described below). In other examples, email messages associated with each address may be received into an individual mailbox for the address. In still other examples, different types and numbers of mailboxes may be implemented for receiving email.

In some examples, email messages may be received directly from a content provider (e.g., Responsys®, Constant Contact®, Vertical Response®, or the like) through, for example, an API. As used herein, a content provider may be a merchant, an organization, a collective, a firm, or any other type of entity, engaged in providing information (e.g., advertisements, newsletters, updates, or other marketing materials) to subscribers, or other groups of opt-in recipients, using email. In some examples, an API may be configured to receive messages from content providers and deliver those messages to a user by way of a suitable environment (e.g., shared environment 1102 in FIG. 11, which may avoid incorrectly, improperly, or unnecessarily flagging or filtering a message). In some examples, an API implemented by an application for email processing and publication on shared environments (e.g., application 200 in FIG. 2) may be configured to receive or obtain email, or email content, from a content provider for subscribers having an account associated with the application without using third party email networks or servers, and to bypass one or more filters (i.e., spam filters) implemented by third party email networks or providers. In some examples, such an API may be configured to process data associated with dynamic content (e.g., video, audio, animation, links, interactive content, or the like) for presentation on a shared environment in an intended format, such that a user may view video or animation content, listen to audio, or the like, in a shared environment. For example, such an API may be configured to receive and process data associated with a video to generate output associated with presentation of the video on a tile in a shared environment. In another example, such an API may be configured to receive and process data associated with an image to generate output associated with presentation of the image on a tile in a shared environment. In some examples, some (i.e., multiple) or all messages in a shared environment (e.g., shared environment 1102 in FIG. 11, or the like) may be presented in an “open” format, where some or all contents (i.e., core, essential or cleaned contents (e.g., subject, title, or body of a message, or the like) of a message, including graphics, images, video and other content, may be readily viewed without clicking on a link, list, item, or other feature associated with each message, on a page. In other examples, email may be received through SMTP or other protocols, as described herein.

In some examples, an account may be configured to store (i.e., in database 206 in FIG. 2) and manage a user's email subscriptions. In some examples, the account associated with an application for email processing and publication on a shared environment (e.g., application 200 in FIG. 2) may be configured to retrieve or receive (i.e., using an API, as described herein) subscription emails directly and/or securely from content providers to which the account is subscribed, and to filter and not publish to a shared environment emails from content providers to which the account does not subscribe. For example, emails received for an address may be checked against a stored list of subscriptions for an account associated with the address before publication on a shared environment. In an example, if an email message is received from a content provider to which the account associated with a recipient address is not subscribed, the email message may not be published. In another example, if an email message is received from a content provider to which the account associated with a recipient address is subscribed, the email message will be given a high priority position in a shared environment (e.g., shared environment 1102 in FIG. 11), and if the email message is received from a content provider to which the account is not subscribed, given a low priority position in a shared environment (e.g., shared environment 1102 in FIG. 11).

Once the electronic mail is received, the account with which the address for each message may be identified (1008). In some examples, this may include reading the “To” line, or other recipient information, from a header section to determine the address to which the message is being sent, and matching the address to an account, for example, using a lookup or otherwise searching a database for an account associated with the address (i.e., using Javascript). In other examples, an account with which an address for a message may be identified differently and are not limited to those shown and described.

Once an account is identified, a clean version of each of the messages may be generated, the clean version including a title and a body of the message (1010). As used herein, a “clean version” of a message is one in which a parsing algorithm has cleaned, or removed (i.e., extracted and separately stored), personally identifiable information in the message. As used herein, “personally identifiable information” refers to information that may be used to uniquely identify, contact, or locate a user (e.g., a name, an e-mail address, a phone number, a social security number, driver's license number, other identification number, a biometric signature, or other form of identification). In other examples, sensitive information other than personally identifiable information also may be cleaned from a message. In some examples, personally identifiable or other sensitive information may be identified and cleaned from a message header (e.g., sender, recipient, route, or other header data). In other examples, personally identifiable or other sensitive information may be identified and cleaned from other portions of the message (e.g., body, other content, metadata, or the like). In still other examples, a clean version of a message may be generated differently and is not limited to those shown and described.

In some examples, a vote count associated with the message may be determined and stored (1012). For example, a comparison against previously received email messages may be conducted to determine, or update or increment, a vote count based upon the number of times an identical or substantially identical email message has been sent to other users (i.e., other accounts). In another example, a vote count for a message may be determined, or updated or incremented, based upon a number of times the message has been forwarded from one user to another user. In still another example, a vote count for a message may be determined, or updated or incremented, based upon a number of times the message has been posted, recommended, liked, shared or otherwise acted upon by a user to indicate a preference, or positive impression of, the message (e.g., by clicking a hyperlink to recommend, share or like a message on Facebook, by clicking a hyperlink to share a message on Twitter, by clicking a hyperlink to recommend (i.e., plus one) on Google+, or the like). In some examples, such vote counts may be determined using comparisons of a clean version of a message with data previously stored and associated with identical or substantially identical messages. In some examples, a vote count may be displayed on a shared environment (e.g., shared environment 1102 in FIG. 11), for example, in a tile for a corresponding message. In other examples, a vote count for a message may be determined, updated or incremented, differently and are not limited to those shown and described.

In some examples, the clean version may be stored in a database, or other storage as described herein, in association with the account to which it was sent (1014). In some examples, a clean version also may be published in a shared environment (i.e., shared environment 1102 in FIG. 11, or the like), including displaying at least a portion of the clean version in the shared environment, the shared environment accessible using access information associated with the account (1016). A shared environment may be a website (e.g., website 118 or the like), or other facility, to which data, information, or other content may be posted or published, as described herein. In some examples, the access information may be the access information used in registering the account. In some examples, publication of a clean version may include publishing data from the clean version on a tile on a shared environment (i.e., FIG. 11). For example, a tile on a shared environment might include, or show, a timestamp (i.e., indicating a day, date and/or time that the message was sent), an age (i.e., indicating how long ago the message was sent), a subject (i.e., the subject line of the message), a body (i.e., some or all of a body of the message), a graphic (i.e., some or all of the graphics from the message), an unsubscribe button, other buttons for executing an action associated with the message (e.g., comment, like, share, or otherwise provide feedback), or other aspects of the message. Displaying one or more messages in a prioritized (e.g., left to right, top to bottom, and the like, according to one or more criteria) and tiled format, or other web browsing interface, on a shared environment may promote readability (i.e., messages may be easier to see, read, review, skim, or otherwise be visually consumed by a user), as described below (FIG. 11). In some examples, a shared environment may include other items (e.g., hyperlinks, buttons, icons, widgets, or the like) for sorting, prioritizing, sharing, searching, or performing other acts associated with a published clean version of a message (see, e.g., FIG. 11). In some examples, a message may be tagged (i.e., in a database) as published after a clean version of the message is posted on a shared environment, such that a shared environment may be updated with new messages without re-publishing previously published messages. In other examples, the above-described process may be performed or implemented differently in steps, order, function, or other aspects, without limitation to those shown and described.

FIG. 11 illustrates an exemplary shared environment for publication of aggregated and cleaned electronic mail messages. Here, window 1100 includes shared environment 1102, share button 1106, filters 1108-1120, search field 1122, tiles 1124-1138, timestamps 1140-1150, subjects 1152-1162, message bodies 1164-1178, comment icons 1180-1186, vote icons 1188-1194, and unsubscribe buttons 1196-1202. In some examples, shared environment 1102 may be a website (e.g., website 118 or the like), including various pages associated with an account in a system for electronic mail processing and publication. In some examples, shared environment 1102 may be provide or display email data for, or associated be associated with, an account. In some examples, each account may be associated with, and accessed using, a website having a uniform resource locator (URL). For example, account information and emails received using an account associated with a domain name and a username may be accessed using a website having an URL in the format of “http://<domain name>/<username>.” For example, an account for Joe Smith may be associated with a website at “http://socialmail.com/JoeSmith.” In this example, Joe Smith's account may be configured to receive, process, and publish at “http://socialmail.com/JoeSmith,” email messages sent to the address JoeSmith@socialmail.com. In some examples, access to a website may be secured using a password, passcode, security question, or the like. In other examples, a shared environment may be provided and accessed differently and is not limited to those shown and described.

As shown, shared environment 1102 may display, show, or otherwise publish, cleaned versions of email messages in an open tiled format, where the contents of a cleaned version of a message is displayed in a tile, for example, including image, video, or other content. For example, each of tiles 1124-1138 may represent (i.e., show, display, be associated with, or the like) a cleaned version of a message. Each tile may display a timestamp or age of a message (e.g., timestamp 1140-1150), a subject of a message (e.g., subjects 1152-1162), and a part or all of a body of a message (e.g., message bodies 1164-1178). For example, timestamp 1140 may indicate a day, date and/or time in which a message (i.e., having subject 1152 and body 1164) was sent. In another example, timestamp 1140 may indicate an age of a message (i.e., number of hours, days, months, or the like, since the message was sent). Timestamps 1142-1150 may be implemented in a similar manner as described above with respect to timestamp 1140. In some examples, subjects 1152-1162 each may display a subject line from each of the messages represented in tiles 1124-1126, 1130-1134 and 1138, respectively. In some examples, subjects 1152-1162 may display text. In other examples, subjects 1152-1162 may display a graphic (i.e., logo, image, or other graphic). In some examples, message bodies 1164-1178 may include text, one or more graphics, hyperlinks (e.g., to or provided by a content provider, as part of an advertisement by a content provider, or the like), or other material from a body of a message. For example, message body 1164 may display a body of a message associated with subject 1152 and timestamp 1140, which has been cleaned of any personally identifiable and sensitive information. In some examples, message body 1164 may display an entire body of a clean version of the message. In other examples, message body 1164 may display a part or portion of a body of a clean version of the message. In some examples, tiles 1124-1138 may be laid out on shared environment 1102 as shown, with all or substantially all email messages on shared environment 1102 displayed in an open format, showing at least a part (i.e., a key or essential part (e.g., an image, a video, a significant portion of text, or the like)) or all of the clean content of the message. In other examples, tiles may be laid out differently on a website and are not limited to those shown and described.

In some examples, each of tiles 1124-1138 also may display an unsubscribe buttons (e.g., unsubscribe buttons 1196-1202), which may link (i.e., hyperlink) to another page (e.g., in a pop-up window, in a new tab in window 1100, in the same window (i.e., window 1100), in a separate window, or the like) configured to unsubscribe from a message. As used herein, “linking,” “link to,” and “hyperlink” refers to pointing a web browsing application to another address (i.e., URL) and retrieving and displaying content from that location. In an example, unsubscribe button 1196 may link to a page associated with a sender or source (i.e., content provider) of a message (i.e., a clean version, in whole or in part) displayed in tile 1124 for unsubscribing to emails from that sender. In another example, an invocation (e.g., by clicking, placing a cursor over, or otherwise selecting) of unsubscribe button 1196 may automatically unsubscribe a user (i.e., an account) from receiving email messages from a sender (i.e., of the message shown in tile 1124. Unsubscribe buttons 1198-1202 each may function similarly for the respective email messages shown in tiles 1128, 1132 and 1136. In still other examples, an unsubscribe button may be implemented differently and is not limited to those shown and described.

In some examples, each of tiles 1124-1138 also may display a comment icon (e.g., comment icons 1180-1186). In some examples, a comment icon may link to another page or website (e.g., in a pop-up window, in a new tab in window 1100, in the same window (i.e., window 1100), in a separate window, or the like) displaying comments associated with a message. For example, comment icon 1180 may link to another page or another website displaying comments associated with a message (i.e., a clean version, in whole or in part) displayed in tile 1124. Likewise, comment icons 1182-1186 may, respectively, link to pages or websites displaying comments associated with messages displayed in tiles 1128, 1132 and 1136. In other examples, a comment icon may link to another page or website providing a user interface for entering comments associated with a message. In yet other examples, a comment icon may be implemented differently and is not limited to those shown and described.

In some examples, each of tiles 1124-1138 also may display other icons for providing feedback (e.g., vote icons 1188-1194). As shown, vote icons 1188-1194 may be displayed as a graphic or image (i.e., Facebook's thumb-up graphic, Twitter's bird graphic, Google's Google+ logo, or other image) with a number next to it, the number indicating a vote count associated with a message shown in the respective tile (e.g., vote icon 1188 indicates the vote count for a message shown in tile 1124 (i.e., associated with subject 1152 and body 1164), vote icon 1190 indicates a vote count for a message shown in tile 1128 (i.e., associated with body 1168), and so on). A vote count may be a number of votes representing various types of feedback (e.g., “likes” on Facebook, pluses on Google+, number of times a message (i.e., a message displayed in the same tile as the graphic or image) is forwarded, or other feedback). In some examples, a vote count may indicate or represent the number of times a message was sent to other users (i.e., other accounts). In other examples, a vote count may indicate or represent a number of times the message has been forwarded from one user to another user. In still other examples, a vote count may indicate or represent a number of times the message has been posted, recommended, liked, shared or otherwise acted upon by a user to indicate a preference, or impression of, the message. In some examples, vote icons 1188-1194 may be implemented as icons or buttons that may be selected to automatically update or increment a vote count. In other examples, vote icons 1188-1194 may be implemented as hyperlinks that may be selected to link to another page, window or website configured to provide a user interface for indicating a vote. In still other examples, a vote icon may be implemented differently and is not limited to those shown and described.

In other examples, tiles 1124-1138 may include other features and display other information associated with a message. For example, other information may be shown or displayed in each tile (e.g., a sender, a link to a related message, or the like) (not shown). In another example, graphics, buttons or icons (not shown) may be included in tiles 1124-1138 (e.g., to delete a message, to indicate a user of a social network (e.g., Facebook, Google+, Twitter, or the like) that has recommended, commented, or otherwise provided feedback regarding a message, to prioritize or re-arrange (i.e., change the order of) the message or similar messages, or the like). In still another example, graphics, buttons or icons (not shown) may be included in tiles 1124-1138, for example, to link to a website or page associated with a social network account (e.g., for a user, a user's friend, a celebrity that a user is following, or the like).

In some examples, shared environment 1102 may include share button 1106, which may be invoked (e.g., by clicking, placing a cursor over, or otherwise selected) to render and present a page configured for sharing one or more messages presented in tiles 1124-1136, or in other tiles published above or below tiles 1124-1136 (not shown). In some examples, sharing may include forwarding to another user, another email address, publishing (e.g., recommending, liking, posting, linking, or otherwise publishing) on a social network (e.g., Facebook, Twitter, Google+, or the like), for example, using access information associated with both an email account (i.e., provided by a system for electronic mail processing and publication) and a social network account. In other examples, a message published on shared environment 1102 may be shared using another hyperlink, icon or button (e.g., comment icons 1180-1186, vote icons 1188-1194, or the like) provided on the website, for example, on a tile posting a message. In still other examples, messages may be shared differently than described and shown herein.

In some examples, shared environment 1102 may display, or otherwise provide, other links, icons, and/or buttons associated with various functions, for example, linking to other pages associated with shared environment 1102. For example, shared environment may include filters 1108-1120 for filtering email messages published on shared environment 1102, for example, by subject matter. In some examples, each of filters 1108-1120 may be implemented as an icon, button, or other hyperlink, which may be invoked (e.g., by clicking, placing a cursor over, or otherwise selected) to show a subset of the messages published on shared environment 1102. For example, filter 1108 may be invoked to show only a subset of messages being associated with (e.g., categorized under, tagged as having subject matter regarding, or otherwise associated with) lifestyle in shared environment 1102. Similarly, filter 1110 may be invoked to show only a subset of messages being associated with humor in shared environment 1102. Also similarly, filters 1112-1120 may be invoked to show only a subset of messages being associated, respectively, with sports, technology, science, miscellaneous and favorites. In some examples, shared environment 1102 also may include search field 1122, which may provide a field for entering a query or term for searching, for example, data associated with messages being published on shared environment 1102. In some examples, search field 1122 may enable searching of other data associated with other messages. In still other examples, search field 1122 may be implemented differently (e.g., enable searching of a different data set, be a widget provided by a third party, or the like), and is not limited to those shown and described.

In some examples, tiles 1124-1138 may be sorted or prioritized according to various criteria. In some examples, a default criterion for prioritizing tiles 1124-1138 may be the ages of their respective messages. For example, tiles 1124-1138 may be prioritized from newest message to oldest message (i.e., timestamp 1140 indicates a more recent date and time, or a younger or lesser age (i.e., less time has passed since the message having subject 1152 and body 1164 was sent), than timestamp 1142, and so on). In other examples, tiles 1124-1138 may be prioritized according to recommendations from other users (e.g., the number of times a message is recommended or “liked” by a Facebook friend, the number of times a message has been posted or re-posted on Twitter, the number of times a message has been shared on Google+, or the like). In still other examples, tiles 1124-1138 may be prioritized according to other criteria specified by a user having access to shared environment 1102 (i.e., a user may customize the presentation or view of messages on their shared environment according to his or her preferences). For example, a page, widget or other user interface (i.e., as part of website 118) may be provided for a user to input or select preferences, including identifying or selecting one or more criteria for prioritizing email messages on their shared environment (e.g., shared environment 1102) or identifying interests (i.e., topics, subjects, hobbies, or the like) in order to receive targeted advertising or recommendations on content providers to which the user may want to subscribe. In some examples, a button or feature (not shown) may be provided on each tile for prioritizing an email or a group of emails (e.g., from a favored content provider, a school newsletter, or the like), for example to cause presentation of the email or group of emails in a high priority position (e.g., at the top of the page, in a designated or set-off section of the page, or the like) in the shared environment. In other examples, an email or message may be demoted, or otherwise designated as having lower priority, using the techniques described herein (e.g., a button, link, feature, preferences selection, or the like), for example to cause presentation of the email or message in a low priority position (e.g., lower in, or at the bottom of, the page, or the like). In still other examples, window 1100 and the above-described elements may be implemented differently in layout, design, function, structure, features, or other aspects and are not limited to the examples shown and described.

As described herein, shared environment 1102 may be configured to present information from marketing or other opt-in emails in an open format (i.e., without a need for clicking on an item or link from an email list to open a message), including graphics, images, videos, audio content, other dynamic content, or the like. As described herein, shared environment 1102 may be configured with buttons, links and other features for ease of managing email content, including a prominent unsubscribe button (e.g., unsubscribe buttons 1196-1202) and prioritization and demotion of messages for customizing presentation of message in shared environment 1102. In other examples, shared environment 1102 may include other features for managing email content. For example, shared environment 1102 may include a related content or “show me more” button (not shown) on each tile configured to provide (i.e., present) a user with similar content (e.g., advertisements, newsletters, or other content, associated with a brand, a product, a collection, a subject matter, or other category of items associated with a message presented in the tile). In another example, shared environment 1102 may include a link on a tile for purchasing an item offered by, or related to, an email message. In still other examples, the above-described elements may be implemented differently in layout, design, function, structure, features, or other aspects and are not limited to the examples shown and described.

In some examples, an application for email processing and publication on shared environment 1102 (e.g., application 200 in FIG. 2) may be configured to gather, organize, process and/or store data (i.e., “track” data) associated with user preferences and activity (i.e., actions on, or interactions with, shared environment 1102), as described above. For example, a variety of types of data associated with messages displayed on shared environment 1102, including a user's activity, may be tracked for use in targeting advertisements and other subscription emails that may be of interest to a user. Activity data may include types of (i.e., subjects, products, brands, interests, or other aspects of content in) emails subscribed to, unsubscribed from, prioritized, demoted, liked by friends, linked to, viewed many times, viewed for long periods of time, trends indicated by such activity, or other metrics. Such activity data may be processed to determine trends, patterns, or other useful information about a user (e.g., buying patterns, media (e.g., books, video, music, and the like) preferences, interests, hobbies, and the like). In some examples, targeted advertisements or subscription email suggestions (e.g., newsletters, marketing emails, or other opt-in emails that may be of interest to a user) may be determined and provided to a user based upon activity data associated with the user's account. In other examples, targeted advertisements or subscription email suggestions may be determined and provided to a user based upon activity data associated with one or more groups or a plurality of users. In some examples, activity data may be used by an application for email processing and publication on shared environment 1102 (e.g., application 200 in FIG. 2) to provide targeted advertisements or subscription email suggestions to a user. In other examples, such activity data may be shared with, or provided to, content providers for their use in targeting advertisements, marketing emails, newsletters and the like. For example, activity data indicating a user subscribes to, prioritizes, and/or has friends that like, a string instrument newsletter may cause an application for email processing and publication on shared environment 1102 (e.g., application 200 in FIG. 2) or a content provider to target an advertisement for a hand cream to the user. In still other examples, data associated with an application for email processing and publication on shared environment 1102 may be used differently and are not limited to the examples shown and described.

In some examples, shared environment 1102 may be configured for display or presentation on a mobile client or device. For example, shared environment 1102 may be displayed using a mobile application or mobile web browser installed on a mobile computing or communications device. In some examples, an application for email processing and publication on shared environments (e.g., application 200 in FIG. 2) may be configured to process content (e.g., video, audio, text, image, or other data) in a subscription email from a content provider for presentation in a shared environment on a mobile application or mobile web browser. In some examples, an application for email processing and publication on shared environments (e.g., application 200 in FIG. 2) may be configured (i.e., using HTML5 or other language or program for structuring and presenting content on a web application or browser) to detect a type of mobile computing or communications device, and to render content based on the type of mobile computing or communications device. In other examples, the above-described elements may be implemented differently in layout, design, function, structure, features, or other aspects and are not limited to the examples shown and described.

Grid View of Tiles and Content Rotation

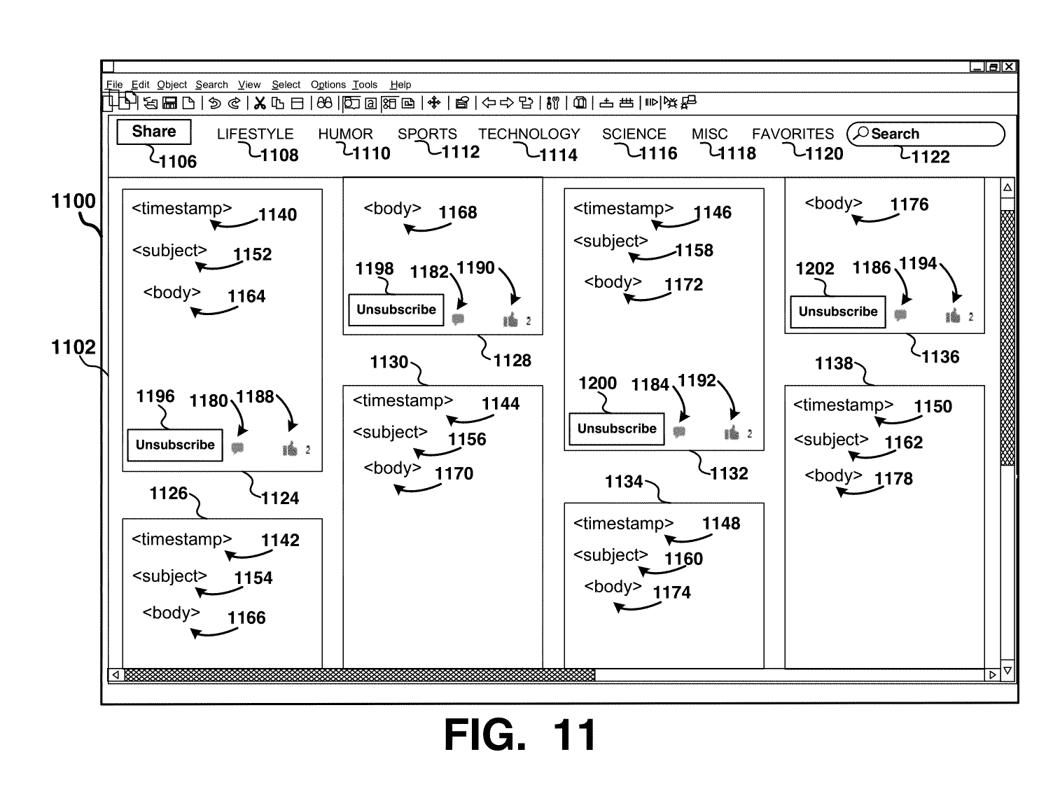

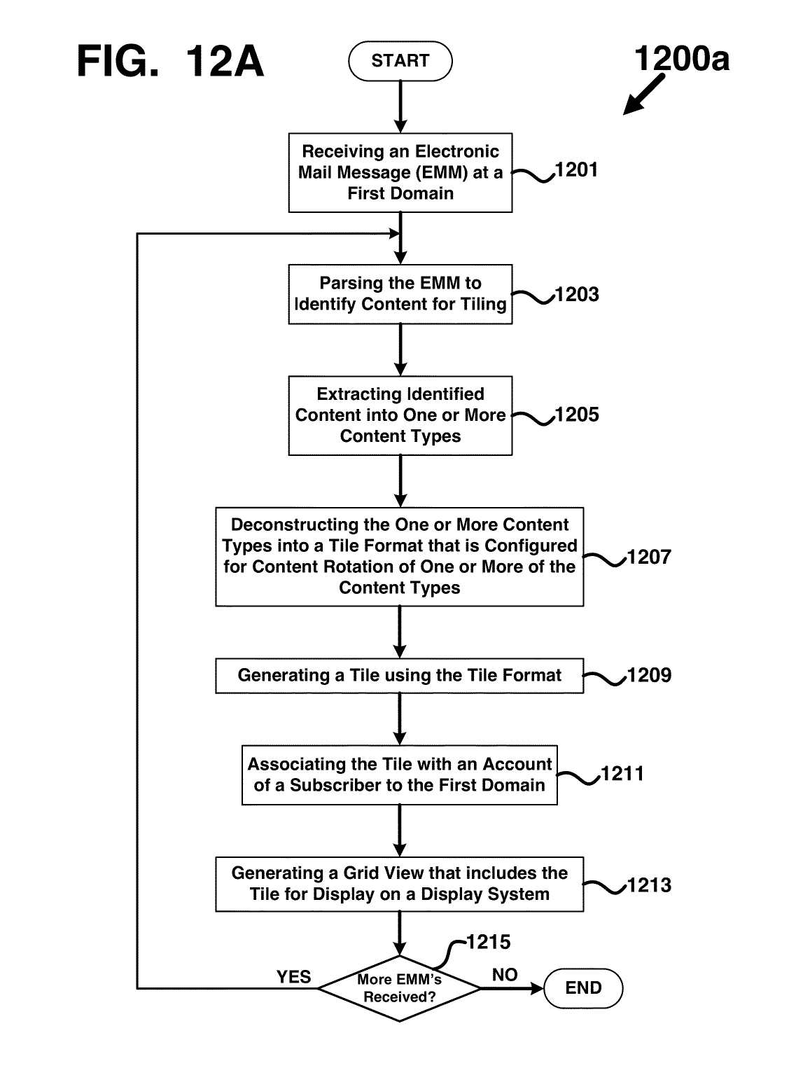

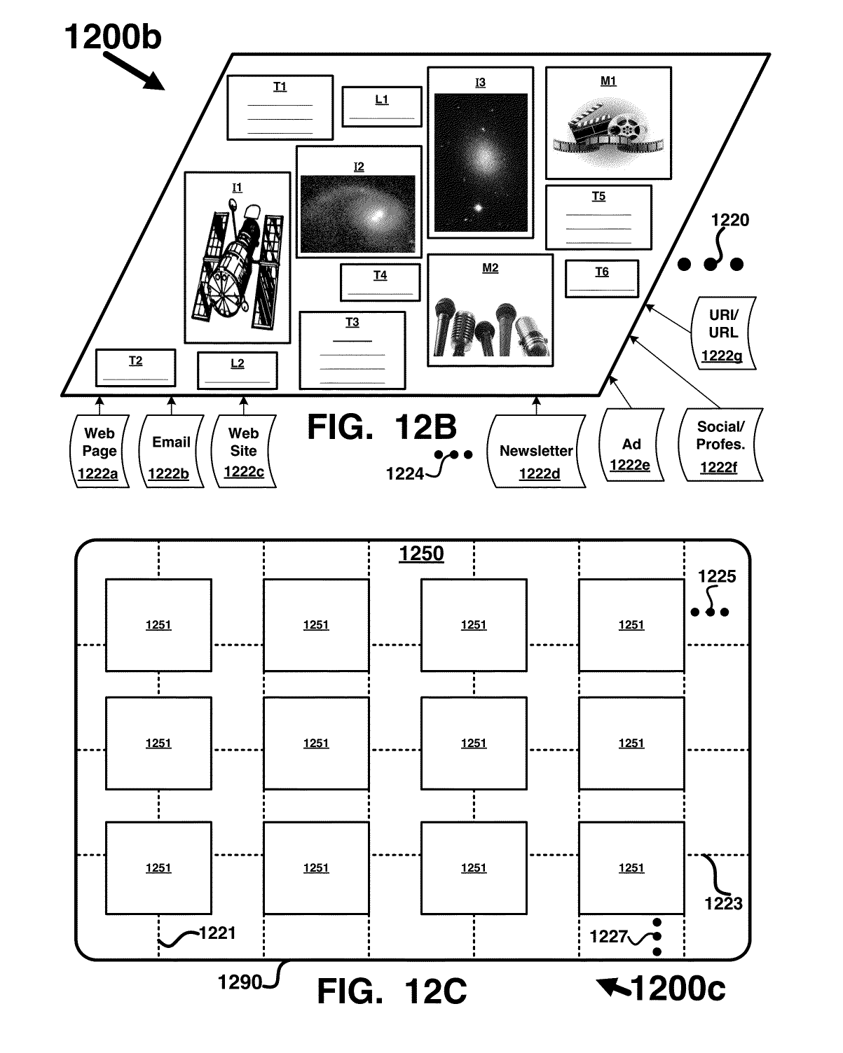

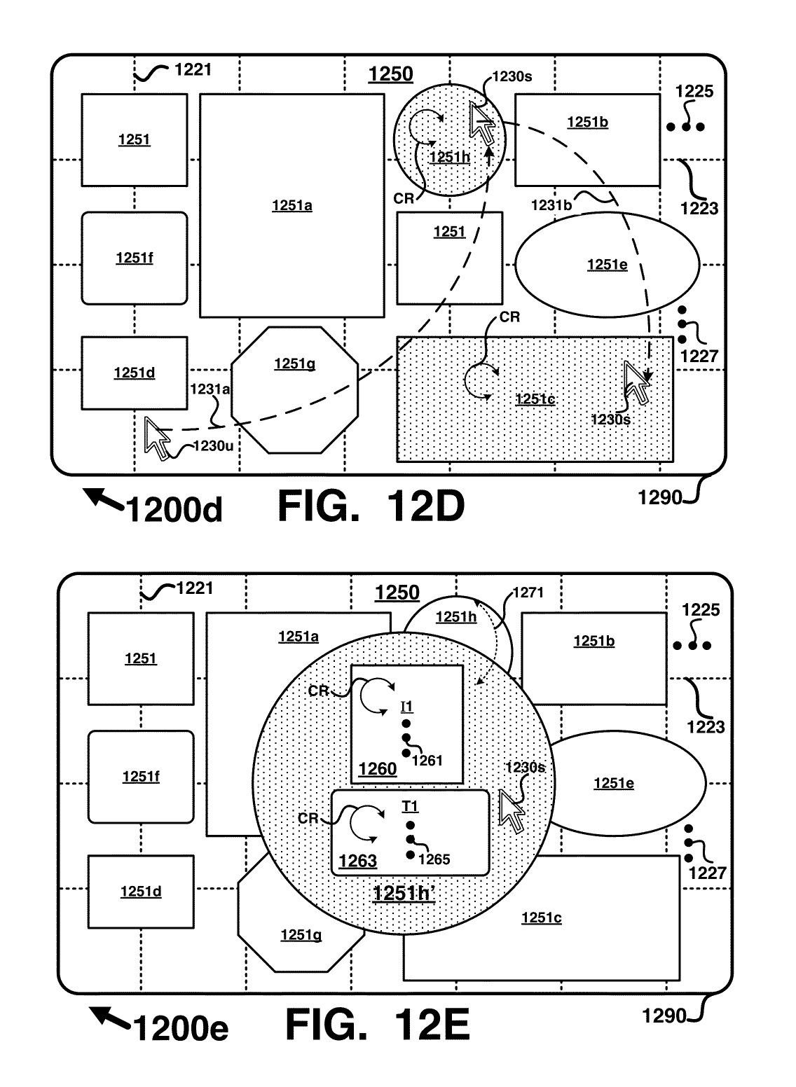

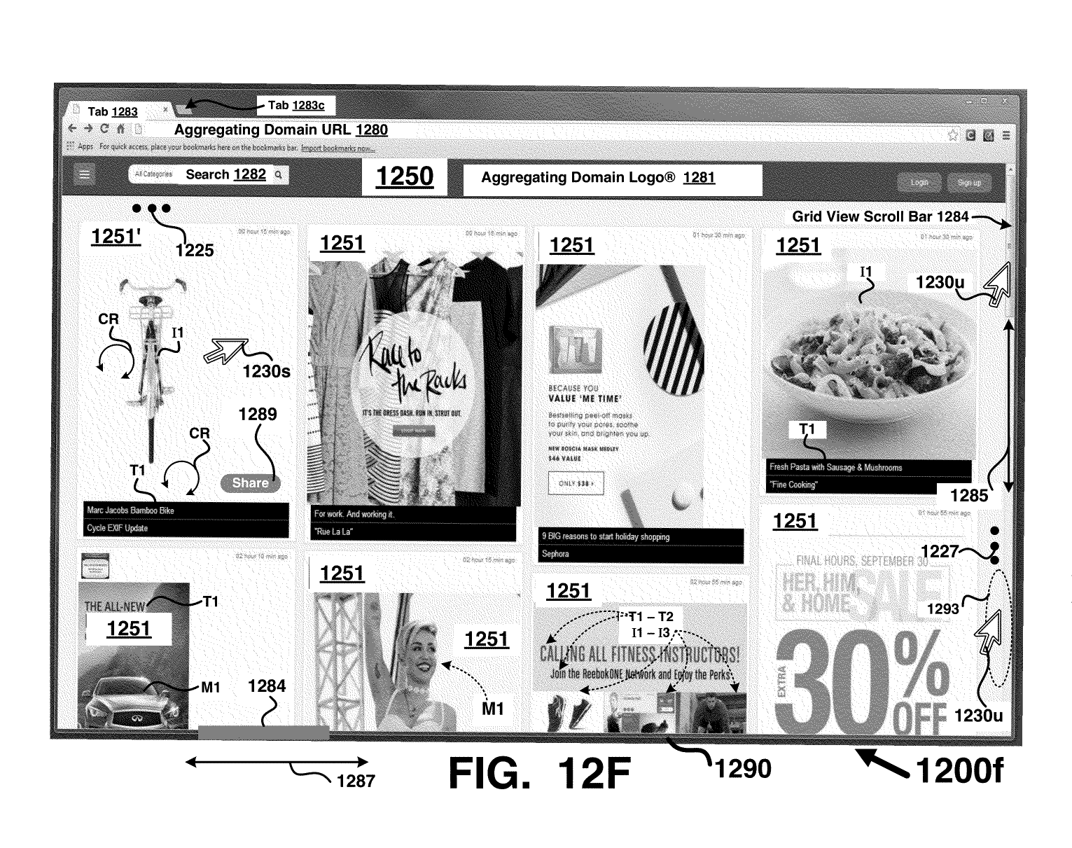

Attention is now directed to FIG. 12A where one example of a flow diagram 1200a for generating a grid view including one or more tiles is depicted. At a stage 1201, an electronic email message (EMM) (e.g., an email, a message, a newsletter, an advertisement, an invoice, etc.) is received at a first domain. The first domain may be any unique address that may be electronically accessed, such as by way of an email address, a uniform resource identifier (URI), a uniform resource locator (URL), a uniform resource name (URN), or the like that defines an entity and/or resource by name, for example. A syntax, character string or other used for accessing the first domain may include but is not limited to HyperText Transfer Protocol (e.g., http://), HyperText Markup Language (HTML), or other formats. The EMM may itself be in a format such as HTML for example, and may include tags or other identifiers that may be used to divine the content of the EMM.

At a stage 1203 the EMM is parsed to identify content in the EMM for subsequent tiling as will be described below. Content in the EMM may include but is not limited to text, images, media, metadata, objects, links, lists, and hyperlinks to other content, for example. Media may include but is not limited to audio, video, audio/video, animation, and other media formats. The EMM may include tags that are associated with and may define or describe the content the tag is associated with. The tags may be associated with and/or recognized those typically used by browsers (e.g., Firefox™, Chrome™, IE™, Bing™ or others) that operate on HTML data. Parsing at the stage 1203 may be accomplished using a variety of software, algorithms, program code, and the like, including but not limited to Java™, parsers that are Java™ based, a custom parser, or others.

At a stage 1205 content identified by the parsing at the stage 1203 is extracted into one or more content types. The one or more content types may be those described above, but are not limited to content types described herein. For purposes of explanation, the following may be some of the content types that are extracted: text (T), image (I), media (M), and link (L). In that an image or text may also be a moving image or text, as in a movie or video, moving images and text may fall with the media content designation. Text T and image I, unless otherwise stated, may refer to still images and still text. Media M may comprise all other types of content that may be extracted, regardless of the actual type of media. For example, media M may include audio, video, animation, etc. Link L content may refer to any type of link (e.g., a hypertext link or other) regardless of form or syntax that may be recognized, acted upon, and used to designate a location or address of some item or object, such as link to a web page, web site, ftp site, etc.

At a stage 1207, some or all of the content types extracted at the stage 1205 are deconstructed into a tile format that is configured for content rotation of the one or more content types. Therefore, text T content types may be broken down into a tile format that allows for content rotation of the text (e.g., ASCII character strings from the ASCII character set or equivalents) contained in the T content type. Similarly, image I content may be broken down into a tile format that allows for content rotation of the image or images contained in the I content type. In some applications, some content types such as media M or link L may not be configured for content rotation. Furthermore, in some applications, text T and/or image I content may not be configured for content rotation. Whether or not content may be configured for content rotation may be determined, at least in part, by a tag or tags associated with the content, for example.

At a stage 1209 a tile is generated using the file format generated by the deconstructing as the stage 1203. As will be described below, a tile may be a discrete entity such as a file or other object that may be operated on and manipulated by a browser or other software program or algorithm. For example, the tile format may include syntax for HTML and the tile may be generated from the HTML in the tile format. Moreover, the tile that is generated may include HTML in its syntax and/or use HTML to describe at least some of its data. Generating the tile using the tile format may further include formatting the data in the tile for display system the tile may be viewed on (e.g., a display of a smartphone, tablet, pad, laptop/notebook computer, computer monitor, HDTV, etc).

At a stage 1211, the tile is associated with an account of a subscriber to the first domain. As one example, of the EMM was communicated (e.g., sent via email) to “Jane_Doe@first.domain.com”, then the generated tile would be associated with the account of “Jane Doe” in a manner similar to that of an email account being associated with an account name and a domain the account is registered to, such as jane.doe@yahoo.com or jane_doe@gmail.com.

At a stage 1213, a grid view is generated and the tile, and optionally any other tiles that are associated with the account at the stage 1211 may be included in the grid view. As will be described below, the grid view may include a single tile or a plurality of tiles; however, the grid view may display only a portion of the plurality of tiles. For example, if there are 57 tiles in the grid view and a display system the grid view is displayed on may only display no more than 20 tiles at a time, then other tiles in the grid view may not be displayed until some action such as scrolling the display is taken to bring the unseen tiles into view.

At a stage 1215, if additional EMM's are received at the first domain, then the flow 1200a may resume at some prior stage, such as the stage 1203, for example. A plurality of other domains may be transmitting a plurality of EMM's addressed to the first domain. To that end, flow 1200a may execute as needed to process each EMM to generate tiles for grid views and content rotation for each subscriber registered or otherwise associated with the first domain. In some applications, the first domain may be regarded as an aggregating domain where EMM's from a plurality of different domains are aggregated and processed into tiles for grid viewing and content rotation for a plurality of subscriber to the aggregating domain.

Moving on to FIG. 12B, one example of an electronic email message 1200b having different content types is depicted. Here, electronic email message 1200b may be in a variety of forms and/or file formats, such as a page or the like, for example. In the example depicted, EMM 1200b includes a plurality of different content types which are presented for the purposes of explanation only are not to be construed as limiting examples. Other content types not depicted in FIG. 12B may be included, without limitation, into EMM 1200b. Moreover, EMM 1200b may include more or fewer content and/or content types than depicted in FIG. 12B. Content types in EMM 1200b may include but is not limited to: one or more text types denoted as T1-T6; one or more image types denoted as I1-I3; one or more media types denoted as M1-M2; and one or more link types denoted as L1-L2. EMM 1200b may derive from a variety of sources and/or domains including but not limited to those denoted as 1222a-1222g. There may be more or few sources for EMM 1200b as denoted by 1224.

As one example, a subscriber may subscribe to an email newsletter about the Hubble Space Telescope and denoted as newsletter 1222d. Each issue of the newsletter is emailed as EMM 1200b to the address of the subscriber at the first domain (e.g., the aggregating domain). The flow 1200a may be applied to the EMM 1220b to generate at least one tile. As one example, tags in EMM 1220b may identify the various content types as described above and may also be used to define associations or linkages between the same or different content types within EMM 1200b. Therefore, image I1 may be associated with text T1 and T2 and with link L2. T1 may be one or more paragraphs, sentences, or the like that are germane to the image I1 of the Hubble Space Telescope (e.g., describing the capabilities of the telescope), and T2 may be one or more paragraphs, sentences, or the like that describe where more information may be found by clicking or otherwise activating link L1 (e.g., a one or more hypertext links). Image I1 may be a single image that may be static, or I1 may be a series of images (e.g., as in an image gallery). The one or more paragraphs, sentences, or the like for T1 and T2 may be too long to view in the space allocated to them during the tiling process or to fit on the screen allocated in the grid view as will be described above. To that end, the tiling process at the stages 1207 and/or 1209 may configure T1, T2, and I1 for content rotation such that positioning a cursor (e.g., hovering or flying over) or other user interface (UI) construct over a selected tile and/or over text or image in the selected tile cause the content comprising the text or image to rotate. Content rotation may comprise scrolling or rolling the text of T1 and/or T2 (e.g., as is done with movie credits) or stepping through, playing back, or cycling through the images in I1 in some order or sequence, for example. Image I1 may include ten images of the telescope and content rotation may comprise displaying each of the ten images in a sequence that is timed (e.g., 2 seconds per image) or stepping through each of the ten images by some action of the UI (e.g., moving a cursor up or down while it is positioned over the image). Similarly, the text in T1 may be ten paragraphs long and content rotation may comprise displaying at least a portion of each paragraph in some sequence, timed or otherwise. If text T1 and image I1 are linked, that is they are somehow related by content, editorial, etc., then during content rotation, then paragraph 1-of-10 of I1 that is associated with image 1-of-10 of T1 will rotate whilst that image is being displayed in the selected tile, followed by subsequent paragraphs undergoing content rotation when their associated image is rotated into view within the selected tile.

Content types, without limitation, may be associated with one or more other content types and content rotation among associated content types may be application specific and/or determined by tags or other data included in the EMM from which they were derived. Media content types may vary as widely as numerous varieties of media that may be included in an EMM. Media M1 may be a movie that when activated (e.g., by hovering) may intimate content rotation and/or some other action. Content rotation of M1 may merely comprise commencing playback of the underlying movie content within the selected tile. text T5 may be subtitles that are associated with M1 and content rotation may comprise a synchronized scrolling of text T5 as M1 is played back. In that M1 may comprise a movie, TV show, video, or the like, during content rotation any sound, audio, or sound track for M1 may also be played back (e.g., over a speaker system or headphones, etc.). Media M2 may comprise music and T6 may comprise lyrics or a score of the music and may content rotate in association with content rotation of M2. Link L2 may comprise one or more links (e.g., hyperlinks) associated with image I2 and may content rotate through the one or more links while is I2 active. The foregoing are non-limiting examples of what may be done with content types in a tile and actual implementations will be application specific and may be programmed or otherwise coded to control behavior of content types in a tile.

Referring now to FIG. 12C where one example 1200c of a grid view 1250 including a plurality of tiles 1251 displayed on a display system 1290 are depicted. Here, dashed horizontal 1223 and vertical 1221 grid lines are depicted to illustrate that the grid view 1250 may include an orderly arrangement of tiles 1251 that may have the same size; however, the grid view 1250 may include an arrangement of tiles 1251 that is not orderly and the tiles 1251 need not be the same size or shape and may have other than rectangular or square shapes. Grid view 1250 may include more or fewer tiles as denoted by 1223 and 1225. If the grid view contains more tiles 1251 than may be displayed by display system 1290, then horizontal and/or vertical scroll bars or the like may be used to bring other tiles into view on the display system 1290 as will be described below. Typically, each tile 1251 may comprise content from different EMM's that have been processed, such as by flow 1200a of FIG. 12A.

Turning now to FIG. 12D where one example of different configurations for tiles 1251 in the grid view 1250 and flying or hovering over a tile 1251 to initiate content rotation CR of content in the tile 1251 are depicted. In FIG. 12D, tiles 1251-1251h in grid view 1250 may have different shapes and sizes and need not be arranged in an orderly manner as compared to the tiles 1251 depicted in FIG. 12C. A cursor 1230 is depicted as being a non-limiting example of a user interface (UI) that may be used to select or activate a tile 1251 in the grid view 1250. When cursor 1230 is not touching and/or positioned over a tile 1251 the cursor is denoted as 1230u; conversely, when the cursor 1230 is and/or positioned over a tile 1251 the cursor is denoted as 1230s. A device such a mouse, track pad, or other at behest of a user may cause cursor 1230u to move 1231a from its present location and fly or hover over circular tile 1251h thereby causing that tile to be selected or activated for content rotation CR where the cursor activating a tile is denoted as 1230s because it is present selecting tile 1251h. Content rotation CR or one or more content types displayed within tile 1251h is now enabled and may continue so long as cursor 1230s remains in a position to select that tile (e.g., continues to hover over tile 1251h). Subsequently, the cursor 1230s moves 1231b from circular tile 1251h to rectangular tile 1251c. Content rotation CR is halted in circular tile 1251h because that tile is no longer selected or activated, and content rotation CR is initiated in rectangular tile 1251c because that tile is currently selected by cursor 1230s. Moving the cursor 1230 away from any selected tile may cause content rotation CR to terminate in that tile. When the cursor 1230 is not positioned and/or touching any of the tiles in grid view 1250 (e.g., as in cursor 1230u) then all tiles in the grid view 1250 may be disabled for content rotation CR.

Description now turns to FIG. 12E where one example of a selected tile 1251h′ is made visually more prominent than un-selected tiles in grid view 1250. Here, selected tile 1251h transitions 1271 (e.g., zooms) from its initial size to a larger size denoted as tile 1251′ in the grid view 1250 and remains at the larger size so long as it is selected by cursor 1230s. Relative to the other un-selected tiles in grid view 1250, selected tile 1251′ is more visually prominent in the grid view and dominates a larger portion of the viewing area of display system 1290 than the un-selected tiles.

While the cursor 1230s continues to hover or otherwise select tile 1251′, content such as image I1, text T1 or both may have content rotation CR initiated in any temporal sequence, such as at the same time or a different times, for example. A rate at which content is rotated may be the same or deferment for content types in a selected tile. Tile 1251h′ may transition 1271 back to its un-selected size in the grid view 1250 when the cursor 1230s is removed and/or ceases to hover over the tile such that tile 1251h′ morphs from its selected an prominent display in the grid 1250 back to its un-selected view in the grid as tile 1251h. A similar to-from transition may occur for the other tiles in grid view 1250, with each tile transitioning to a prominent view when selected and morphing back to its normal non-prominent view upon becoming un-selected. Un-selected tiles may be configured to have a muted or visually diminished appearance relative to a selected tile or selected tiles in the same grid view 1250 which may be configured to have a more striking or visually dominant appearance. Although a single selected tile has been descried with regard to the grid view 1250, the present application is not limited to only one tile being active at the same time, and in some applications, actions by the UI (e.g., a CTRL sequence on a keyboard or the like) may cause a plurality of tiles 1251 to be selected or otherwise activated at the same time in the same grid view 1250 and content type in each of the plurality of selected tiles 1251 may have content rotation CR.

Turning now to FIG. 12F where a grid view 1250 of plurality of tiles 1251 and their respective content types with one of the tiles 1251′ being selected and having content rotation CR of its content. Here, grid view 1250 may appear as a tab 1283 or the like in a web browser (e.g., Chrome, Fire Fox, BING, IE, or other) presented on display system 1290 (e.g., a touch screen, laptop display, desktop PC display, smartphone display, tablet/pad display, LCD, OLED, HDTV, projection display, virtual image display, HUD, Plasma Display, 3D Display, or other). Other grid views 1250 (not shown) may be presented in other tabs such as tab 1283c, for example. In tab 1283, some of the tiles 1251 in grid view 1250 may be on screen (as shown) and other tiles in the grid view may be off screen (not shown) but may be brought into view or out of view by moving (1285, 1287) a scroll bar 1284, via cursor 1230u or other UI methods, for example. In some examples, a finger or stylus on a touch screen device may comprise the UI. In other example, a keyboard, track pad, arrow keys, mouse or similar tracking device may comprise the UI. In yet other examples, a gesture recognition system that tracks a user's body movements and/or gestures (e.g., the eyes, facial features, hands, etc.) may comprise the UI. The actual UI that interacts with the grid view 1250 and it tiles 1251 will be application dependent and is not limited by the examples described herein.

In FIG. 12F, a subscriber to the aggregating domain upon logging in (e.g., user name & password) into the domain may enter an address (e.g., URL 1280) where tiles 1251 associated with the subscribers subscribed to EMM's are populated with the various content types as described above. The processed EMM's presented in the tile 1251 format may reflect the subscribers interest in food, fashion, automobiles, bicycling, fitness, bargain hunting, and a variety of other interests. As one example, a received EMM relating to a bespoke bicycle shop in another state is subscribed to by the subscriber, is processed after being received, and generated into tile 1251, which becomes selected tile 1251 when activated by cursor 1230s. Content rotation CR of text T1 textually describes in several paragraphs, custom bicycle features being visually displayed in regard to content rotation CR of image I1 which comprises several images for each of the custom features. Paragraph one may describe features in image one, and so forth. In some examples, the subscriber may have other persons or entities that he/she may wish to share some or all of the content in a tile 1251. To that end, a tile 1251 may include an icon or other field or image that when activated (e.g., via the cursor 1230s or other) may allow the tile's content to be shared (e.g., as another EMM to another domain). For example, activating a “Share” icon 1289 in selected tile 1251′ may cause content in that tile to be emailed or otherwise transmitted to an address such as an email address, URI, URN, URL, or other. In some examples, activating the “Share” icon 1289 results in content in the selected tile 1251′ being shared only with another subscriber to the aggregating domain 1280. That is Jane_Doe@aggregating.domain.com may share tile 1251′ with one or more subscribers such as subscriber John.Doe@aggregating.domain.com, for example. Although not depicted in FIG. 12F, selected tile 1251′ or any other selected tile(s) in grid view 1250 may be displayed with prominent view as described in regards to tile 1251h′ in FIG. 12E. In grid view 1250, moving the cursor 1230u to neutral region of the display system 1290 as denoted by dashed lines 1293 may operate to deactivate (e.g., render as un-selected) all tiles 1251 and prevent content rotation CR in the un-selected tiles 1251. A logo 1281 or other identifier of the goods and/or services of the aggregating domain may be displayed in the grid view 1250. Tiles 1251 in the grid view 1250 may be searched using a search tool 1282 or the like, by entering a search string in the search tool 1282, for example.

Carousel View of Tiles and Content Rotation

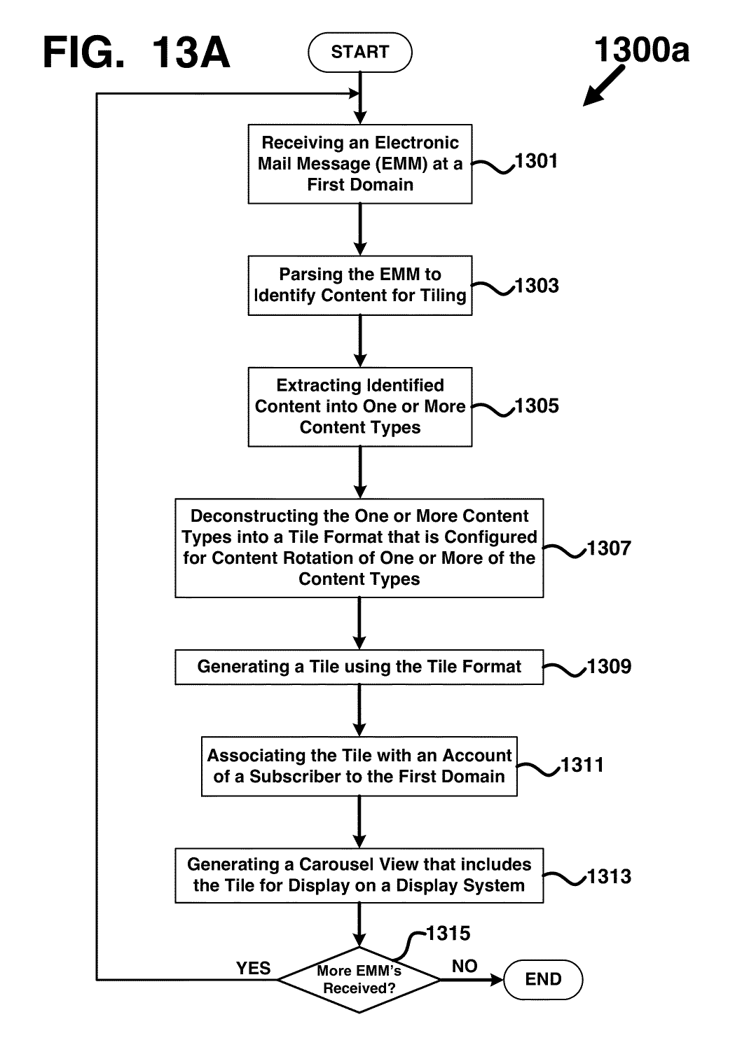

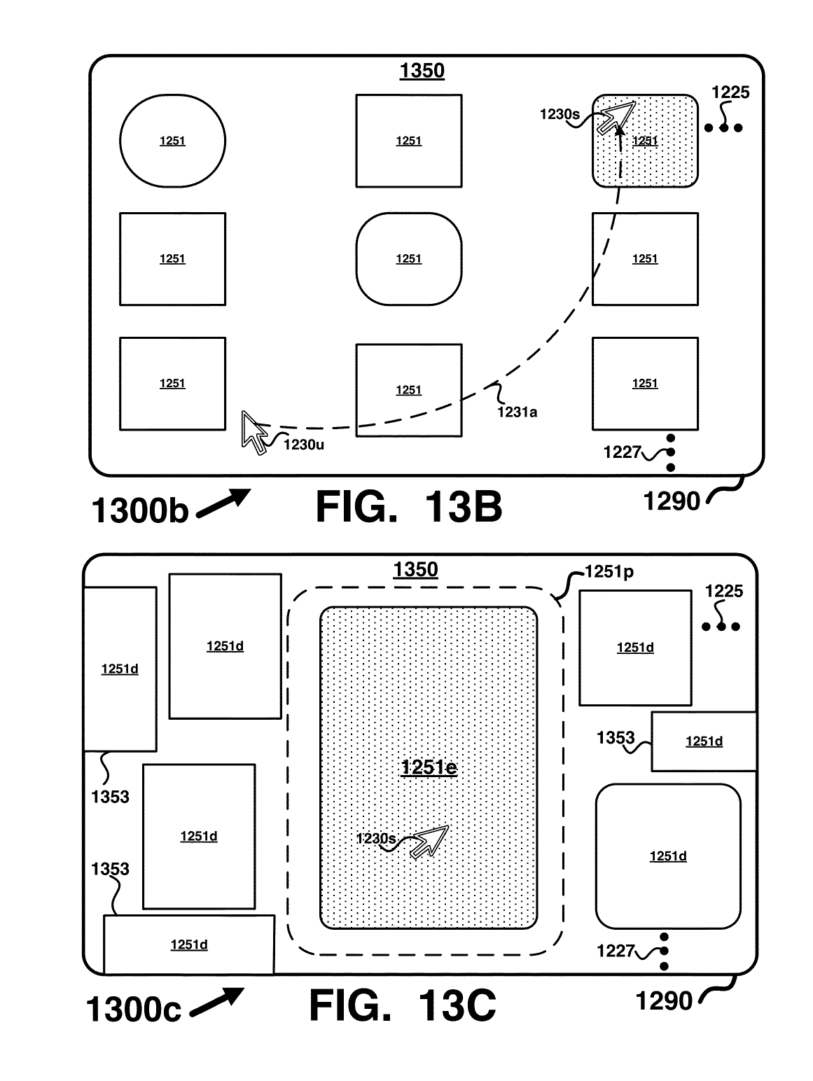

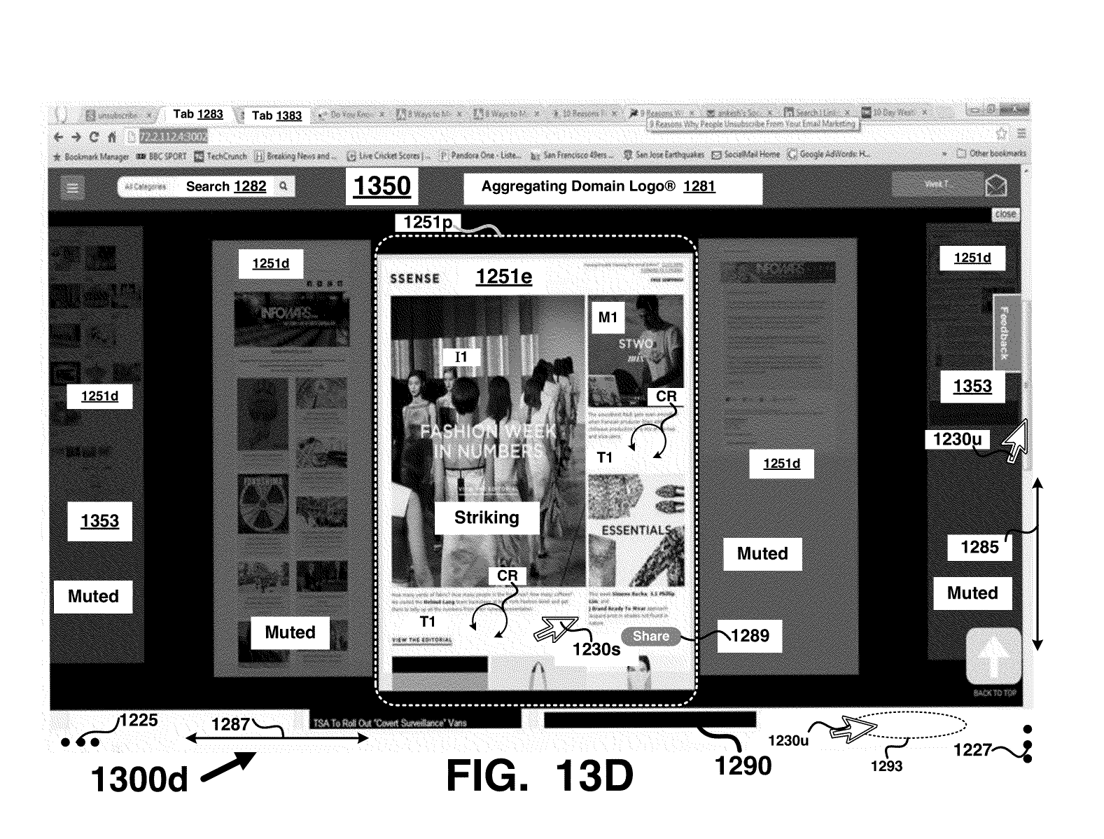

Attention is now directed to FIG. 13A where one example of a flow diagram 1300a for generating a carousel view including one or more tiles is depicted. To simplify explanation, stages 1301-1311 and 1315 may be identical or similar to the stages 1201-1211 and 1215 as described above in reference to flow 1200a in FIG. 12A; therefore, a stage 1313 where a carousel view 1350 that is different than the grid view 1250 will be discussed in conjunction with FIGS. 13B-13C. At the stage 1313 the carousel view 1350 is generated for a tile 1251 for display on the display system 1290. Here, the tiles 1251 that are generated for the carousel view 1350 may be identical to those generated for the grid view 1250; however, the manner in which the tiles 1251 are visually presented in the carousel view 1350 differs from that of the grid view 1250.

Moving now to FIGS. 13B-13C, where FIG. 13B depicts one example of a carousel view 1350 including a plurality of tiles 1251 displayed on a display system 1290. Here, moving 1231a cursor 1230u from an un-selecting position on display system 1290 to a selected position 1230s on tile 1251 is operative to activate/select tile 1251 for content rotation CR in the carousel view depicted in FIG. 13C, where one example of different configurations for tiles 1251 in the carousel view 1350 and flying or hovering over selected tile 1251e to make selected tile 1251e visually prominent and to position un-selected tiles 1251d around a perimeter 1251p of the selected tile 1251e is depicted. As selected in the carousel view 1350, tile 1251e may be moved to a centralized location on display system 1290 and may have its dimensions and/or shaped change to make it visually more dominant (e.g., takes up more of the display) than un-selected tiles 1251d which may not change in size or shape and/or may be made smaller in dimension to emphasize their diminished visual importance relative to selected tile 1251e, for example. A portion of some un-selected tiles 1251d may be partially on screen and off-screen as denoted by 1351 and as before may be moved into and out of view using scroll bars or the like. Selected tile 1251e need not be centrally positioned on display system 1290 as depicted in FIG. 13C and may be positioned anywhere on the display system 1290.

Reference is now made to FIG. 13D where carousel view 1350 of plurality of tiles (1251d and 1251e) and their respective content types and selected tile 1251e being visually prominent and having content rotation CR of its content are depicted. Here, un-selected tiles 1251d may be visually less distinct in size, color, brightness, clarity of text and/or imagery, which for purposes of description will be generally denoted as “Muted” in appearance relative to visually more striking and prominent selected tile 1251e. Un-selected tiles 1251d positioned about perimeter 1251p are “Muted” and the selected tile 1251e is visually “Striking” and its content may undergo content rotation CR. A logo 1281 or other identifier of the goods and/or services of the aggregating domain may be displayed in the carousel view 1350. Tiles 1251 in the grid view 1350 may be searched using a search tool 1282 or the like, by entering a search string in the search tool 1282, for example.

Reducing Unsubscribed Requests at Subscribed to Domains

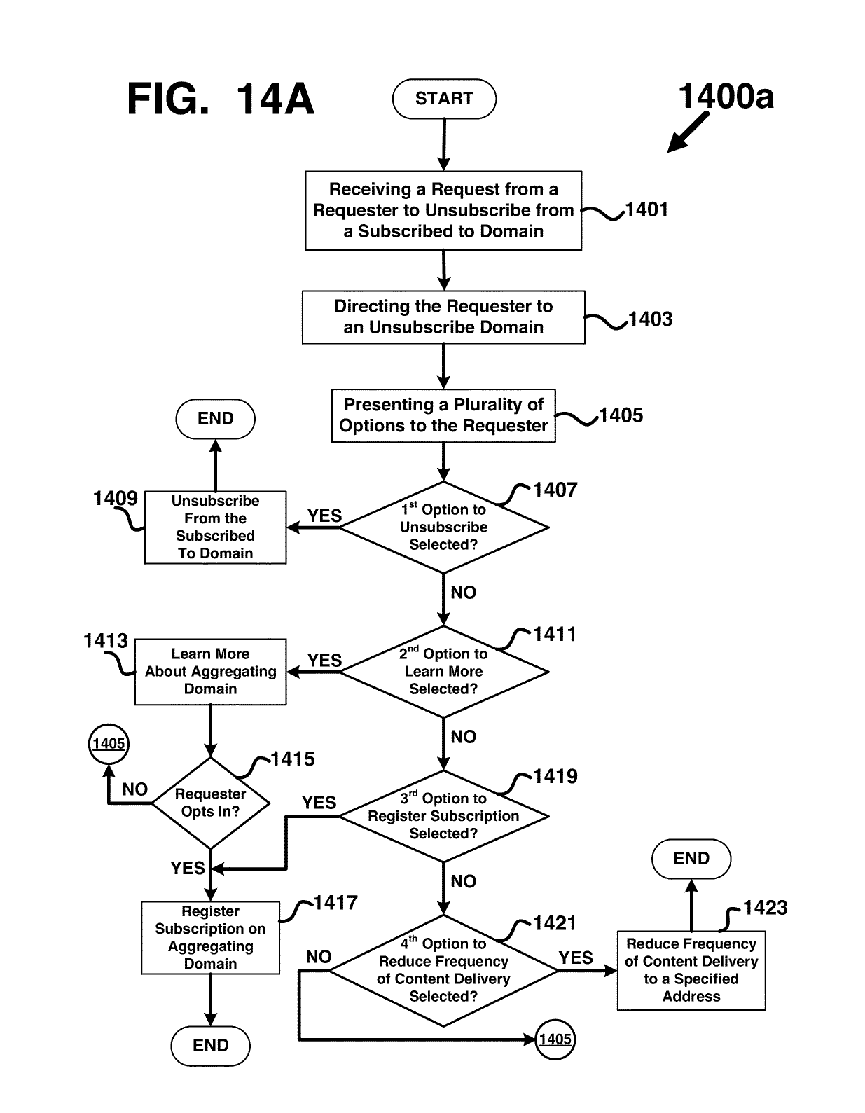

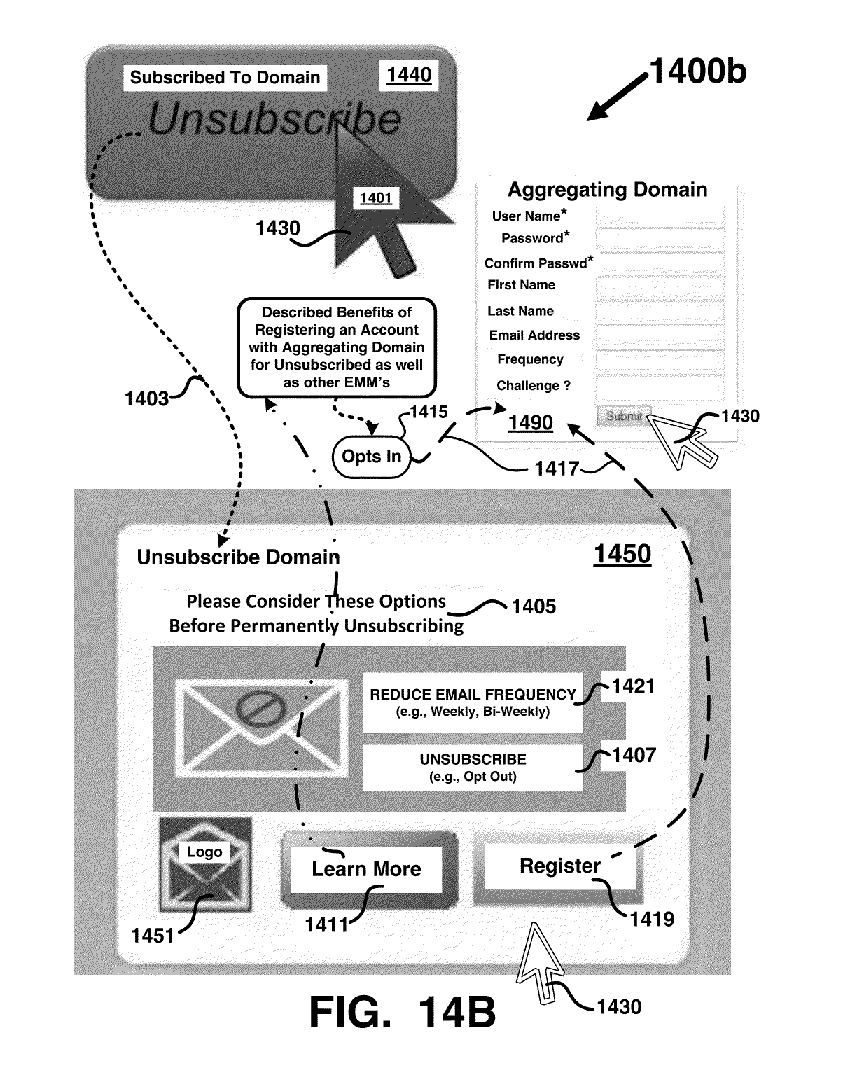

Attention is now directed to FIG. 14A where one example of a flow diagram 1400a for reducing unsubscribe requests includes at a stage 1401, receiving a request from a requester (e.g., a user and/or subscriber) to “Unsubscribe” from a subscribed to domain. An example of a subscribed to domain may include but is not limited to an email subscription to a newsletter, an email relationship with online retailer, an email relationship with a business, an email relationship with a social network, an email relationship with a professional network, just to name a few. In many instances, a subscriber may have at some point solicited the emails by agreeing to receive them at a domain provided by the subscriber, such as Jane.Doe@mymail.com or some other email address, for example. As one example, emails from the subscribed to domain may include a statement such as: “You are receiving this e-mail because our records indicate you requested that we send information Jane.Doe@mymail.com regarding special offers, newsletters, product information and updates from Socks&Shoes.com.” However, due to receiving too many emails in general from a variety of sources and/or too many emails from the subscribed to domain, the subscriber makes a decision to unsubscribe and requests to unsubscribed by taking an action such as clicking on: “This e-mail is a Socks&Shoes.com advertisement. If you no longer wish to receive our marketing e-mails, unsubscribe here. If you have difficulty with the unsubscribe link, you may also send an e-mail to PrivacyManager@socks&shoes.com. For more information, read our Privacy Policy or call 1-888-777-7777.” At the stage 1401 the requester (e.g., the subscriber) may have clicked on the “unsubscribe here” hyperlink to effectuate the unsubscribe request. At a stage 1403, the requester may be redirected to an unsubscribe domain that may not necessarily be associated with the subscribed to domain. In some applications, the unsubscribe domain may be a third party domain acting as an agent for the subscribed to domain and operative to carry out the unsubscribe request, or offer additional options to the requester. At a stage 1405 a plurality of options (e.g., in addition to an unsubscribe option) are presented to the requester.

At a stage 1407 a first option to unsubscribe may be presented for selection by the requester. If a YES branch is taken, then the requester has made the decision to unsubscribe from the subscribed to domain and flow 1400a transitions to a stage 1409 where the requesters desire to unsubscribe from the subscribed to domain is executed, thereby removing the requesters email address or the like from future emails or EMM's from the subscribed to domain. Flow 1400a may terminate after execution of the stage 1409.

If a NO branch is taken from the stage 1407, then a second option to learn more may be presented for selection by the requester at a stage 1411. If a YES branch is taken from the stage 1411, then the requester has selected to learn more about an aggregating domain and flow 1400a transitions to a stage 1413. At the stage 1413 the requester is presented with information regarding an aggregating domain where instead of terminating the receiving emails from the subscribed to domain, those emails, and optionally other EMM's from other domains that are received by the requester, may be sent to an address (e.g., a unique address such as Jane.Doe@agreegating.domain.com) for the requester at the aggregating domain. At a stage 1415 the requester may decide whether or not to “Opt In” to the aggregating domain. If a YES branch is taken at the stage 1415, then the flow 1400a continues to a stage 1417 where a subscription to the aggregating domain is registered for the requester. The flow 1400a may terminate after execution of the stage 1417. If the NO branch is taken from the stage 1411, then the flow 1400a may return to a prior stage in the flow, such as the stage 1405, for example.

Returning to the stage 1411, if the NO branch is taken from the stage 1411, the flow 1400a may transition to a stage 1419 where a third option to register a subscription with the aggregating domain may be presented for selection by the requester. If the YES branch is taken from the stage 1419, then the flow 1400a may transition to the stage 1417 as described above. If the NO branch is taken from the stage 1419, then the flow 1400a may transition to a stage 1421. At the stage 1421 a fourth option to reduce a frequency at which content (e.g., EMM's) is delivered from the subscribed to domain may be presented to the requester. If a YES branch is selected at the stage 1421, then flow 1400a may transition to a stage 1423 where frequency of content delivery to a specified address (e.g., an address on the aggregating domain) is reduced. If a NO branch is take from stage 1421, then flow 1400a may return to a prior stage in the flow, such as the stage 1405, for example.

Turning now to FIG. 14B where one example of a scenario for handling an unsubscribe request that may result in registration with an aggregating domain is depicted. Here, a requester may request (e.g., at the stage 1401) to unsubscribe from a subscribed to domain 1440 by using a cursor 1430 or other UI to click on or otherwise activate an unsubscribe request contained in an EMM (e.g., an email from the subscribed to domain) or on a web site/page for the subscribed to domain. The request 1401 triggers a redirection (e.g., at the stage 1403) to an unsubscribe domain 1450 which may be a domain including but not limited to the same domain as the subscribed to domain, a third-party domain, or the aggregating domain, for example. The unsubscribe domain 1450 offers the requester a plurality of options as described above in regard to flow 1400a, including but not limited to unsubscribing from any future EMM's from the subscribed to domain 1440 by selecting 1421 using cursor 1430, learning more about the aggregating domain 1490 by selecting 1411 using cursor 1430, registering with the aggregating domain 1490 by selecting 1419 using cursor 1430, and reducing email frequency by selecting 1421 using cursor 1430.

The learning more at the stage 1411 and/or the registering at the stage 1419 may result in an actual registration 1417 of the requester with the aggregating domain 1490. Registration 1417 may include but is not limited to information such as the requester filling out information necessary to establish an account with the aggregating domain 1490, such as first name, last name, user name, password, an email address at the aggregating domain 1490, a frequency of email delivery if the option 1421 was also selected, and a security question such as a challenge question (e.g., What city were you born in?), for example. For example, Jan Doe may select jane_doe@aggregating.domain.com as her email address for future emails from the subscribed to domain 1440 to be sent to, and if option 1421 was selected, then the subscribed to domain 1440 would send emails to the aggregating domain 1490 address jane_doe@aggregating.domain.com at a frequency of once a week, for example.

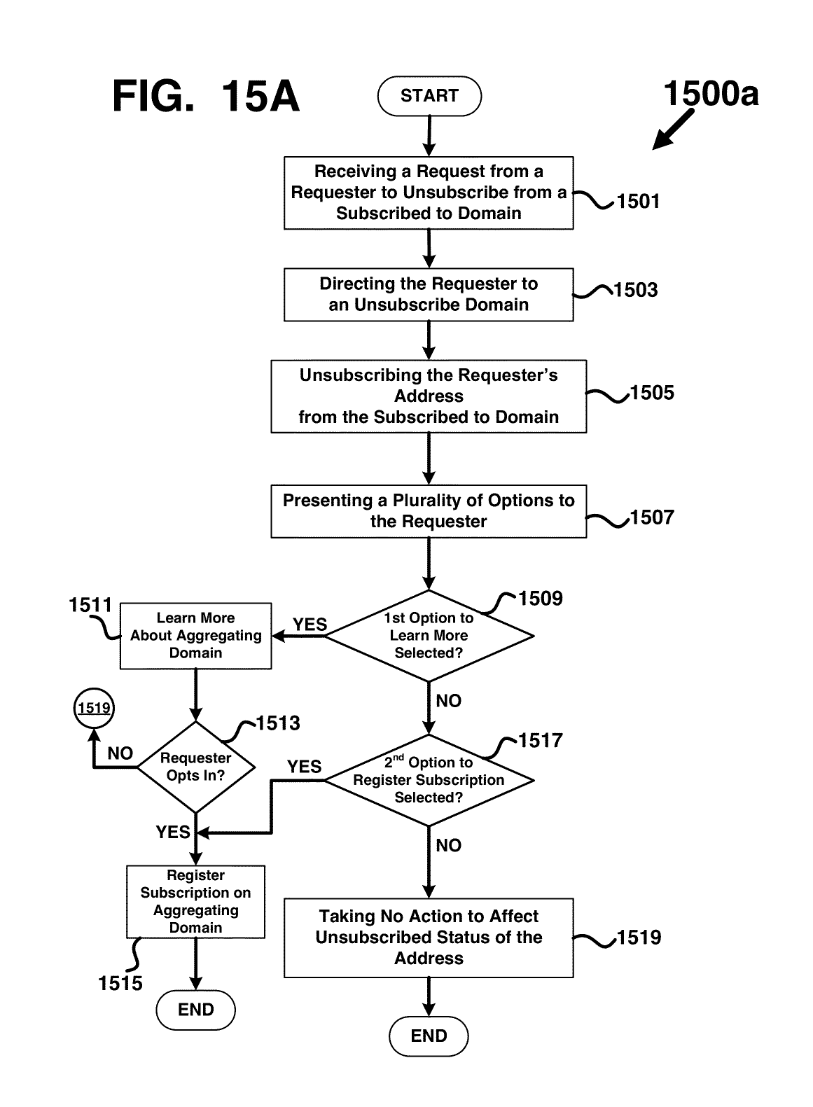

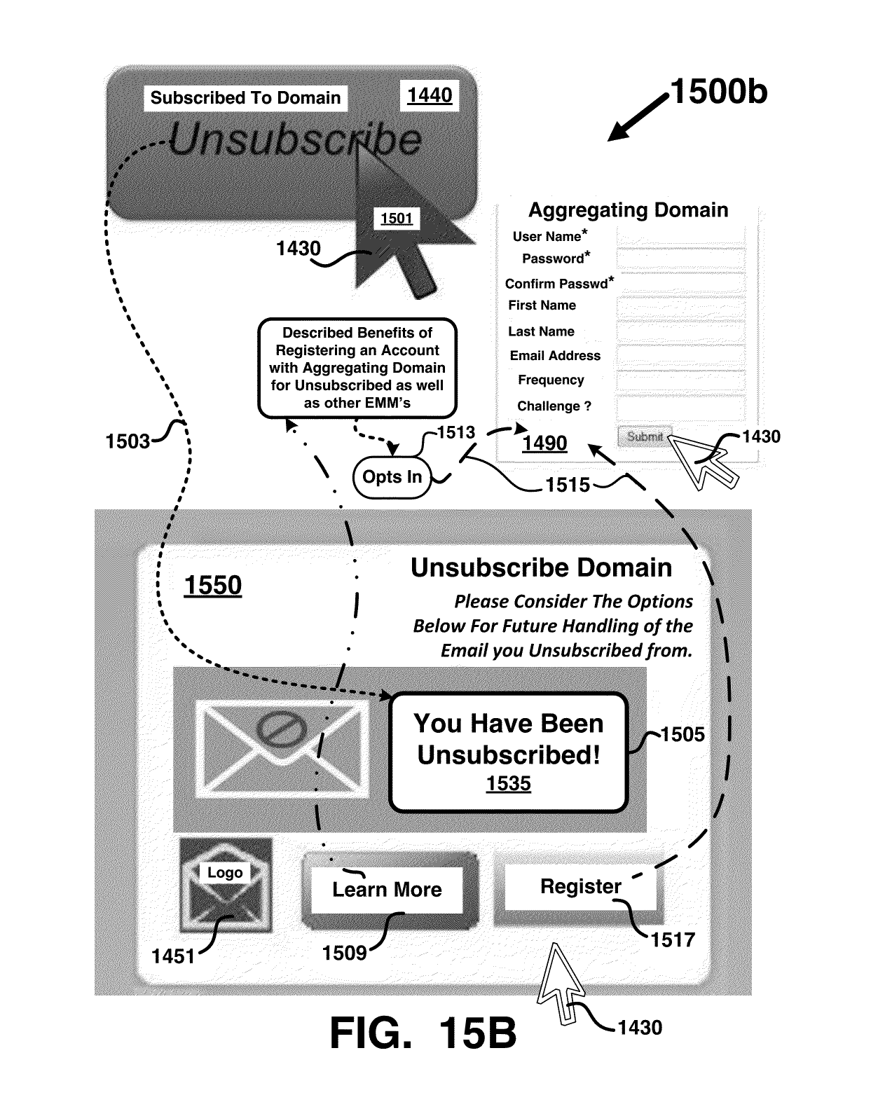

Turning now to FIG. 15A where another example of a flow diagram 1500a for reducing unsubscribes is depicted. In contrast to flow 1400a of FIG. 14A, flow 1500a includes at a stage 1501, receiving a request 1501 form a requester to unsubscribe from a subscribed to domain. At a stage 1503 the requester is redirected to an unsubscribe domain. At a stage 1505, the requester address (e.g., email address, EMM address) is unsubscribed from the subscribed to domain, and the requester may receive a message such as “You Have Been Unsubscribed” (e.g., see 1525 in FIG. 15B). At a stage 1507, after the requester's address has already been unsubscribed from the subscribed to domain, a plurality of options may be presented to the requester.

At a stage 1509 a 1^{st} option to learn more is presented to the requester. If a YES branch is taken, then the requester has selected to learn more about an aggregating domain and flow 1500a transitions to a stage 1511. At the stage 1511 the requester is presented with information regarding an aggregating domain where instead of terminating the receiving of emails from the subscribed to domain, those emails, and optionally other EMM's from other domains that are received by the requester, may be sent to an address (e.g., a unique address such as John_Doe@agreegating.domain.com) for the requester at the aggregating domain.

At a stage 1513 the requester may decide whether or not to “Opt In” to the aggregating domain. If a YES branch is taken at the stage 1513, then the flow 1500a continues to a stage 1515 where a subscription to the aggregating domain is registered for the requester. The flow 1500a may terminate after execution of the stage 1515. If the NO branch is taken from the stage 1513, then the flow 1500a may return to another stage in the flow 1500a, such as a stage 1519 where no further action may be taken in regard to unsubscribing the requester's address at the stage 1501, that is, the requesters address remains unsubscribed from the subscribed to domain.

If the NO branch is taken from the stage 1509, then flow 1500a transitions to a stage 1517 where a second option to register a subscription is selected by the requester and the flow 1500a continues to the stage 1515 where the subscription is registered on the aggregating domain as was described above. The flow 1500a may terminate after execution of the stage 1515. If the NO branch is taken from the stage 1517, then the flow 1500a may transition to the stage 1519 as described above.

Referring now to FIG. 15B, where another example of a scenario 1500b for handling an unsubscribe request that may result in registration with an aggregating domain is depicted. Here, the requester clicking on or otherwise activating an unsubscribed icon or the like, results in the transition 1503 to the unsubscribe domain 1550 where an actual unsubscribing 1535 of the requesters address from the subscribed to domain occurs, as described above in reference to stage 1505. In that the requester's unsubscribe request is fulfilled (e.g., at the stage 1505), the plurality of options (e.g., 1^{st} and 2^{nd} Options 1509 and/or 1517) are presented to the requester as described above, at the stage 1507. The “Learn More” at the stage 1509 may include a discussion of the benefits of registering with the aggregating domain as described above and the requester may decide to “Opt In” followed by registering a subscription as describe above for the stages 1513 and 1515. Similarly, the requester selecting the 2^{nd} Option to “Register” (e.g., at the stage 1517) results in registering a subscription with the aggregating domain 1490 at the stage 1515. The information to be provided by the requester to register the subscription with the aggregating domain may be as described above in reference to FIG. 14B.

EMM's received at address jane_doe@aggregating.domain.com at aggregating domain 1490 as well as any other EMM's received at the same address (e.g., EMM's not resulting from flows 1400a and/or 1500a) may be processed in to tiles 1251 with content rotation CR for display in grid view 1250 and/or carousel view 1350 as was described above in reference to FIGS. 12A-13D. In some examples, pre-processed tiles 1251 may be received at the aggregating domain 1490 and may not require some or all of the stages described above in reference to flows 1400a and/or 1500a. A pre-processed tile 1251 may be processed using one or more of the stages described above in reference to flows 1400a and/or 1500a. Processing of tiles and/or pre-processed tiles 1251 may be by hardware, software, or both. A pre-processed tile 1251 may be a tile 1251 in grid view 1250 or carousel view 1350 that is communicated to another address by activating the “Share” 1289 option described above in reference to FIGS. 12F and 13D, for example. In some applications, the aggregating domain may be socialmail.com as described above, and the address may be john_doe@socialmail.com, for example. In some examples, the domains such as the subscribed to domain, the unsubscribe domain, and the aggregating domain need not be a “.com” and may be a “.org”, “.gov”, “.biz”, “.edu”, or other domains without limitation.

Handling of Tiles

Tiles 1251 as described herein may be configured to simplify an amount of interaction required by a user to divine the content type(s) presented in the tile 1251. For example, unlike emails or other EMM's in an inbox or folder of a conventional email system/engine, a user may not want to take actions such as Reply, Forward, Cc, Bcc, or other actions with respect to the tile 1251 and may merely wish to view the content of the tile and then move on to another tile 1251 of interest. Therefore, the ability to Reply, Forward, Cc, Bcc, or take other actions relating to tiles 1251 and their content may be unavailable to the user either by user election (e.g., user configurable settings and/or preferences) or by algorithms operating on the aggregating domain 1490, for example. In some examples, tiles 1251 may persist after being selected for viewing/content rotation CR by a user. In other examples, tiles 1251 may be relegated to a trash can/bin/folder, deleted items, a recycle bin, or the like after being selected for viewing/content rotation CR by a user. In yet other examples, tiles 1251 after being selected for viewing/content rotation CR by a user may be moved out of view on the grid 1250 or carousel 1350 and unviewed tiles 1251 that were not previously in view on the grid 1250 or carousel 1350 may be moved into view to replace already viewed tiles 1251 that were moved out of view. After a tile 1251 is viewed, that tile 1251 may remain in the grid 1250 or carousel 1350 but with an altered or muted appearance that indicates to the user that the user has already viewed that tile 1251.

A Non-Subscription-Based Alternative to Unsubscribed and Dis-Engaged User Requests Received at Subscribed to Domains

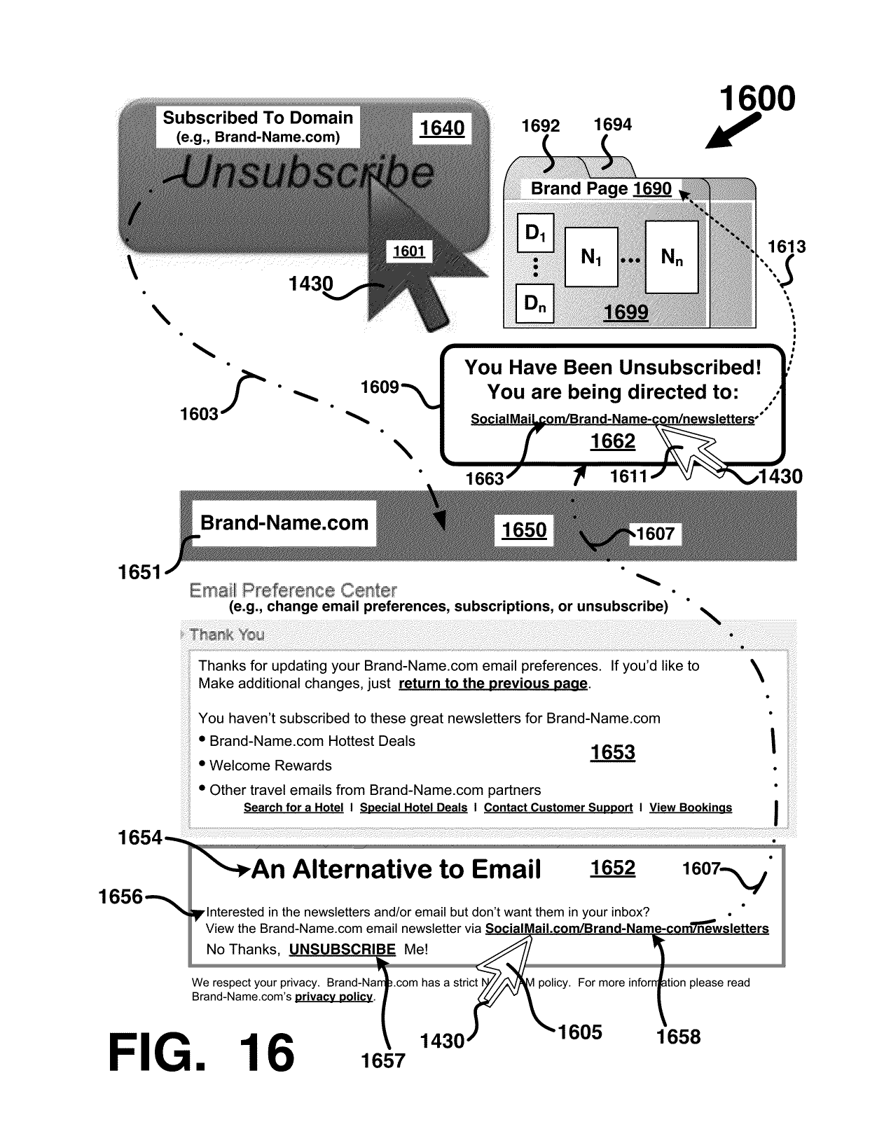

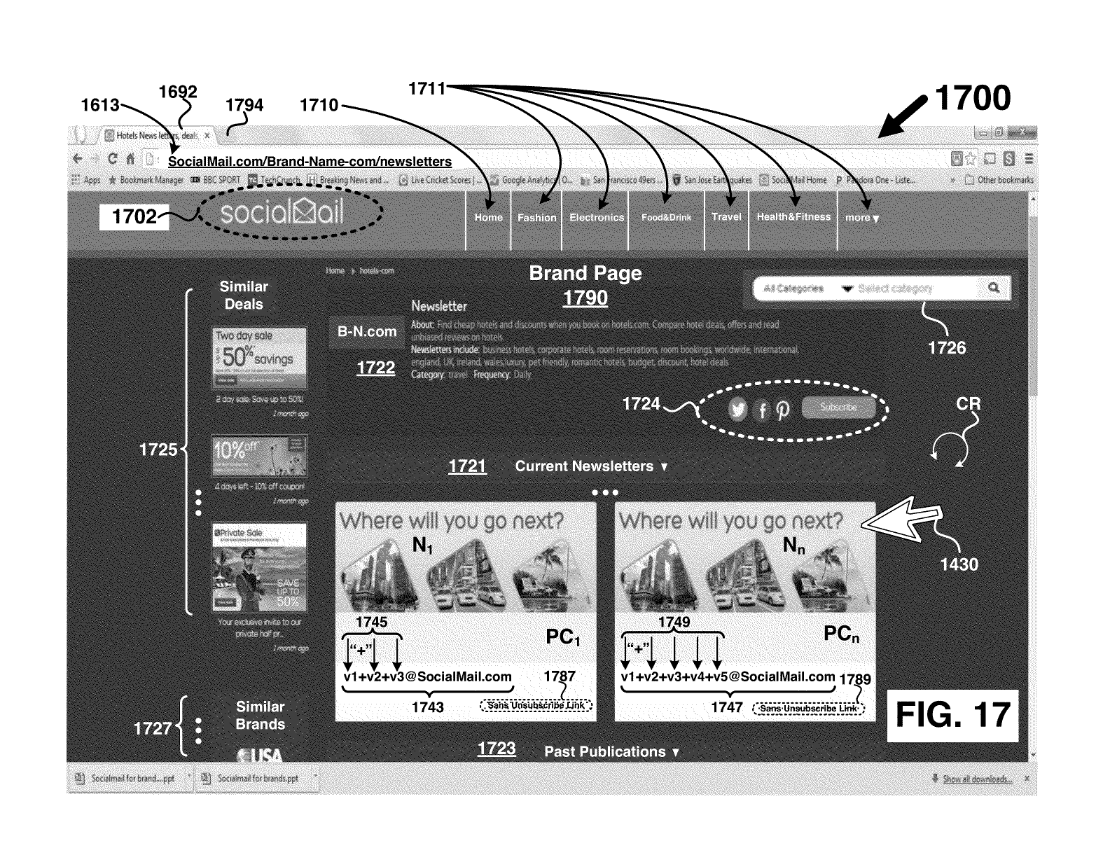

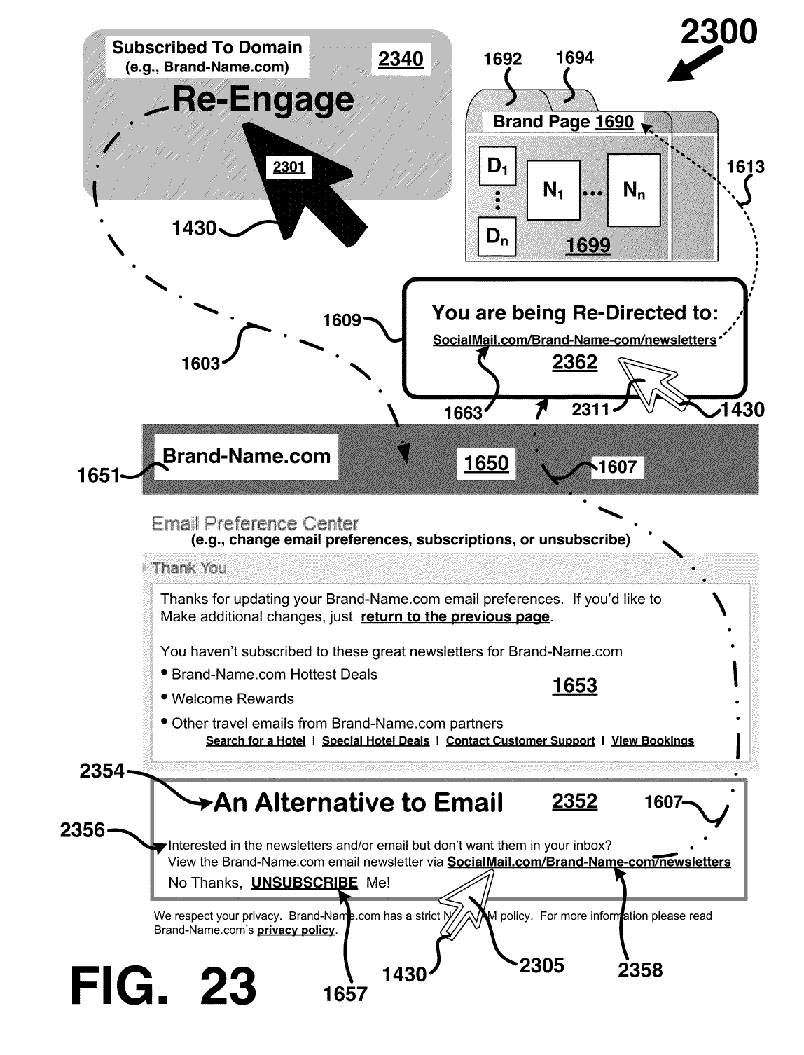

Attention is now directed to FIG. 16 where one example 1600 of a non-subscription-based alternative to receiving electronic messages is depicted. Another example of a non-subscription-based alternative to receiving electronic messages will be described below in reference to FIG. 23. In FIG. 16 a user (e.g., a subscriber to content from a subscribed to domain) may have decided to unsubscribe from the subscribed to domain for various reasons. The user may actually be favorably disposed to content from the subscribed to domain, but for other reasons may decide to unsubscribe, such as the user receives far more electronic messages (e.g., emails, newsletters, marketing collateral) in their inbox or other location than they have time and/or inclination to read. The user may receive electronic messages from other subscribed to domains, and taken as a whole, there are just too many messages from a variety of subscribed to domains and the user has selected 1601 to unsubscribe from the subscribed to domain by using cursor 1430 to select icon 1640 to initiate an unsubscribe process. Activation of icon 1640 may transition 1603 the user to another web page, web site, menu, icon, or other, etc., denoted as 1650 which may be an electronic preference center provided as a customer service to subscribers to the subscribed to domain (e.g., Brand-Name.com). For example, Brand-Name.com may be associated with a service related to hotel reservations, travel, car rentals, etc. Page 1650 may present the user with information 1653 regarding additional subscriptions the user may be interested in; however, the subscribed to domain may wish to offer the user an alternative 1654 to its subscription based electronic messages (e.g., emails, newsletters, marketing collateral, etc.). For example, a non-subscription-based alternative 1652 may offer the user another forum 1656 where the electronic messages (e.g., emails, newsletters, marketing collateral, etc.) may be browsed or otherwise viewed by the user and others without the need to have a subscription to access the electronic messages. One non-limiting example of a subscription may include a user name or a user email address and a password that may be used as access credentials necessary to gain access to the subscription-based electronic messages from the subscribed to domain.

The user may opt out of the alternative and may choose to activate the UNSUBSCRIBE link 1657, thereby unsubscribing the user from receiving future content from the subscribed to domain (e.g., Brand-Name.com). However, for purposes of explaining how the non-subscription-based alternative may operate, it will be assumed that the user instead activates link 1658 (e.g., using cursor 1430 to select 1605, the link 1658). Here, the alternative forum 1656 may allow the user to browse or otherwise view content from the subscribed to domain on a non-subscription-based domain that may include an address in link 1658 (e.g., SocialMail.com/Brand-Name-com/newsletters). Activating link 1658 may transition 1607 the user to another web page, web site, menu, or other, etc., denoted as 1662. The user may be notified as depicted in 1662 and/or by an email, text message, SMS, or other form of electronic message, that they have been unsubscribed from the subscribed to domain. In some examples, the user may be automatically directed to the non-subscription-based domain (e.g., SocialMail.com/Brand-Name-com/newsletters). In other examples, the user may use cursor 1430 to select 1611 a link 1663 presented in 1662 that transitions 1613 to the non-subscription-based domain denoted as 1699. As will be described in greater detail below, non-subscription-based domain 1699 may present content from the subscribed to domain as a brand page 1690 where one or more electronic messages N₁-Nₙ (e.g., newsletters) and optionally other content D₁-Dₙ (e.g., related deals for hotels from other marketing channels and/or publishers of content), may be presented for browsing/viewing by the user, for example.

Non-subscription-based domain 1699 may present content from various subscribed to domains as one or more tabs (1692, 1694) or as separate browser windows, for example. Different tabs (1692, 1694) or different browser windows, may include content from the same or different subscribed to domains. For example, tabs (1692, 1694) may comprise different subject matter from the same subscribed to domain, such that tab 1692 may be related to hotels and travel destinations and tab 1694 may be related to scuba diving travel destinations and scuba diving gear. As another example, tabs (1692, 1694) may comprise different subject matter from different subscribed to domain, such that tab 1692 may related to Hot Rod Automobiles and tab 1694 may be related to Bespoke Bicycle Frames and Parts. Brand page 1690 may be visible to other users (e.g., is public and available without subscription at an address such as a URL). Brand page 1690 may be a website, webpage or other location or address on the Internet or in the Cloud that may be accessed without access credentials (e.g., an account, a login, a user name and/or password); therefore, brand page 1690 may be denoted as credential-less site that does not require a subscription, an account, access credentials, or the like. For example, content included in electronic messages including but not limited to marketing emails, email newsletters, subscription based emails, non-subscription based emails, and other forms of electronic messages may be taken out of (e.g., redirected) the inboxes of one or more users and placed on the brand page 1690 (e.g., after an um-subscribe process) for public access (e.g., credential-less) and viewing of the content (e.g., at socialmail.com/brand-name or socialmail.com/newsletter-name, etc.). ZZZZZ

Moving now to FIG. 17 where one example 1700 of how information may be presented on a brand page 1790 generated by a non-subscription based domain is depicted. In FIG. 17, content from one or more publishers may be presented and the content may be formatted in a grid view, may be tiled, and may undergo content rotation CR as described above. In example 1700, one of the publishers may comprise the subscribed to domain that the user has previously unsubscribed from (e.g., Brand-Name.com denoted as B-N.com) and now presented on the non-subscription-based domain as electronic messages N₁-Nₙ (e.g., current newsletters 1721). Optionally, content (1725, 1727) from one or more other publishers (e.g., electronic messages for related hotel deals from other marketing channels and/or publishers of content) may also appear on brand page 1790. In some examples, brand page 1790 may include content that comprises past publications 1723 from publishers including but not limited to the publisher of electronic messages N₁-Nₙ and/or other publishers (e.g., competitors, publishers associated with content 1725, 1727, or others). Brand page 1790 may include content 1722 provided by B-N.com to aid the user in understanding and using the newsletters or other electronic messages published on brand page 1790 by B-N.com. Brand page 1790 may include content 1724 that may be used to connect or subscribe to other domains, media, social media, professional media, etc. Content 1724 may be generated by an administrator or other authority associated with the non-subscription based domain for brand page 1690, by one of the publishers whose content is presented on the brand page 1690, or both. Brand page 1690 may include a search facility 1726 that may be used to search for other content available at the non-subscription based domain (e.g., at SocialMail.com/ . . . / . . . ). Brand page 1690 may include an identifier 1702, such as a logo, a trademark, a service mark, a registered mark or other indicia that may be used to identify the source for the brand page 1690 (e.g., SocialMail). Brand page 1690 may have address 1613 (e.g., a URI or URL) that may be typed or otherwise accessed by a web browser, search engine or the like to access the brand page 1690. Brand page 1690 may present content in one or more tabs (1692, 1794) or in different browser window or the like, for example. Content presented in tab 1794 may be different that content presented in tab 1692. A home page field 1710 may present content from B-N.com; whereas, other fields 1711 may be selected to present published content for different areas of interest, commerce, product offerings, etc. The one or more electronic messages (e.g., N₁-Nₙ) presented on brand page 1690 may be derived from content published by a publisher of the subscribed to domain. The content as it appears on brand page 1690 may not necessarily be the same as the content as it was presented in the subscribed to domain (e.g., as an email in an inbox of a user who previously subscribed to the content from subscribed to domain). As one example, published content PC₁ for electronic message N₁ as presented in the non-subscription-based domain may not include an unsubscribed link 1787 as denoted in dashed line; whereas, the content as presented in the subscribed to domain may include the unsubscribe link so that a user in the subscribed to domain may have the option to unsubscribe as described above. However, the non-subscription-based domain may be a public domain in which no access credentials or subscriptions are required in order to view the content that is published there. Accordingly, to prevent malicious or accidental acts of unsubscribing content, such as PC₁ or PCₙ, the published content is sans the unsubscribe links denoted by dashed lines for 1787 and 1789 (e.g., they are removed before being published on brand page 1690). Removal of unsubscribe links will be described in greater detail below.

Published content (e.g., PC₁, PCₙ) may include an unique address (1743, 1747) that may be used to determine a category the content belongs in or is otherwise related to. The address may include the non-subscription-based domain (e.g., @SocialMail.com) and one or more variables denoted as “v” separated by a symbol (e.g., the character “+”). A publisher of the content (e.g., PC₁, PCₙ) may use a sign-up form, dashboard, GUI or other form of interface to compose the address for content to be published on the brand page 1690.

As one example, a publisher of a subscribed to domain may transmit electronic messages (e.g., newsletters, emails) to subscribers (e.g., users) that are associated with fashion in San Francisco, Calif., and more specifically with hats. The publisher may compose an address that includes information about the subject matter of the electronic message (e.g., fashion as it relates to hats) and a geographic location (e.g., San Francisco, Calif.). Therefore, the address generated by the publisher may look like: sanfrancisco+fashion+hats@SocialMail.com. The address may comprise a hyperlinked text string, for example. Here the “+” character may be used as a separator between the variables in the address, that is: v1=sanfrancisco; v2=fashion; and v3=hats. An address may be composed of more or fewer variables and may include different separator characters. In the example for published content (PC₁, PCₙ), the composed portion of the addresses 1743 and 1747 are denoted as 1745 and 1749 respectively, with 1749 including more variables (v1-v5) than 1745 (v1-v3). As one example, published content PC₁ in N₁ may comprise: newyork+thehamptons+hotels@SocialMail.com. As another example, published content PCₙ in Nₙ may comprise: massachusetts+marthasvineyard+house+rental+july@SocialMail.com. For example, a user may be presented with published content PC₁, PCₙ or both when the user is transitioned 1613 to brand page 1690. As another example, a user may be presented with published content PC₁, PCₙ or both when entering search parameters in search field 1726 of the brand page 1690. Additional content (e.g., 1725, 1727) that may not be from the publisher of the subscribed to domain may be presented on the brand page 1690. The additional content may change over time and may change in response to search parameters entered by a user in search field 1726, to links or icons the user clicks on (e.g., using cursor 1430), to user data collected from browsing activity, emails, purchases, and other electronic activity that may be detected and stored in a data base or other data store, for example.

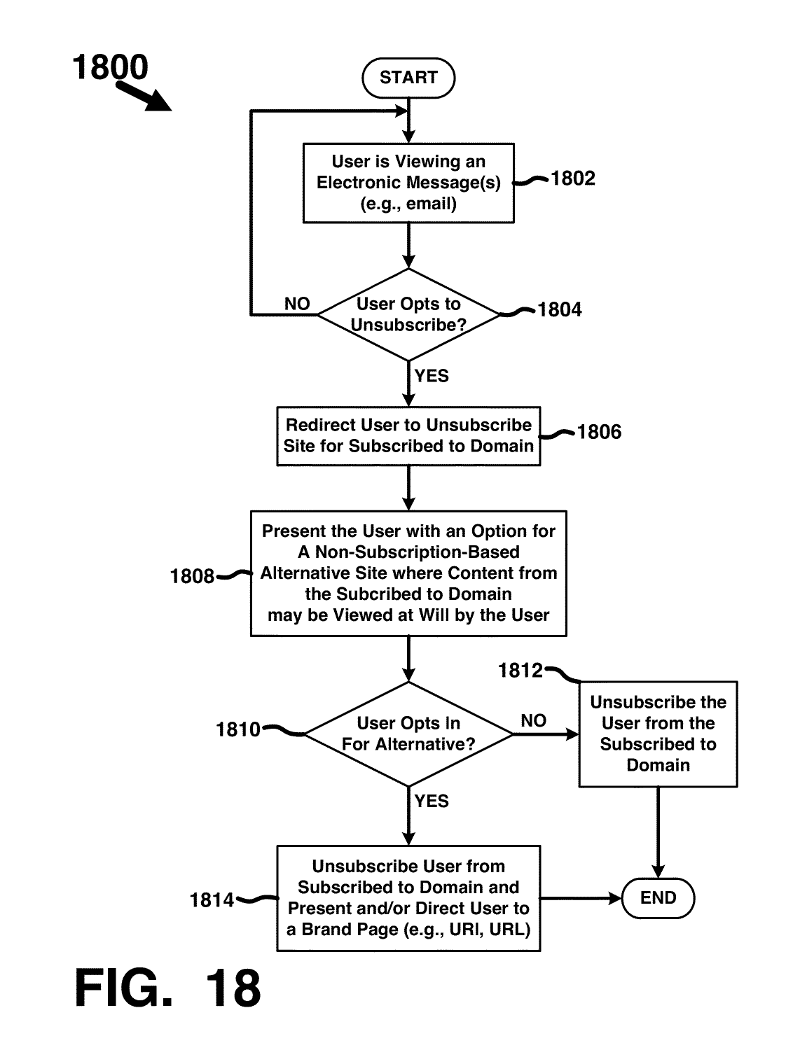

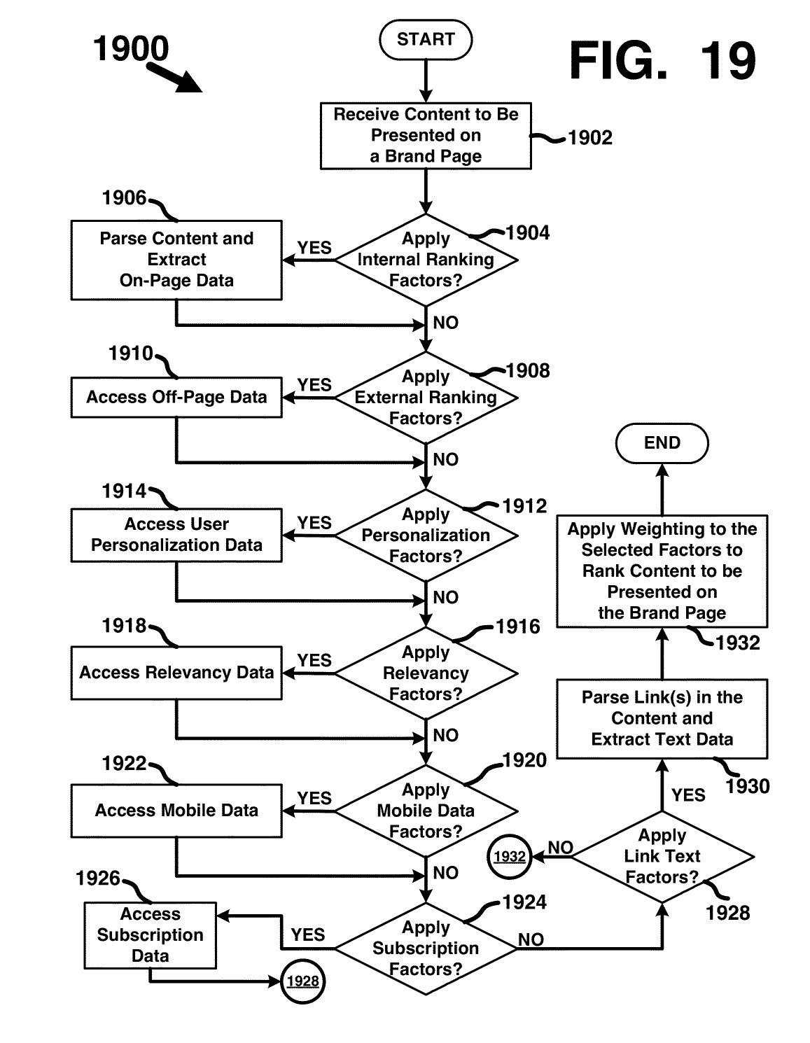

Referring now to FIG. 18 where one example of a flow diagram 1800 of a non-subscription-based alternative to receiving electronic messages is depicted. At a stage 1802 a user viewing an electronic message, such as an email or a newsletter, for example, may decide at a stage 1804 to unsubscribe from the content being received from the subscribed to domain from which the electronic message(s) originate (e.g., Brand-Name.com). If the user decides not to unsubscribe, then a NO branch may be taken from the stage 1804 and flow 1800 may transition to another stage, such as back to the stage 1802. On the other hand, if the user decides to unsubscribe from the content (e.g., 1640 of FIG. 16), then a YES branch may be taken from stage 1804 to a stage 1806.

At stage 1806 the user may be redirected (e.g., 1603 of FIG. 16) to an unsubscribe site for the subscribed to domain (e.g., 1650 of FIG. 16). Stage 1806 may transition to a stage 1808 where the user may be presented with a non-subscription-based alternative that allows the user to unsubscribe from the subscribed to domain while having the option to view content from the subscribed to domain on a brand page (e.g., 1690 of FIGS. 16 and 17) as described above (e.g., 1652 of FIG. 16). Stage 1808 may transition to a stage 1810 where a determination may be made as to whether or not the user has decided to opt-in for the non-subscription-based alternative. If the user chooses to opt-out of the non-subscription-based alternative, then a NO branch may be taken from the stage 1810 to a stage 1812 where the user is unsubscribed from the subscribed to domain (e.g., 1657 of FIG. 16). Conversely, if the user decides to opt-in for the non-subscription-based alternative, then a YES branch may be taken from the stage 1810 to a stage 1814 (e.g., 1605 and 1658 of FIG. 16). At the stage 1814, the user may be unsubscribed from the subscribed to domain and be presented with a link (e.g., hyperlink text for a URI, URL, etc.) to a brand page (e.g., 1690 of FIGS. 16 and 17) or directed to the brand page (e.g., a new tab or window is opened in a browser or the like). As described above, content from the subscribed to domain that the user has unsubscribed from at the stage 1814 may be presented on the brand page and may be accessed without a subscription and/or access credentials. In flow 1800 different systems may perform different tasks associated with the user deciding to opt-in for the non-subscription-based alternative. For example a front end system (e.g., PUBLISHER 2220 of FIG. 22) may handle one or more stages of flow 1800 (e.g., stages 1802-1810 and stage 1812) and a backend system (e.g., ADMIN 2110 of FIG. 22) may handle one or more portions of stage 1814, such as providing a web site, web page, etc. where content from the publisher is presented for browsing by the user when the link 1658 is activated by cursor 1430 or when the user is directed to the address in the link 1658 by opening a new tab or browser window, for example. The examples depicted in FIGS. 16-17 may be presented to a user on a variety of client devices including but not limited to a wireless client device, a laptop computer, a PC, a server, a tablet, a pad, a smartphone, a smart watch, a wearable device, a hand-held device, a PDA, a touch screen device, a TV, a HDTV, a Smart TV, an image projection device, an eyepiece, a goggle, eyeglasses, etc., just to name a few for example. In some examples the non-limiting web page format depicted in FIG. 17 may be modified, changed or otherwise adapted for presentation on different types of devices such as mobile devices, hand-held devices, eyeglass/goggle displays, smart watches, etc.

Referring now to FIG. 19 where one example of a flow diagram 1900 of ranking of content presented on a brand page is depicted. A system, such as a backend system (e.g., ADMIN 2210 of FIG. 22) may host and present content from a plurality of publishers (e.g., PUBLISHERS 2220 of FIG. 22) who may have different brand pages 1690 generated by the backend system. In that the number of marketing emails, newsletters, emails, marketing collateral and other electronic messages that may be formatted for presentation by the backend service for the various brand pages 1690 may be in a range from about 100K to over 1 million, and may continue to increase over time, a methodology may be applied by the backend service for ranking of content that may be presented on the brand pages 1690.

In flow 1900 at a stage 1902 content to be presented on a brand page (e.g., 1690) may be received (e.g., by a backend service). Compute resources available to the backend service (e.g., internally or externally) may receive the content from a communications link (e.g., wired and/or wireless such as 2201 of FIG. 22). At a stage 1904 a decision as to whether or not to apply one or more internal ranking factors to the content that was received may be made. Internal ranking factors may apply to data included in the content (e.g., on-page elements, on-page data, in-content data) that was received regardless of whether or not that data is perceptible to a user. In some examples, internal ranking factors may be included in data internal to the backend system. Non-limiting examples of internal ranking factors (e.g., that may be applied to on-page data) include but are not limited to metadata, subject lines, date, time, date content was received, time content was received, images in the content, attachments in the content, size and/or number of images in the content, size and/or font type of text in the content, audio and/or video included in the content, IP address content was sent from or is otherwise associated with, URI or URL the content is derived from, publisher who sent the content, publisher ranking (e.g., some publishers may be higher ranked than other publishers such as USA Today vs. a local community newspaper), frequency at which the content is sent (e.g., daily, hourly, weekly, monthly, etc.), headline and/or subject of the content (e.g., “lifestyles”, “Travel”, “Politics”, “Cooking”, “Skiing”, etc.), Bold text and/or Italic text in the content, etc., just to name a few.

If a YES branch is taken from the stage 1904, then flow 1900 may transition to a stage 1906 where content may be parsed (e.g., read, analyzed, searched, etc.) to extract on-page elements. On-page elements that meet the criteria for the internal ranking factors may be stored in a data store, may be processed by one or more algorithms, or both and may later be included on the brand page (e.g., formatted for presentation as content such as N₁ or Nₙ of FIG. 17.

If a NO branch is taken from the stage 1904, then flow 1400 may transition to a stage 1908 where a decision may be made as to whether or not to apply external ranking factors to ranking and/or categorization of the content from a publisher. External factors may be accessed from sources of data or information that are external to the backend system and/or the content being received by the backend system (e.g., off-page elements, off-page data). Non-limiting examples of external factors includes but is not limited to popularity of a brand, service or product (e.g., based on standard metrics such as Google Ad Planner, Compete, Alexa, Google Insights, SEMrush, Quantcast, DoubleClick, Google Trends, etc.), open rate, Click-Through Rate (CTR) (e.g., CTR may be equal to the number of clicks divided by the number of impressions, or some other metric), bounce rate, unsubscribe rate, conversion of marketing emails (e.g., a click-through resulting in an actual purchase or action on part of a user), and ranking of a web site (e.g., using metrics that determine how highly ranked a web site is), metadata, etc., just to name a few. If a YES branch is taken from the stage 1908, then flow 1900 may transition to a stage 1910 where off-page data is accessed and one or more external ranking factors may be applied to the ranking process. If a NO branch is taken from the stage 1908, the flow 1900 may transition to a stage 1912 where a determination may be made as to whether or not to apply personalization factors to the ranking process. The above described internal factors and/or external factors may be used to determine a ranking of content, position of content, size of content or other form of prominence of content to be displayed.

If a YES branch is taken from the stage 1912, then flow 1900 may transition to a stage 1914 where user personalization data may be accessed to apply one or more personalization factors to the ranking process. Non-limiting examples of personalization data include but are not limited to user likes based on searches on a web browser or other search engine, cookies, bookmarks, click-thru, visits to sites on the Internet, history files from browsers, and emails sent and/or received, etc., just to name a few. If a NO branch is taken from the stage 1912, then flow 1400 may transition to a stage 1916 where a determination may be made as to whether or not to apply relevancy factors to the ranking process. If a YES branch is taken from the stage 1916, then flow 1900 may transition to a stage 1918 where relevance data (e.g., on-page, off-page or both) may be accessed and may be applied to the ranking process. Non-limiting examples of relevancy data include but are not limited to user personal interest (e.g., identified by previous search history of the user), category relevancy, browser based signals (e.g., emails associated with brand websites previously visited by the user), etc., just to name a few. If a NO branch is taken from the stage 1916, then flow 1900 may transition to a stage 1920.

At the stage 1920 a determination may be made as to whether or not to apply mobile data factors to the ranking process. If a YES branch is taken from the stage 1920, then flow 1900 may transition to a stage 1922 where mobile data (e.g., mobile data associated with or generated by the user or the user's client devices, see 2250 in FIG. 22) may be accessed and may be applied to the ranking process. Non-limiting examples of mobile data include but are not limited to location data, GPS data, wireless access data (e.g., wireless access by a client device at a business), wireless transaction data (e.g., payments made wirelessly at a business), accelerometer data generated by a client device (e.g., indicative of activity such as exercise, running, etc.), data from applications (APP's) running on a client device (e.g., browser data, social media site data, professional media site data), search data from APP's, web sites visited using a client device, etc. just to name a few. If a NO branch is taken from the stage 1920, then flow 1900 may transition to a stage 1924.

At the stage 1924 a determination may be made as to whether or not to apply subscription factors (e.g., current subscriptions of the user) to the ranking process. If a YES branch is taken from the stage 1924, then flow 1900 may transition to a stage 1926 where subscription data (e.g., on-page, off-page or both) may be accessed and may be applied to the ranking process. Non-limiting examples of subscription data includes but is not limited to newsletter subscriptions, email subscriptions, billing subscriptions (e.g., for student loan payment notifications, utility bill notifications, etc.) finance notifications (e.g., bank accounts, investment accounts, etc.), emails from retailers and on-line sellers of goods and/or services, etc., just to name a few. As one example, a user may be currently subscribed to electronic messages from one or more sources (e.g., publishers) such as “REI” and “Runners World” (e.g., indicating a potential user interest in exercise, health, fitness), “Michael Kors”, “One Kings Lane”, and “Lacoste” (e.g., indicating a potential user interest in fashion), etc., just to name a few. The subscription data may be used in ranking searches made by the user on the brand page (e.g., 1690). For example, if the user enters “Sunglasses” in the search field (e.g., 1726 of FIG. 17), then product offerings and/or services related to fashion may have a higher ranking in the returned search results and may include hits for content from one or more of “Michael Kors”, “One Kings Lane”, and “Lacoste”. There may be hits from “REI” and “Runners World” as well and those hits may be of lower rank as may not be as closely related in ranking to fashion. However, actual search results and ranking may be application dependent and are not limited to the examples herein. Moreover, a search for “Sunglasses” may include content from higher ranked hits from “REI” and “Runners World” as sunglasses are often used in exercise and fitness and other factors in flow 1900 may indicate a user preference for exercise, health and fitness than for fashion, for example, thereby ranking the search results to more closely match indicated user preference, likes, dislikes, habits, shopping patterns, spending patterns, etc. The stage 1926 may transition to another stage in flow 1900, such as a stage 1920, for example. If a NO branch is taken from the stage 1924, then flow 1900 may transition to the stage 1928.

At the stage 1928 a determination may be made as to whether or not to apply link text factors in the ranking process. If a NO branch is taken from the stage 1928, then flow 1900 may transition to a stage 1932. On the other hand, if a YES branch is taken from the stage 1928, then flow 1900 may transition to a stage 1930. At the stage 1930, link content may be parsed to extract text data from the text in the link. Text data that may be included in a link (e.g., an on-page hyperlink text) may include but is not limited to ASCII text characters, alpha numerical characters, special characters, symbols, fonts, text in Bold, Italic, or regular font, etc. Text included in links in content may be parsed, extracted and analyzed to determine the importance, if any, of the text in the link (e.g., one or more of size/font of text, style of text such as Bold text, Italic text, phrases in text, or length of text may indicate importance of text included a link/hyperlink). In some examples, shorter lengths of text (e.g., 24 characters or less) may have higher importance than longer lengths of text (e.g., greater than 24 characters). In other examples, Bold text may have higher importance than Italic text and regular text (e.g., not Italic or Bold). In another example, Italic text may have higher importance than regular text. The stage 1930 may transition to the stage 1932.

The stage 1932 may apply weighting to one or more of the selected factors (e.g., from one or more of stages 1906, 1910, 1914, 1918, 1922, 1926, and 1930) and may use the weighting to rank the content that is to be presented on the brand page (e.g., to determine how content will be presented on brand page 1690). Ranking of the content based on the weighting at the stage 1932 may be used to determine a layout of content on the brand page. Layout of the content on the brand page may include but is not limited to a position of the content on the brand page, a position of the content relative to other content on the brand page, prominence of the content relative to other content on the brand page, an order of presentation of the content on the brand page, appearance (e.g., look and feel, icon size and/or shape, color pallet, fonts, etc.) of content on the brand page, hierarchy (e.g., content with a higher weighting may be presented on top of or overlaid over content of with a lower weighting) of content on the brand page, and formatting of content on the brand page, etc., just to name a few. Weighting applied at the stage 1932 may be application specific and may be different for content from different publishers. Weighting applied at the stage 1932 may be used to determine which items of content from a publisher or publishers are presented on the brand page (e.g., N₁-Nₙ, D₁-Dₙ). Weighting applied at the stage 1932 may be used to determine how items of content from a search (e.g., using search field 1726) are ranked, the order in which the items are presented in the search results, or other. Weighting applied at the stage 1932 may be used in a calculus for presenting data on the brand page that may be varied based on any number of application dependent factors, in response to inputs received by the backend system, the frontend system, user inputs, etc., just to name a few.

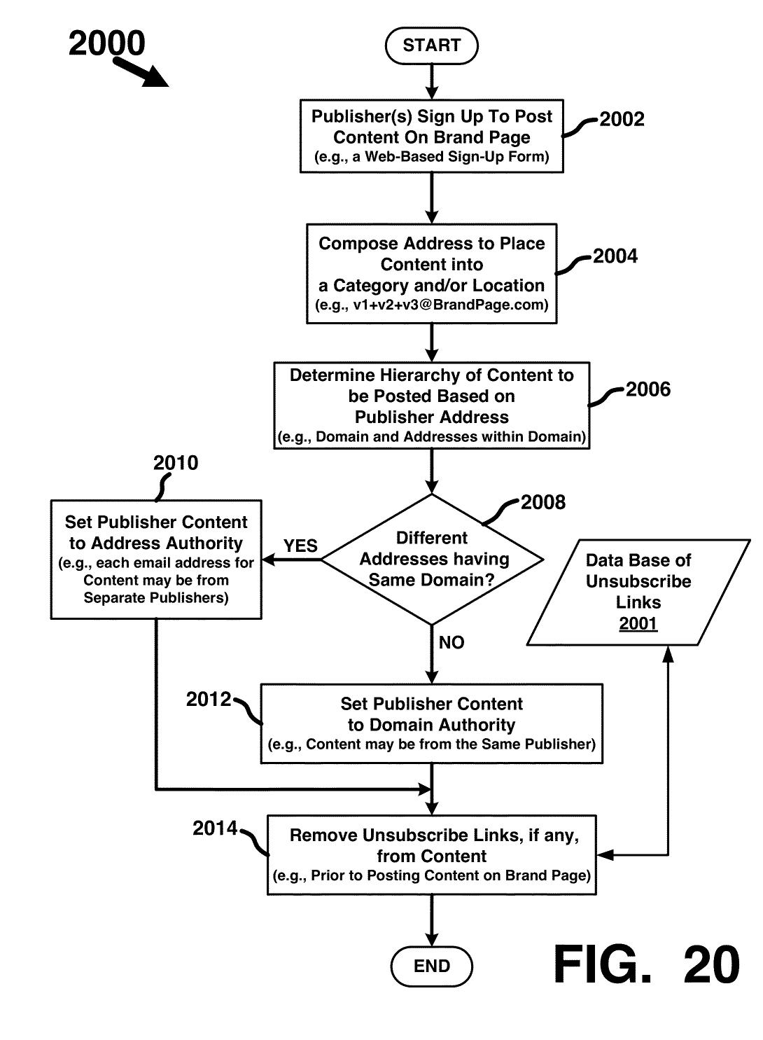

Referring now to FIG. 20 where one example of a flow diagram 2000 of collection and organization of content by publishers who submit content to a non-subscription-based alternative to receiving electronic messages is depicted. In flow 2000 at a stage 2002 a publisher (e.g., of a newsletter, a business, a service, a web site, etc.) may sign up (e.g., using a username and password) to a backend system (e.g., ADMIN 2210 of FIG. 22) to post content (e.g., N₁-Nₙ, D₁-Dₙ) to a brand page hosted or otherwise generated by the backend service. A web-based sign-up form or the like may be used by the publisher to enter necessary information (e.g., publisher name, address, place of business, email address(s), phone number(s), state of incorporation, tax-ID number, web site, lists of goods, services, emails, and newsletters, etc.) to register with the backend system. At a stage 2004, the publisher may compose one or more addresses (e.g., v1+v2+v3@BrandPage.com) to place content into a category or location on the brand page (e.g., 1690) as described above. Content from the publisher may have different categories and locations or other information that may be used to determine placement of the content as published on the brand page and may determine search term key words that may be used by a user in searching for content on the brand page. As one example, a publisher may compose the following addresses (a)-(c) for fashion related to shoes, fragrances, and jackets:

(a) sanfrancisco+fashion+shoes@BrandPage.com;
(b) chicaqo+fashion+fragrances@BrandPage.com; and
(c) london+fashion+jackets@BrandPage.com.

As another examples, one or more publishers may compose the following addresses:

world=badminton=racket=strings@xmail.com;
world=badminton=rackets@xmail.com;
world=badminton=shuttlecocks@xmail.com;
world=badminton=shoes@xmail.com;
india=bangalore=badminton=tournaments@xmail.com;
bespoke=bicycles=transmissions=derailleurs@ride.com;
bespoke=bicycles=transmissions=electronic=derailleurs@ride.com;
bespoke=bicycles=brakes=hydraulic@ride.com; and
hotrods=engines=pistons=rings@gearhead.com.

In the above examples, an equal sign “=” is uses as a separator between variables, to provide an alternate example of a different type of separator symbol. Actual syntax for addresses and/or separators may be application dependent and may be determined by the backend system (e.g., the host for the brand page).

At a stage 2006 a backend service that receives the composed address (e.g., via a communications network) may determine a hierarchy of content to be posted on the brand page and that hierarchy may be based on the address provided by the publisher.

At a stage 2008 a determination may be made as to whether or not different addresses having the same domain (e.g., v1+v2@xmail.com and v4+v5+v6+v7+v8@xmail.com) have been received. For example, if multiple addresses from the same domain are received by the backend system, each of those address may comprise a different email address from different publishers. Each of the different publishers may have different settings in the brand page. If a YES branch is taken from the stage 2008, then at a stage 2010 different addresses (e.g., v1+v2 and v4+v5+v6+v7+v8) from the same domain (e.g., @xmail.com) have been received and the backend system may set content associated with the different addresses from the same domain to address authority, such that each different address from the same domain is associated with a separate publisher, that is, publisher-one=v1+v2 and publisher-two=v4+v5+v6+v7+v8. As one example, consider the following four composed address from domain @freemail.com: dresses+hoopskirts@freemail.com; k9+collars+rolledfreemail.com; cats+collars@freemail.com; and saws+handsaws+jewelers+diamond+blade@freemail.com. Here, all four addresses are different and have domain @freemail.com in common. At the stage 2010 and admin or other authority and/or algorithm at the backend system may set all four addresses to address authority (e.g., email address authority for the different addresses) and associate content from each of those four different addresses with four different publishers.

If a NO branch is taken from the stage 2008, then at a stage 2012 the backend system may set content for addresses from within the same domain with domain authority, such that content from those addresses are associated with a single publisher. Setting authority to domain authority may indicate that all email addresses within the domain share the same settings. In the above bicycle example, domain authority for @ride.com may be set for all email address from domain @ride.com, where the publisher of the content is @ride.com (e.g., bespoke=bicycles=transmissions=derailleurs@ride.com, bespoke=bicycles=transmissions=electronic=derailleurs@ride.com, and bespoke=bicycles=brakes=hydraulic@ride.com).

At a stage 2014, unsubscribe links, if any, included in the content to be published, may be removed by the publisher, the backend service or both. In some examples, the backend service may parse submitted content to determine if the content includes unsubscribe links and compare unsubscribe links that are found with a data base (e.g., 2001) or other data store of unsubscribe links (e.g., exact matches and/or variations of the unsubscribe link(s) found in the submitted content). Unsubscribe links that are found may be removed from the content prior to that content being presented or otherwise posted for viewing/browsing on the brand page (e.g., 1690). There may not be an exact match between the unsubscribe link found in the content and the unsubscribe links in the data base of unsubscribe links. Therefore, a similitude between the unsubscribe link in the submitted content and one or more datum from the data base of unsubscribe links may be all that is necessary to cause removal of the unsubscribe link found in the content. In some examples, there may be an exact match between the unsubscribe link found in the content and one or more datum from the data base of unsubscribe links. In other examples, there may be no match between the unsubscribe link found in the content and one or more datum in the data base of unsubscribe links. The admin (e.g., the backend system) may analyze the syntax, text, content, structure or other attributes of the unsubscribe link found in the content and determine that is may be an unsubscribe link and remove it from the content. Furthermore, the backend system may add the unsubscribe link to the data base so it may be available for use in matching future items of content that are submitted. Removing unsubscribe links prior to publishing content on the brand page may prevent malicious or accidental unsubscribing of content from the brand page, in that in some examples, the brand page may be a public forum that does not require a subscription and/or access credentials to gain access to the brand page.

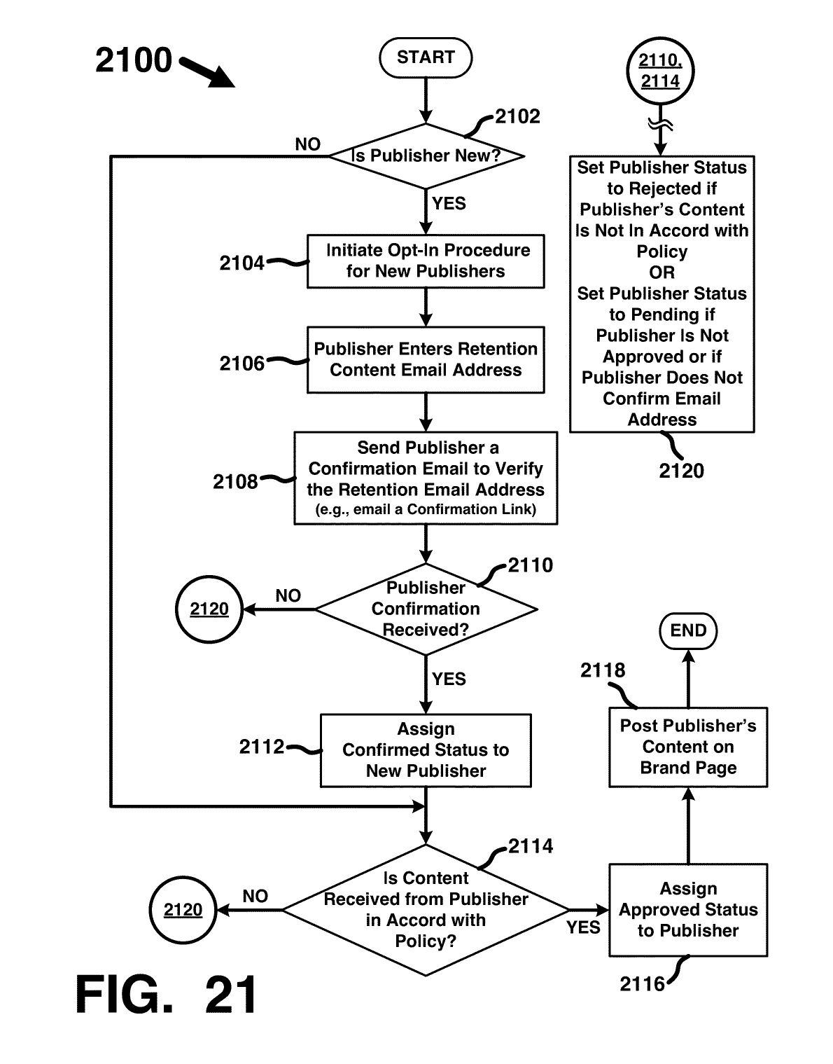

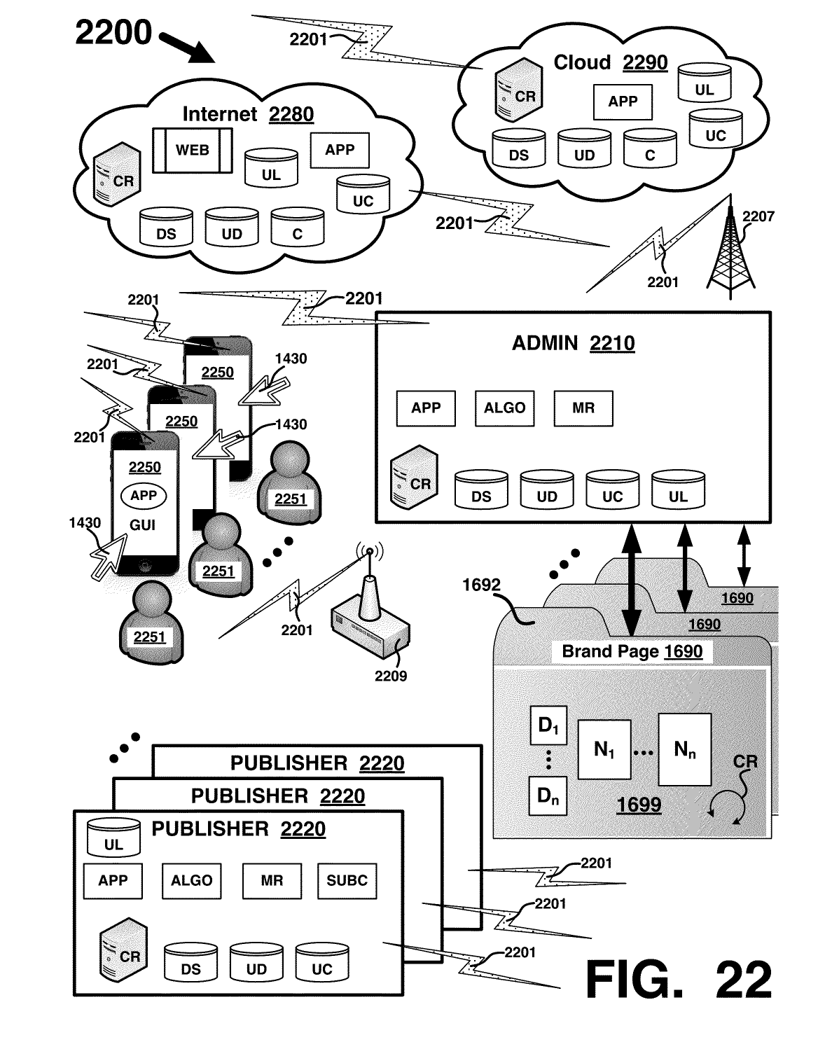

Description now is directed to FIG. 21 where one example of a flow diagram 2100 of a publisher opt-in process is depicted. Prior to granting publisher access to submit content for presentation on the brand page(s) of the non-subscription-based-alternative, the admin or other authority may vet the publisher and/or content from the publisher. At a stage 2102 a determination may be made as to whether a publisher is a new publisher (e.g., a new email address or addresses and a new domain that have not been previously used by other publishers). If a NO branch is taken from the stage 2102, then flow 2100 may transition to another stage, such as the stage 2114 as will be described in greater detail below. If a YES branch is taken from the stage 2102, then at a stage 2104 an opt-in process may be initiated for the new publisher. At a stage 2106 the publisher may enter a retention content address (e.g., typing an email address into a retention content address field in an on-line form in a Newsletter sign up Box). A non-limiting example of a retention content address for a new publisher may comprise publisher.admin.content@jays-surfboards.com.

At a stage 2108 a confirmation email that may include a confirmation link may be emailed to the email address that was entered for the retention content address by the publisher. The confirmation email may be sent to verify the email address for the retention content address and to prevent spammers or hoax sites from gaining access to the brand page.

At a stage 2110 a determination may be made as to whether or not publisher confirmation has been received (e.g., by the backend system), that is, the publisher has confirmed receipt of the confirmation email by activating the link included in the confirmation email, for example. If a NO branch is taken from the stage 2110, then flow 2100 may transition to another stage, such as a stage 2120 that will be described in greater detail below. If a YES branch is taken from the stage 2110, then the new publisher has confirmed receipt of the confirmation email and activated the confirmation link, and at a stage 2112 a confirmed status may be assigned to the publisher and the publisher may be sent an email announcing the confirmed status and that email may also notify the publisher that they may begin to send content for publication. At a stage 2114 a determination may be made as to whether or not content received from the publisher is in accord with a policy of the brand page host (e.g., backend system). The policy may be one or more rules that govern what may or may not be included in content being submitted by the publisher. Non-limiting examples include but are not limited to offensive language, offensive images, pornography, immoral content, hateful images or text, defamatory statements, etc. The backend system may employ algorithms and/or moderators that review content for compliance with rules and/or policies of the hosting domain. Testing of content for conformance with the rules/policy may require a publisher to transmit a minimum amount of content (e.g., more than two items of content) for review. If a NO branch is taken from the stage 2114, then flow 2100 may transition to another stage, such as the stage 2120. If a YES branch is taken from the stage 2114, then at a stage 2116 the publisher may be assigned an approved status. Approved status may include forwarding content of approved email addresses to the hosting domain (e.g., @SocialMail.com).

At a stage 2118, publishers having approved status may begin to transmit content to be published on the brand page (e.g., 1690) using email or other forms of communication (e.g., Dropbox, etc.). At the stage 2120, a publisher whose content was not in conformance with the rules/policy at the stage 2114 may have their status set to a rejected status, or publisher status may be set to pending if that publisher has not attained approved status at the stage 2116 or has not confirmed their email address at the stage 2110.

Turning now to FIG. 22 where one example of a system diagram 2200 of a non-subscription-based alternative to receiving electronic messages is depicted. In FIG. 22, one or more systems such as Internet 2280, Cloud 2290, ADMIN 2210, PUBLISHERS 2220, client devices 2250, wireless access point 2209 and cellular tower 2207, may communicate 2201 with one another using a variety of communications links include wireless, wired, or both. One or more of the above mentioned systems may include internal resources, external resources, or both including but not limited to computer resources (CR) (e.g., servers, computers, compute engines, etc.), data storage (DS) (e.g., NAS, RAID, SSD, enterprise class storage, etc.), user data (UD) (e.g., data generated by, accessed by, or associated with one or more users 2251), a data store of unsubscribe links (UL) (e.g., a data base, look-up table, hash table, etc., see 2001 of FIG. 20), a data store for unsubscribed to content (UC) (e.g., electronic messages that may be published on brand page 1690), algorithms (ALGO) embodied in a non-transitory computer readable medium (e.g., Flash memory, SSD, HDD, DRAM, etc.) that may be used to implement one or more of the flows or variations of the flows including but not limited to flows depicted in FIGS. 18-21, subscriptions (SUBC) to subscribed to content (e.g., access credentials for users 2251 to access subscribed to content from PUBLISHERS 2220), application software (APP) (e.g., an application operative to execute on a processor(s) of a client device such as devices 2250), content (C) (e.g., emails, newsletters, deals, advertisements, ads, marketing collateral, etc.) that may be presented on brand page 1690, moderation rules (MR) (e.g., data, software or both that may be used to vet content from publishers, see stage 2114 of FIG. 21), and web pages or web sites (WEB) (e.g., a URI or URL where users may view brand page 1690 and/or unsubscribed from subscribed to content).

Now, in FIG. 22, one or more users 2251 may have subscriptions (e.g., as stored in SUBC) from one or more publishers 2220 and one or more of those users may decide to select the non-subscription-based alternative as described above and elect to access content from the publisher on the brand page 1690 for that publisher's unsubscribed to content and/or other content from that publisher or other publishers, advertisers, etc. For example, one or more users 2251 may use a GUI, APP, browser or the like on their respective client devices 2250 (e.g., smartphone, tablet, pad, smart watch, etc.) to select using cursor 1430, a finger, a stylus or the like, the unsubscribe option (e.g., 1657 of FIG. 16) or the unsubscribe option that includes the non-subscription-based alternative (e.g., 1658 and 1662 of FIG. 16). A frontend system (e.g., the Publisher 2220 or a third party) may process and handle electronic message preferences for users 2251 (e.g., such as the opt-out option 1657 or the opt-in option 1658 in 1650 of FIG. 16). For example, of the plurality of users 2251 depicted, each may decide to unsubscribe from content from different publishers 2220 and select the non-subscription-based alternative option (e.g., the opt-in option 1658 in 1650 of FIG. 16). Each user may be removed from the subscribers data base (SUBC) and be redirected or provided with a link to the brand-page 1690 for that publisher's content.

ADMIN 2210 may be a backend system that generates brand pages 1690, receives content from publishers, vets the content by applying moderation rules MR, removes unsubscribe links, and performs other tasks as described above. The flows 1800-2100 described above in reference to FIGS. 18-21 may be performed by ADMIN 2210, Publisher(s) 2220 or both. In some examples at least a portion of one or more of the flows 1800-2100 may be processed via Cloud 2290, Internet 2280 or both. In other examples, data storage DS, content C, unsubscribe links data bases UL, user data UD, algorithms ALGO, moderation rules MR, applications APP, unsubscribed to content UC, may be accessed 2201 from one or more sources or systems such as Cloud 2290, Internet 2280, Publishers 2220, or ADMIN 2210. Computer resources CR for Publishers 2220 and/or ADMIN 2210 may be internal, external or both.

As one example, a frontend system (e.g., Publisher(s) 2220) may execute one or more stages of flows 1800 (e.g., stages 1802-1814), 2000 (e.g., stages 2002 and 2004), and 2100 (e.g., stages 2106, 2110, and transmitting content in stage 2114). As another example, a backend system (e.g., ADMIN 2210) may execute one or more stages of flows 1900 (e.g., stages 1902-1932), 2000 (e.g., stages 2006-2014), and 2100 (e.g., stages 2102-2104 and 2108-2120).

Admin 2210 may generate a plurality of brand pages 1690 for a plurality of publishers 2220 who had users 2251 that selected the opt-in 1658. However, in the non-subscription-based domain in which the brand pages live, any of the users 2251 may also view any of the other brand pages 1690 available in the domain using a search engine, search field (e.g., 1726) or a link or other data that addresses the brand page (e.g., via a URI or URL). In some examples, content from a publisher (e.g., an approved publisher) may already exist as a brand page and a newly unsubscribed user who elects to opt-in may be redirected to the already existing brand page for the content and there may be no need for the content to be vetted or the publisher to be approved as described above. In some examples, a trusted publisher and/or a trusted third party may perform some or all of the tasks in one or more of the flows 1800-2100. As one example, a trusted publisher 2220 may be allowed to vet content to be published by the ADMIN 2210 by applying the moderation rules MR to the content and may transmit the content, if it passes the vetting process, to the ADMIN 2210 for publication on one or more brand pages 1690. Publishers may include advertisers, sellers, merchants, businesses, corporations, individuals, or other entities that have content for presentation on one more brand pages 1690, such as deals D₁-Dₙ (e.g., 1725 of FIG. 17) or branded products (e.g., 1727 of FIG. 17), for example. Processes for placing content of the aforementioned entities may be accomplished using one or more stages of the one or more flows 1800-2100. In some examples, ADMIN 2210 or a third party acting on behalf of the ADMIN 2210 may handle the process of vetting those entities and the content they submit for publishing on the brand page.

Attention is now directed to FIG. 23 where another example 2300 of a non-subscription-based alternative to receiving electronic messages is depicted. In some examples users desiring to unsubscribe from content in electronic messages from publishers or others may be a subset of a broader set of users. As one example, unsubscribe users may be a subset of dis-engaged users. As another example, unsubscribe users and dis-engaged users may not be subsets of each other. Dis-engaged users may be users who receive marketing content, news content, newsletter, advertisements, and other forms of electronic messages; however, the dis-engaged user may not have opened those electronic messages (e.g., clicked on, selected for viewing/reading) in a long enough period of time (e.g., 3-months, 6-months, etc.) that may indicate the user is dis-engaged. For example, dis-engaged users may account for approximately two-thirds (⅔) of subscribers to an electronic messaging list (e.g., an email list, a marketing list, newsletter list, etc.). As another example, users who desire to unsubscribe from content may account for approximately one-third or less of a subscription base for the electronic messaging list. A dis-engaged user may be too busy to read subscribed to electronic messages, or may be overwhelmed by the sheer number of electronic messages they receive, for example. However, the dis-engaged user may still desire access to the content presented in subscribed to electronic messages if they were to receive that content in a different manner than their inbox, for example. Accordingly, dis-engaged user's may be presented with an option for receiving that content on a brand-page in a manner that may be similar to that described above in reference to FIGS. 16-22, for example.

In FIG. 23 a user (e.g., a subscriber to content from a subscribed to domain) may be targeted as a dis-engaged user by detecting a lack of user activity relative to electronic messages (e.g., email) and associated content communicated to the user by one or more subscribed to domains. The lack of activity may be detected includes but is not limited to open rate, Click-Through Rate (CTR), deletion rate (e.g., deletes an email or other form of electronic message), or other metrics that may be detected (e.g., electronically) and used to determine whether or not a user has viewed an electronic message (e.g., opened an email in their inbox) or clicked on or otherwise selected an image, an icon, an advertisement, a hyperlink, a field, or the like in an electronic message, for example. The user may actually be favorably disposed to content from the subscribed to domain, but for one or more reasons has not taken action relative to that content that is indicative of user interest in or interaction with content from the subscribed to domain, such as the user receives far more electronic messages (e.g., emails, newsletters, marketing collateral) in their inbox or other location than they have time and/or inclination to read. The user may receive electronic messages from other subscribed to domains, and taken as a whole, there are just too many messages from a variety of subscribed to domains and the user ignores those messages or puts off viewing them until a later date, but never gets around to viewing them.

The dis-engaged user may be sent an electronic message from a subscribed to domain in an attempt to re-engage that user with content from the subscribed to domain. The user may select 2301 a re-engagement icon 2340 (e.g., using cursor 1430). Selection of icon 2340 may transition 1603 the dis-engaged user to another web page, web site, menu, icon, or other, etc., denoted as 1650 which may be an electronic preference center provided as a customer service to subscribers to the subscribed to domain (e.g., Brand-Name.com). For example, Brand-Name.com may be associated with goods and/or service related to cookware, yoga, motorcycles, vacation rentals, auto sales, etc. Page 1650 may present the user with information 1653 regarding additional subscriptions the user may be interested in; however, the subscribed to domain, in an attempt to re-engage the dis-engaged user with content provided by the subscribed to domain, may wish to offer the user an alternative 2354 to its subscription based electronic messages (e.g., emails, newsletters, marketing collateral, solicitations, advertisements, etc.). For example, as described above, non-subscription-based alternative 2352 may offer the dis-engaged user another forum 2356 where electronic messages (e.g., emails, newsletters, marketing collateral, etc.) may be browsed or otherwise viewed (e.g., other than in their inbox or other location) by the dis-engaged user and others without the need to have a subscription to access the electronic messages. As described above, a user name or a user email address and a password that may be used as access credentials necessary to gain access to the subscription-based electronic messages from the subscribed to domain may not be required to access the non-subscription-based alternative 2352, that is, the non-subscription-based alternative 2352 may be publically accessible to all via is address (e.g., a URI, URL or the like).

The dis-engaged user may opt out of the alternative and may choose to activate the UNSUBSCRIBE link 1657, thereby unsubscribing the dis-engaged user from receiving future content from the subscribed to domain (e.g., Brand-Name.com) as was described above. On the other hand, for purposes of explaining how the non-subscription-based alternative may operate to re-engage the dis-engaged user, it will be assumed that the dis-engaged user instead activates link 2358 (e.g., using cursor 1430 to select 2305, the link 2358). Here, the alternative forum 2356 may allow the dis-engaged user to browse or otherwise view content from the subscribed to domain on a non-subscription-based domain that may include an address in link 2358 (e.g., SocialMail.com/Brand-Name-com/newsletters). Activating link 2358 may transition 1607 the dis-engaged user to another web page, web site, menu, or other, etc., denoted as 2362. The dis-engaged user may be notified as depicted in 2362 and/or by an email, text message, SMS, or other form of electronic messaging, that he/she has been unsubscribed from the subscribed to domain and is being re-directed to the non-subscription-based. In some examples, the dis-engaged user may be automatically directed to the non-subscription-based domain (e.g., SocialMail.com/Brand-Name-com/newsletters). In other examples, the dis-engaged user may use cursor 1430 to select 2311 the link 1663 presented in 2362 that transitions 1613 to the non-subscription-based domain denoted as 1699 (e.g., re-directed to URL denoted by link 1663). As was described above, non-subscription-based domain 1699 may present content from the subscribed to domain as a brand page 1690 where one or more electronic messages N₁-Nₙ (e.g., newsletters) and optionally other content D₁-Dₙ (e.g., related deals for hotels from other marketing channels and/or publishers of content), may be presented for browsing/viewing by the dis-engaged user, for example. Accordingly, dis-engaged users that may have continued to ignore or procrastinate in viewing and/or acting on content from the subscribed-to-domain may be re-engaged with that content on the brand page 1690, thereby converting dis-engaged users to re-engaged users. Converting dis-engaged users into re-engaged users may be used to reduce un-subscribe rates, to increase revenue from economic activity by re-engaged users (e.g., purchases, CTR, etc.), to reduce the number of dis-engaged users (e.g., to less than approximately two-thirds), and to introduce re-engaged users with other content from the subscribed-to-domain and/or content from other domains the re-engaged users may not have been previously exposed to, just to name a few, for example.

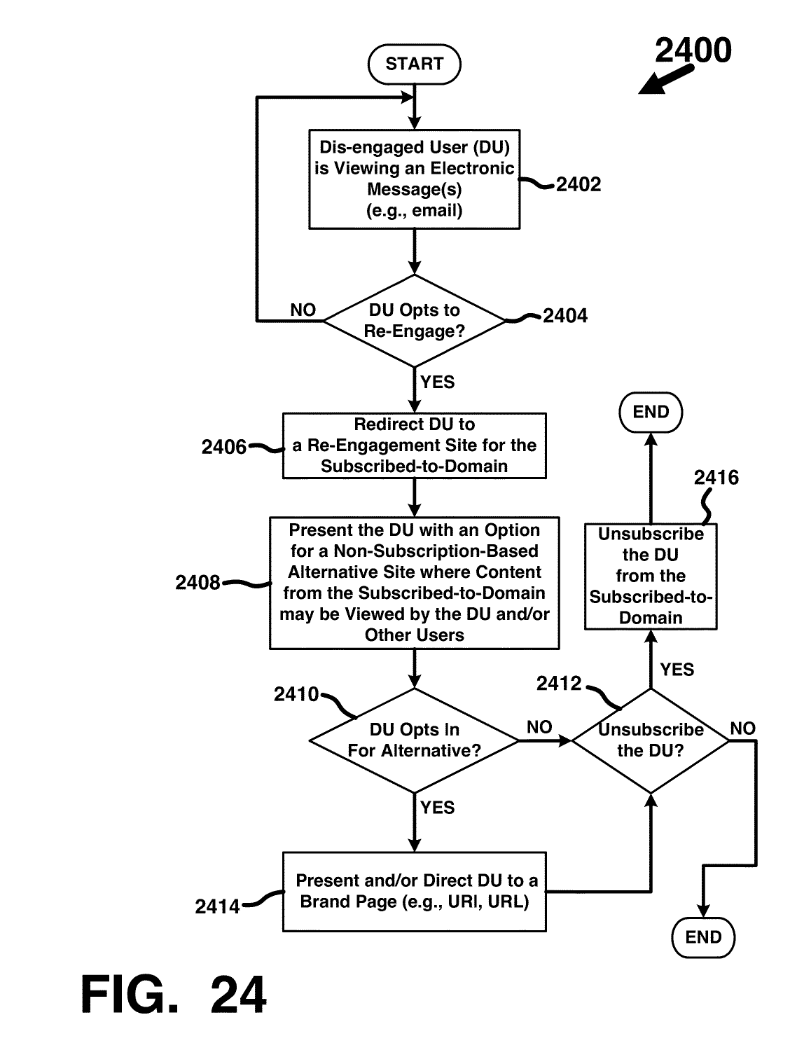

Moving now to FIG. 24 where another example of a flow diagram 2400 of a non-subscription-based alternative to receiving electronic messages is depicted. At a stage 2402 a dis-engaged user (DU hereinafter) may view an electronic message, such as an email or a newsletter, for example. The electronic message may offer the DU a non-subscription-based alternative to content the DU has subscribed to or has been receiving from the subscribed-to-domain as describe above in reference to FIG. 23 (e.g., re-engagement icon 2340). As was described above, the electronic message may be communicated to the DU based on information indicating the DU has not accessed, viewed or otherwise taken action on content from the subscribed-to-domain. The DU may decide at a stage 2404 to consider the non-subscription-based alternative to the content being received from the subscribed-to-domain from which the electronic message(s) originate (e.g., Brand-Name.com). If the DU decides not to consider the non-subscription-based alternative, then a NO branch may be taken from the stage 2402 and flow 2400 may transition to another stage, such as back to the stage 2402, for example. On the other hand, if the DU decides to consider the non-subscription-based alternative (e.g., 2340 of FIG. 23), then a YES branch may be taken from stage 2404 to a stage 2406.

At the stage 2406 the DU may be re-directed (e.g., 1603 of FIG. 23) to a web site, web page, or the like for the subscribed to domain (e.g., 1650 of FIG. 23). The stage 2406 may transition to a stage 2408. At the stage 2408, the DU may be presented with a non-subscription-based alternative that allows the user to re-engage with content from the subscribed-to-domain by viewing that content on at a location other than the DU inbox or other facility, such as on a brand page (e.g., 1690 of FIGS. 17 and 23) as described above (e.g., 2352 of FIG. 23). The stage 2408 may transition to a stage 2410 where a determination may be made as to whether or not the DU has decided to opt-in for the non-subscription-based alternative (e.g., to re-engage with content from the subscribed-to-domain). If the DU chooses to opt-out of the non-subscription-based alternative, then a NO branch may be taken from the stage 2410 to a stage 2412.

Conversely, if the DU decides to opt-in for the non-subscription-based alternative, then a YES branch may be taken from the stage 2410 to a stage 2414 (e.g., 2305 and 1658 of FIG. 23). At the stage 2414, the DU may be presented with a link (e.g., hyperlink text for a URI, URL, etc.) to a brand page (e.g., 1690 of FIGS. 17 and 23) or re-directed 1607 to the brand page (e.g., a new tab or window is opened in a browser or the like). As described above, content from the subscribed-to-domain that was previously received by the DU (e.g., in the DU's inbox or other facility) may be presented on the brand page and may be accessed without a subscription and/or access credentials. The stage 2414 may transition to another stage of flow 2400, such as the stage 2412, for example.

At the stage 2412, a determination may be made as to whether or not to unsubscribe the DU from the subscribed-to-domain. If a YES branch is taken from the stage 2412, then flow 2400 may transition to a stage 2416 where the DU is unsubscribe from the subscribed-to-domain. If a NO branch is taken from the stage 2412, then flow 2400 may terminate or may transition to another stage, such as back to the stage 2402, for example. Taking the YES branch from the stage 2412 to the stage 2416 may occur by action taken by the DU, such as, the DU selecting 1657 the UNSUBSCRIBE icon as depicted in 2352 of FIG. 23, for example. In other examples, taking the YES branch from the stage 2412 to the stage 2416 may occur automatically by operation of one or more systems that may execute one or more stages of flow 2400. As one example, if the DU opts-in such that the stage 2414 of flow 2400 is executed, then the DU may be automatically unsubscribed from the content from the subscribed-to-domain.

As was described above in reference to flow 1800 of FIG. 18, in flow 2400, different systems (e.g., front end systems, back end systems) may perform different tasks associated with the DU deciding to opt-in for the non-subscription-based alternative or to opt-out (e.g., unsubscribe or take no action at all). The examples depicted in FIGS. 17 and 23 may be presented to a DU on a variety of client devices including but not limited to a wireless client device, a laptop computer, a PC, a server, a tablet, a pad, a smartphone, a smart watch, a wearable device, a hand-held device, a PDA, a touch screen device, a TV, a HDTV, a Smart TV, an image projection device, an eyepiece, a goggle, eyeglasses, etc., just to name a few for example. In some examples the non-limiting web page format depicted in FIG. 17 may be modified, changed or otherwise adapted for presentation on different types of devices such as mobile devices, hand-held devices, eyeglass/goggle displays, smart watches, etc. A DU who has elected to opt-in may be denoted as a re-engaged user (RU).

Although the foregoing examples have been described in some detail for purposes of clarity of understanding, the above-described inventive techniques are not limited to the details provided. There are many alternative ways of implementing the above-described techniques for the present application. The disclosed examples are illustrative and not restrictive.

What is claimed is:

1. A method, comprising:
receiving, on a backend system in data communication with one or more first networked computing resources of a frontend system, content from the frontend system;
applying a factor to the content using one or more second networked computing resources in data communication with the backend system; and
weighting the factor, using the one or more second networked computing resources, to determine a ranking of the content on a brand page.

2. The method of claim 1, wherein the factor comprises an internal factor that is parsed from on-page data included in the content received from the frontend system.

3. The method of claim 1, wherein the factor comprises an external factor accessed from off-page data that is not included in the content received from the frontend system.

4. The method of claim 1, wherein the factor comprises a personalization factor accessed from user personalization data.

5. The method of claim 1, wherein the factor comprises a relevancy factor accessed from relevancy data.

6. The method of claim 1, wherein the factor comprises a mobile data factor accessed from one or more client devices.

7. The method of claim 1, wherein the factor comprises a subscription factor accessed from subscription data.

8. The method of claim 1, wherein the factor comprises a text factor that is parsed from a link included in the content received from the frontend system.

9. A method, comprising:
signing up, by a publisher of content, to post unsubscribed to content from the publisher on a brand page;
composing an address for the unsubscribed to content, the address operative to determine placement of the unsubscribed to content on the brand page;
determining a hierarchy of the unsubscribed to content based on the address from the composing;
setting a publisher authority to address authority when a plurality of addresses from the composing include different addresses from an identical domain; and
setting the publisher authority to domain authority when address authority is not indicated by the plurality of addresses.

10. The method of claim 9 and further comprising:
parsing the unsubscribed to content to detect an unsubscribe link; and
removing the unsubscribe link when detected.

11. The method of claim 10 and further comprising:
comparing the unsubscribe link with data in a data base of unsubscribe links, wherein the removing of the unsubscribe link occurs when the comparing indicates a similitude between the unsubscribe link and the data.

12. The method of claim 10 and further comprising:
comparing the unsubscribe link with data in a data base of unsubscribe links; and
adding the unsubscribe link to the data base of unsubscribe links when the comparing indicates a lack of similitude between the unsubscribe link and the data.

13. The method of claim 9, wherein the address comprises a plurality of variables separated by a separation character.

14. The method of claim 9, wherein the address includes a domain address for the brand page.

15. A method, comprising:
initiating, on a backend system in data communication with one or more first networked computing resources, a new publisher double opt-in procedure;
entering a retention content email address associated with a new publisher;
sending, to the new publisher, a confirmation email operative to verify the retention email address;
determining whether or not the new publisher has verified the retention email address by activating a link included in the confirmation email;
assigning a confirmed status to the new publisher if the new publisher has activated the link;
receiving, from the new publisher, a plurality of content;
determining if the plurality of content is in accord with a policy for content to be posted on a brand page;
assigning an approved status to the new publisher if the plurality of content is in accord with the policy; and
posting content from the new publisher on the brand page after the new publisher has been assigned the approved status.

16. The method of claim 15 and further comprising:
assigning the new publisher a rejected status if the plurality of content is not in accord with the policy.

17. The method of claim 15 and further comprising:
assigning the new publisher a pending status if the new publisher has not been assigned the approved status or if the new publisher has not activated the link.

18. The method of claim 15, wherein the policy is embodied in a moderation rule that is accessed by the backend system, a frontend system in data communication with the one or more first networked computing resources or both.

19. The method of claim 15, wherein the content comprises an electronic message.

20. The method of claim 15, wherein the content comprises an email.
